(19) United States
(12) Patent Application Publication
(10) Pub. No.: US 2022/0007399 A1
(43) Pub. Date: Jan. 6, 2022

(54) Acknowledgment Transmission in Wireless Communications Systems

(71) Applicant: Ofinno, LLC, Reston, VA (US)

(72) Inventors: Nazanin Rastegardoost, McLean, VA (US); Hyoungsuk Jeon, Centreville, VA (US); Esmael Hejazi Dinan, McLean, VA (US); Ali Cagatay Cirik, Herndon, VA (US); Yunjung Yi, Vienna, VA (US)

(73) Assignee: Ofinno, LLC, Reston, VA (US)

(21) Appl. No.: 17/476,087

(22) Filed: Sep. 15, 2021

Related U.S. Application Data
(63) Continuation of application No. PCT/US2021/013934, filed on Jan. 19, 2021.
(60) Provisional application No. 62/975,945, filed on Feb. 13, 2020.
(60) Provisional application No. 62/961,874, filed on Jan. 16, 2020.

(51) Int. Cl. H04W 72/12; H04L 1/18; H04W 74/08

(52) U.S. Cl. CPC H04W 72/1273; H04W 72/1278; H04W 74/0841; H04L 1/1896; H04L 1/1819

(57) ABSTRACT

A wireless device receives a downlink channel of a semi-persistent scheduling. The downlink channel is associated with a first uplink control channel indicated by a feedback timing parameter of the semi-persistent scheduling. Based on at least one symbol of the first uplink control channel, it is determined that the first uplink control channel is not available for transmitting feedback information of the downlink channel. A second uplink control channel that is available for the transmitting is determined after the first uplink control channel. The wireless device multiplexes the feedback information in the second uplink control channel.

### CROSS-REFERENCE TO RELATED APPLICATIONS

This application is a continuation of International Application No. PCT/US2021/013934, filed Jan. 19, 2021, which claims the benefits of U.S. Provisional Patent Application No. 62/961,874, filed Jan. 16, 2020, and U.S. Provisional Patent Application No. 62/975,945, filed Feb. 13, 2020, the contents of each of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates an example of HARQ acknowledgment timing determination, according to some embodiments.

FIG. 18 illustrates an example of signaling for configuration, activation, transmission, and deactivation of a DL SPS, according to some embodiments.

FIG. 19 illustrates an example of scheduling SPS PDSCH and the corresponding PUCCH, according to some embodiments.

FIG. 20 illustrates an example of SPS PDSCH scheduling where the corresponding PUCCH is not within the same channel occupancy, according to some embodiments.

FIG. 21 illustrates an example of SPS PDSCH scheduling where the corresponding PUCCH is scheduled for HARQ feedback transmissions in addition to that of the SPS PDSCH, according to some embodiments.

FIG. 22 illustrates an example of SPS PDSCH scheduling where the corresponding PUCCH is only scheduled for HARQ feedback transmission of the SPS PDSCH, according to some embodiments.

FIG. 23 illustrates an example of dynamic scheduling indicating a second PUCCH resource overriding semi-persistent scheduling indicating a first PUCCH resource, according to some embodiments.

FIG. 24 illustrates an example of dynamic scheduling before SPS PDSCH, indicating postponing a HARQ feedback transmission, overriding semi-persistent scheduling, indicating a first PUCCH resource for HARQ feedback transmission, according to some embodiments.

FIG. 25 illustrates an example of dynamic scheduling after SPS PDSCH, indicating postponing a HARQ feedback transmission, overriding semi-persistent scheduling, indicating a first PUCCH resource for HARQ feedback transmission, according to some embodiments.

FIG. 26 illustrates an example of postponing HARQ feedback transmission of SPS PDSCH based on receiving an indication of non-numerical timing value, according to some embodiments.

FIG. 27 illustrates an example of postponing HARQ feedback transmission of SPS PDSCH based on receiving an indication of non-numerical timing value within the same COT as the SPS PDSCH, according to some embodiments.

FIG. 28 illustrates an example of dropping a pending HARQ feedback in semi-static codebook due to BWP switching, according to some embodiments.

FIG. 29 shows an example of dropping a pending HARQ feedback in dynamic/enhanced-dynamic codebook due to BWP switching, according to some embodiments.

FIG. 30 shows another example of dropping a pending HARQ feedback in dynamic/enhanced-dynamic codebook due to BWP switching, according to some embodiments.

FIG. 31 shows an example of different behaviors regarding HARQ feedback with dynamic/enhanced-dynamic codebook due to BWP switching, according to some embodiments.

FIG. 32 shows an example of cross-COT scheduling of DL data reception and HARQ feedback transmission in unlicensed bands, according to some embodiments.

FIG. 33 shows an example of dropping a pending HARQ-ACK associated with a non-numerical HARQ feedback timing indicator, due to BWP switching before receiving a second DCI indicating a PUCCH resource for the HARQ-ACK transmission, according to some embodiments.

FIG. 34 shows an example of maintaining a pending HARQ-ACK associated with a non-numerical HARQ feedback timing indicator, in case of BWP switching before receiving a second DCI indicating a PUCCH resource for the HARQ-ACK transmission, according to some embodiments.

FIG. 35 shows an example of extending the BWP inactivity timer based on the non-numerical HARQ feedback timing indication, according to some embodiments.

FIG. 36 shows an example of suspending the BWP inactivity timer based on the non-numerical HARQ feedback timing indication, according to some embodiments.

FIG. 37 shows an example of suspending the BWP inactivity timers of cells in a self-carrier scheduling scenario based on the non-numerical HARQ feedback timing indication, according to some embodiments.

FIG. 38 shows an example of suspending the BWP inactivity timers of cells in a cross-carrier scheduling scenario based on the non-numerical HARQ feedback timing indication, according to some embodiments.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

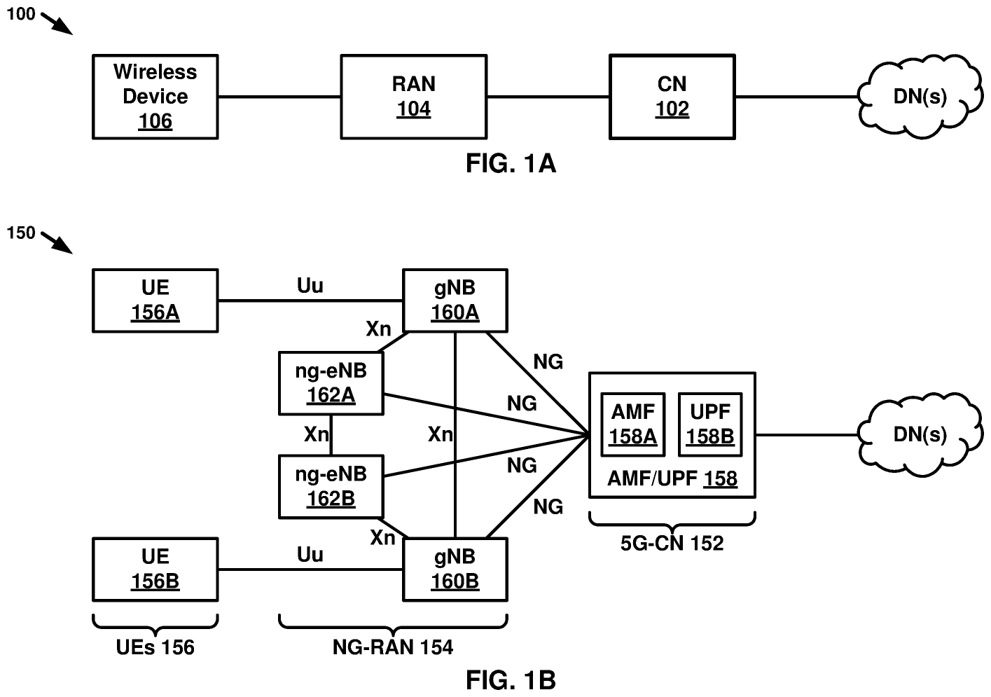

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

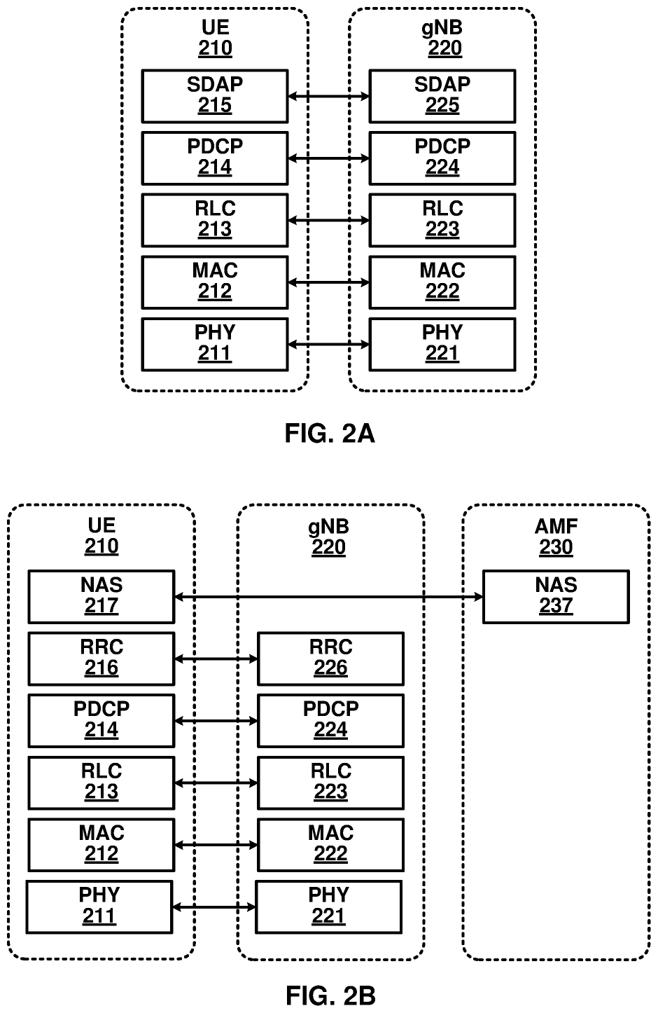

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

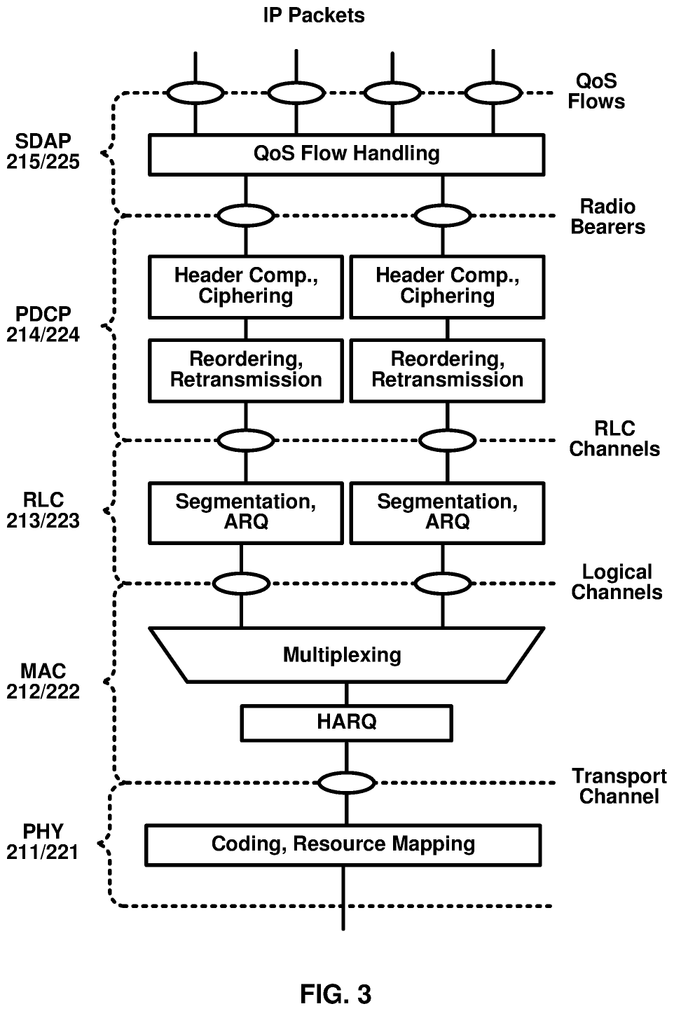

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

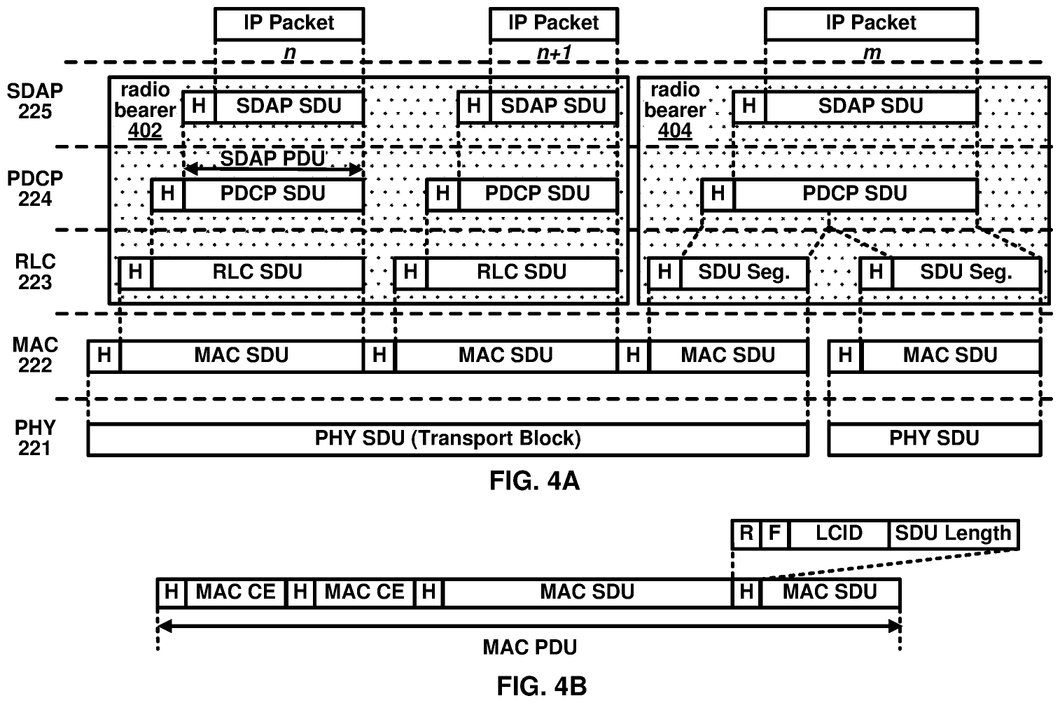

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

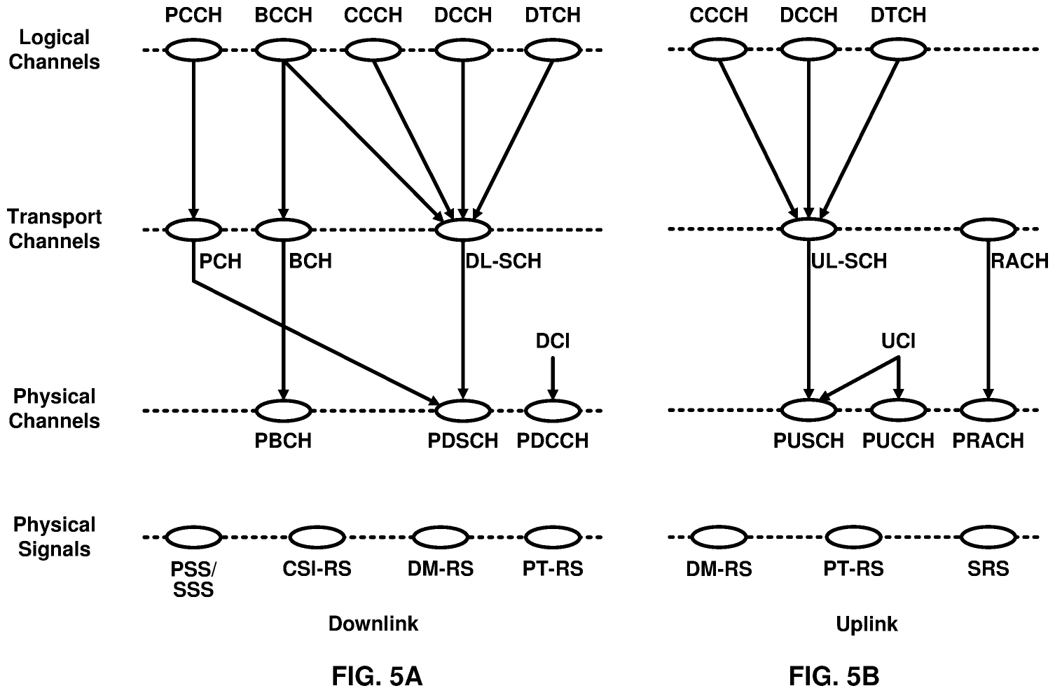

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

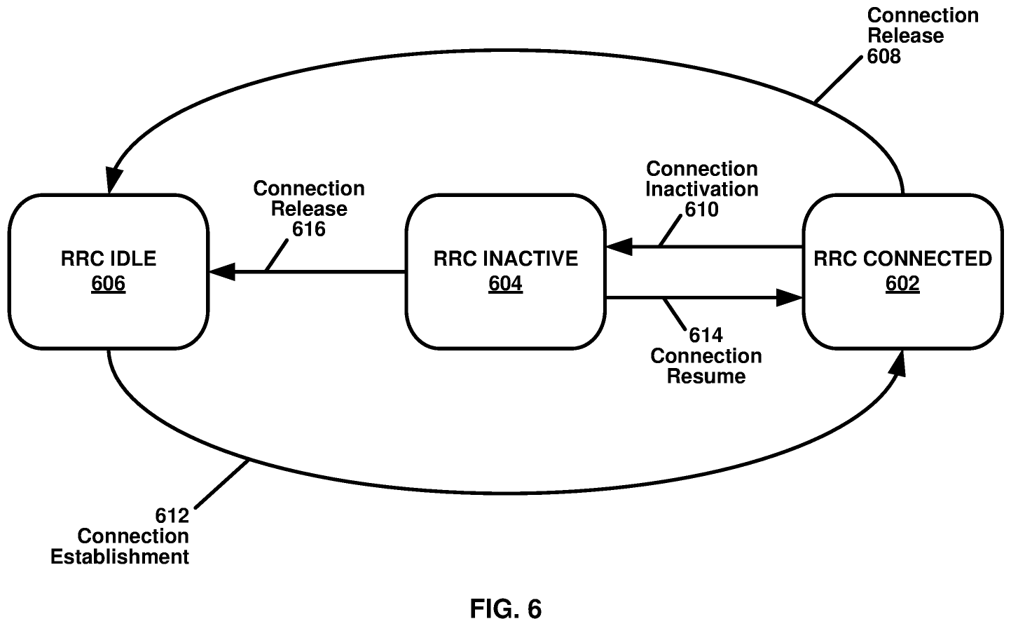

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

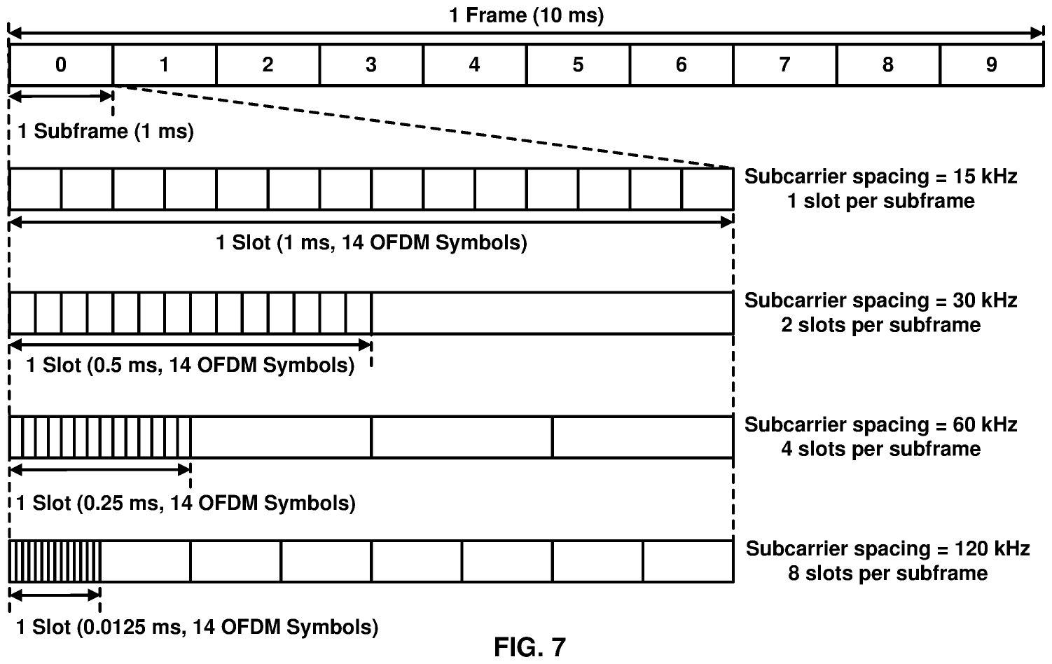

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 s. For example, NR defines numerologies with the following subcarrier spacing/cyclic prefix duration combinations: 15 kHz/4.7 s; 30 kHz/2.3 s; 60 kHz/1.2 s; 120 kHz/0.59 s; and 240 kHz/0.29 s.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

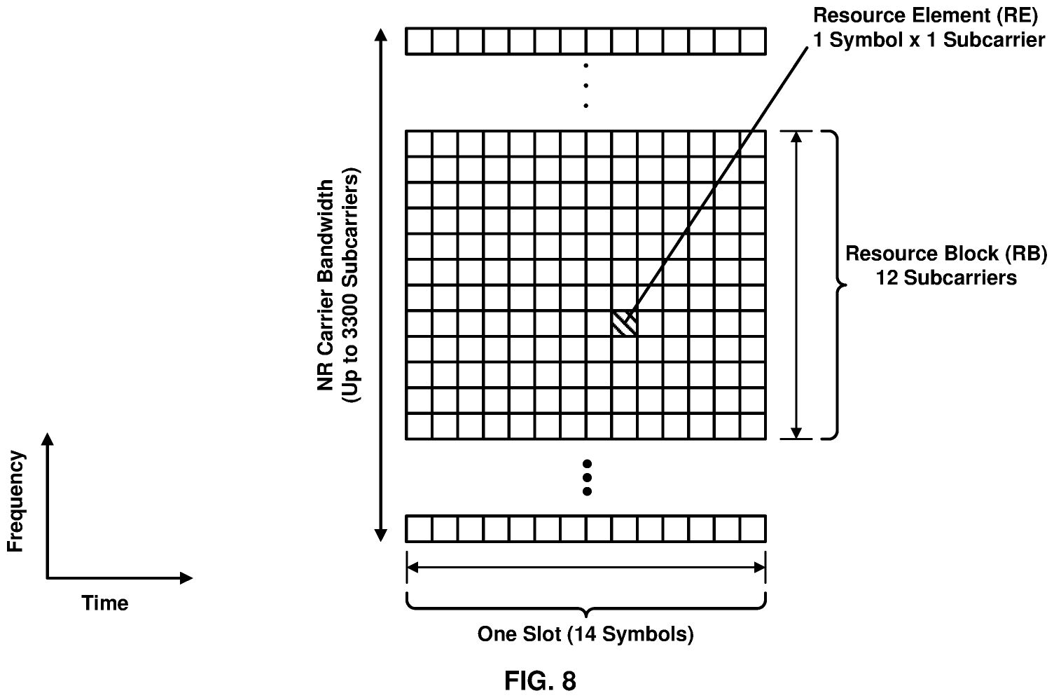

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

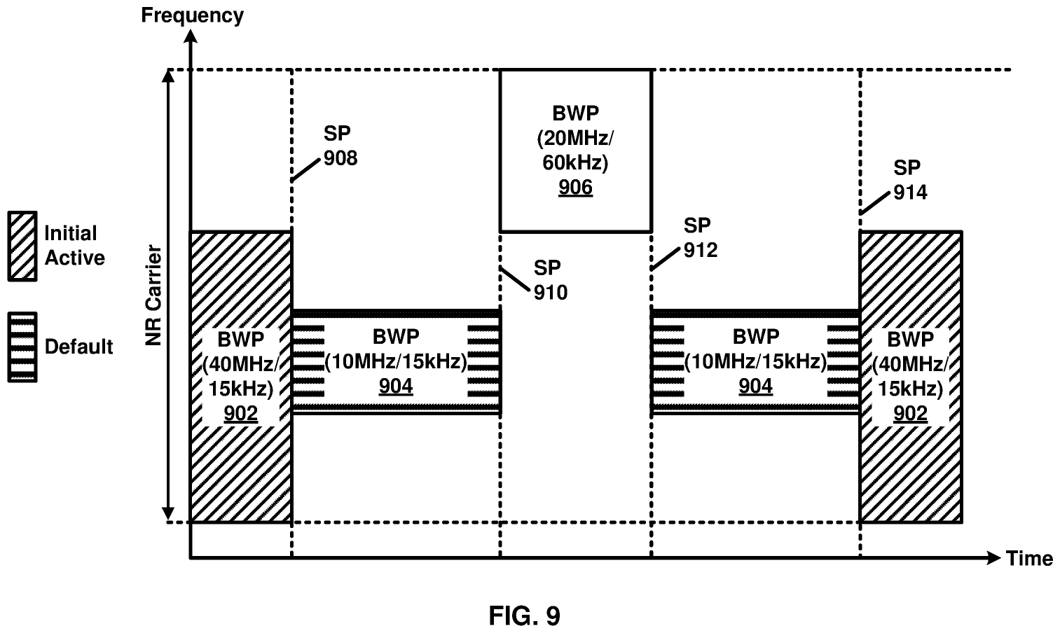

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

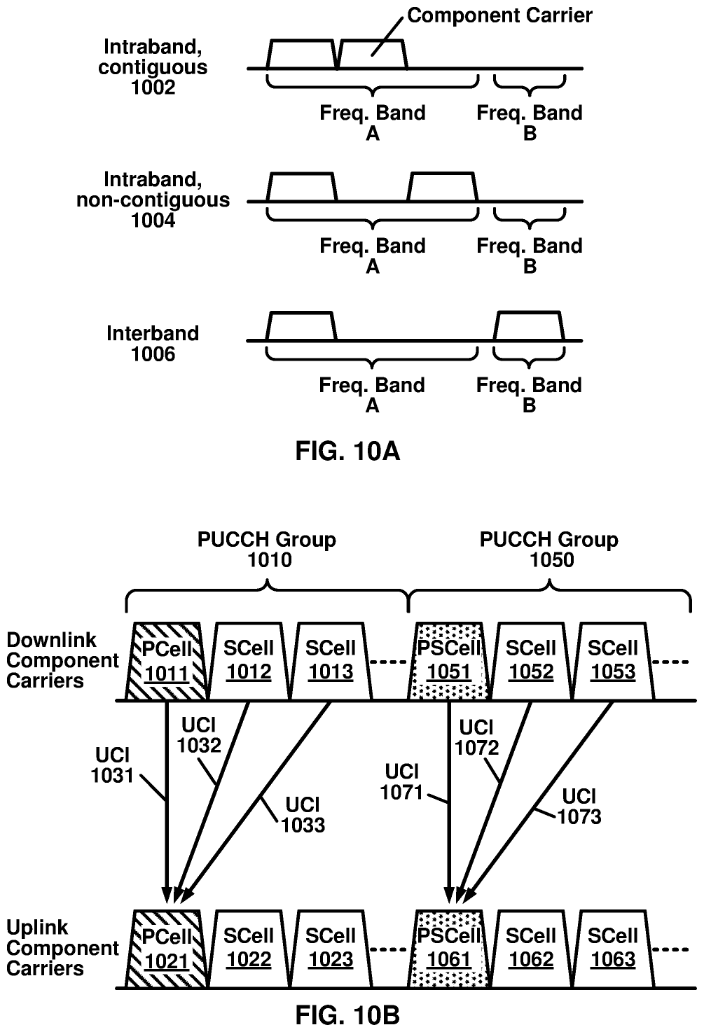

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary Scell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

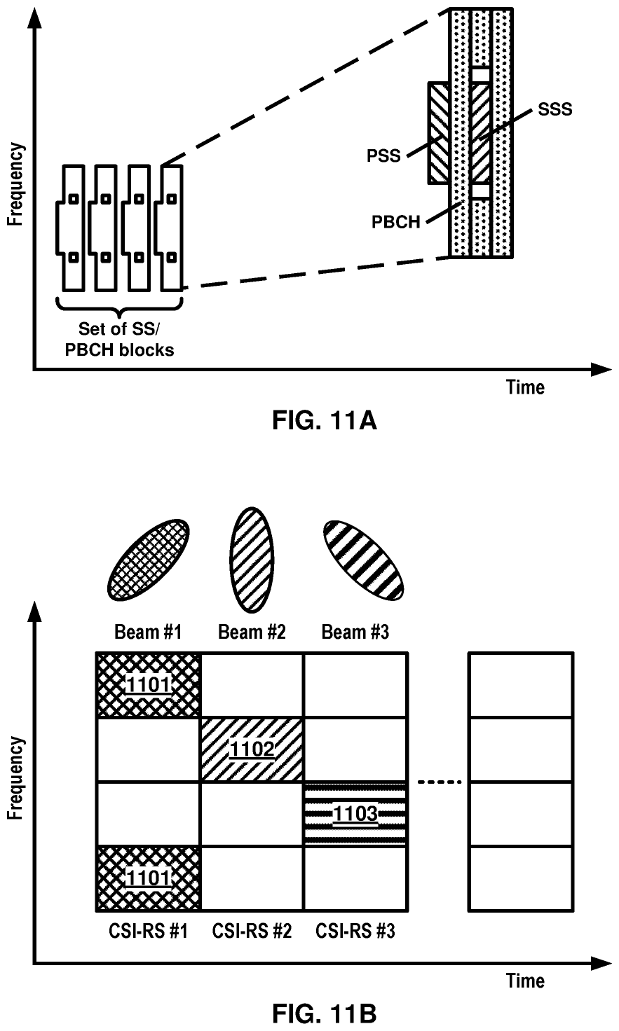

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

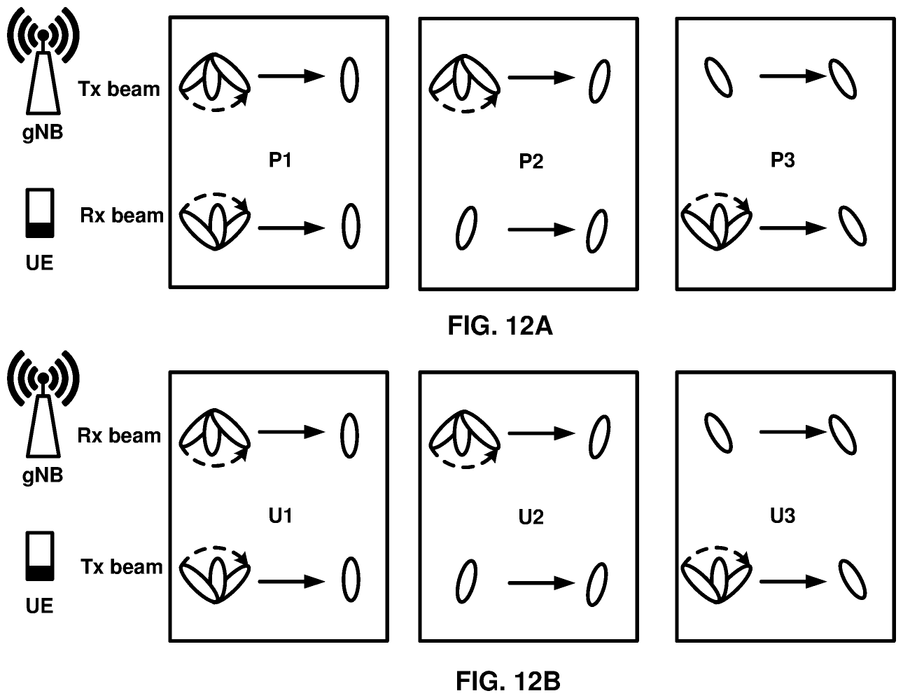

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counter-clockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counter-clockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counter-clockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

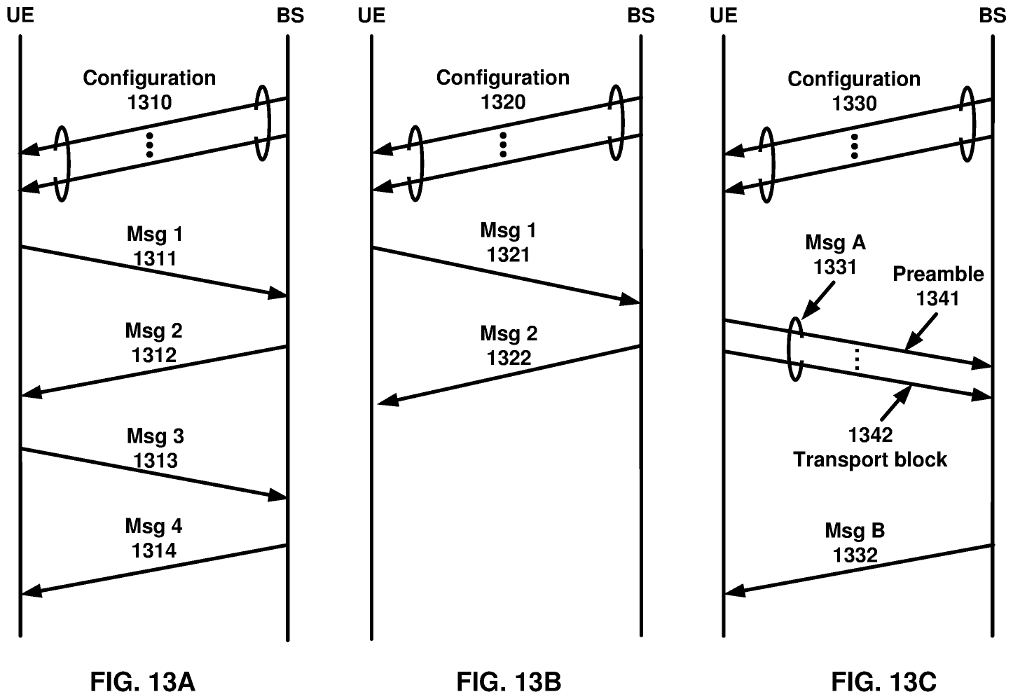

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 11311, a Msg 21312, a Msg 31313, and a Msg 41314. The Msg 11311 may include and/or be referred to as a preamble (or a random access preamble). The Msg 21312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 11311 and/or the Msg 31313. Based on the one or more RACH parameters, the UE may determine a reception timing and a downlink channel for receiving the Msg 21312 and the Msg 41314.

The one or more RACH parameters provided in the configuration message 1310 may indicate one or more Physical RACH (PRACH) occasions available for transmission of the Msg 11311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 11311 and/or Msg 31313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 11311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 11311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 31313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 31313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 11311 based on the association. The Msg 11311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 21312 received by the UE may include an RAR. In some scenarios, the Msg 2 1312 may include multiple RARs corresponding to multiple UEs. The Msg 21312 may be received after or in response to the transmitting of the Msg 11311. The Msg 21312 may be scheduled on the DL-SCH and indicated on a PDCCH using a random access RNTI (RA-RNTI). The Msg 21312 may indicate that the Msg 11311 was received by the base station. The Msg 21312 may include a time-alignment command that may be used by the UE to adjust the UE's transmission timing, a scheduling grant for transmission of the Msg 31313, and/or a Temporary Cell RNTI (TC-RNTI). After transmitting a preamble, the UE may start a time window (e.g., ra-ResponseWindow) to monitor a PDCCH for the Msg 21312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).
The UE may transmit the Msg 31313 in response to a successful reception of the Msg 21312 (e.g., using resources identified in the Msg 21312). The Msg 31313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 31313 and the Msg 41314) may be used to increase the likelihood that the UE does not incorrectly use an identity of another the UE. To perform contention resolution, the UE may include a device identifier in the Msg 31313 (e.g., a C-RNTI if assigned, a TC-RNTI included in the Msg 21312, and/or any other suitable identifier).

The Msg 41314 may be received after or in response to the transmitting of the Msg 3 1313. If a C-RNTI was included in the Msg 31313, the base station will address the UE on the PDCCH using the C-RNTI. If the UE's unique C-RNTI is detected on the PDCCH, the random access procedure is determined to be successfully completed. If a TC-RNTI is included in the Msg 31313 (e.g., if the UE is in an RRC_IDLE state or not otherwise connected to the base station), Msg 41314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 31313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 11311 and/or the Msg 31313) may remain on the selected carrier. The UE may switch an uplink carrier during the random access procedure (e.g., between the Msg 11311 and the Msg 31313) in one or more cases. For example, the UE may determine and/or switch an uplink carrier for the Msg 11311 and/or the Msg 31313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 21322. The Msg 11321 and the Msg 21322 may be analogous in some respects to the Msg 11311 and a Msg 21312 illustrated in FIG. 13A, respectively. As will be understood from FIGS. 13A and 13B, the contention-free random access procedure may not include messages analogous to the Msg 31313 and/or the Msg 41314.

The contention-free random access procedure illustrated in FIG. 13B may be initiated for a beam failure recovery, other SI request, SCell addition, and/or handover. For example, a base station may indicate or assign to the UE the preamble to be used for the Msg 11321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 11321 and reception of a corresponding Msg 21322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 31313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 21312 (e.g., an RAR) illustrated in FIGS. 13A and 13B and/or the Msg 41314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 31313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 23 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

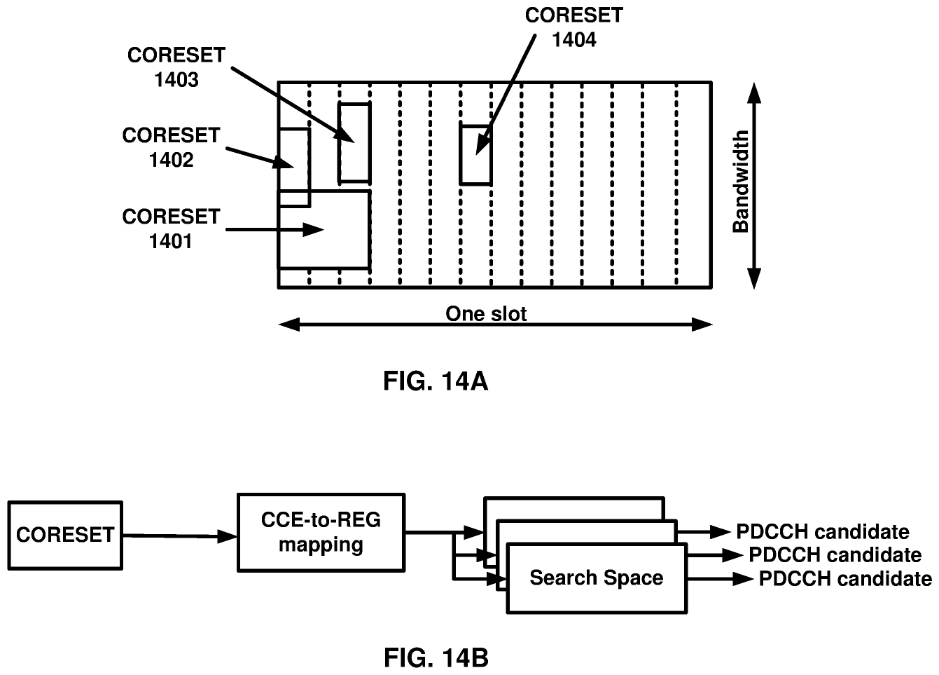

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

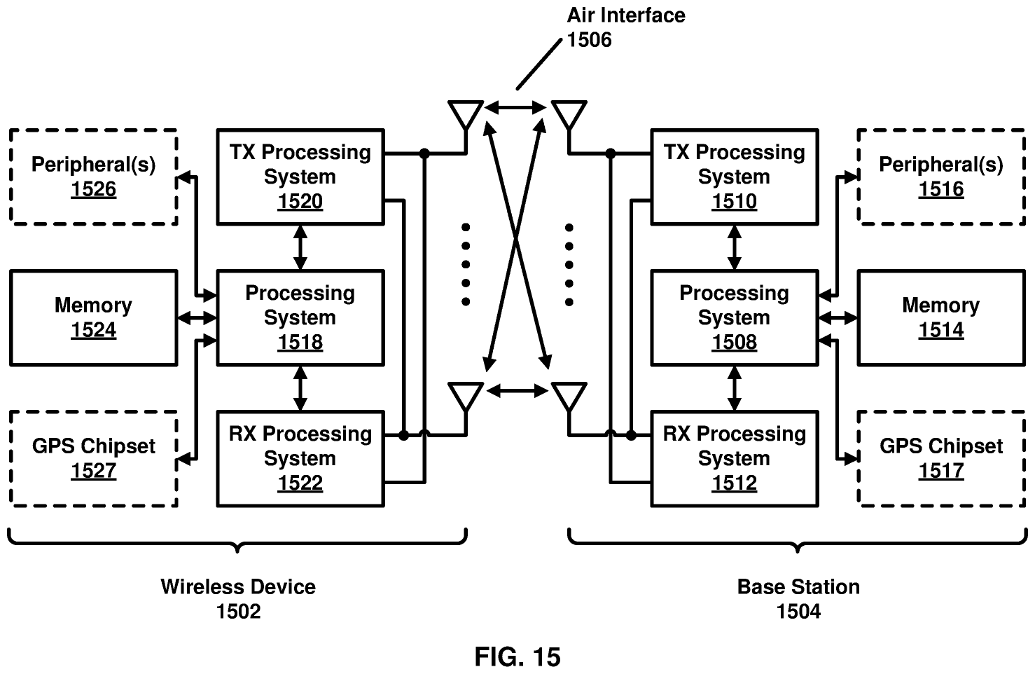

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

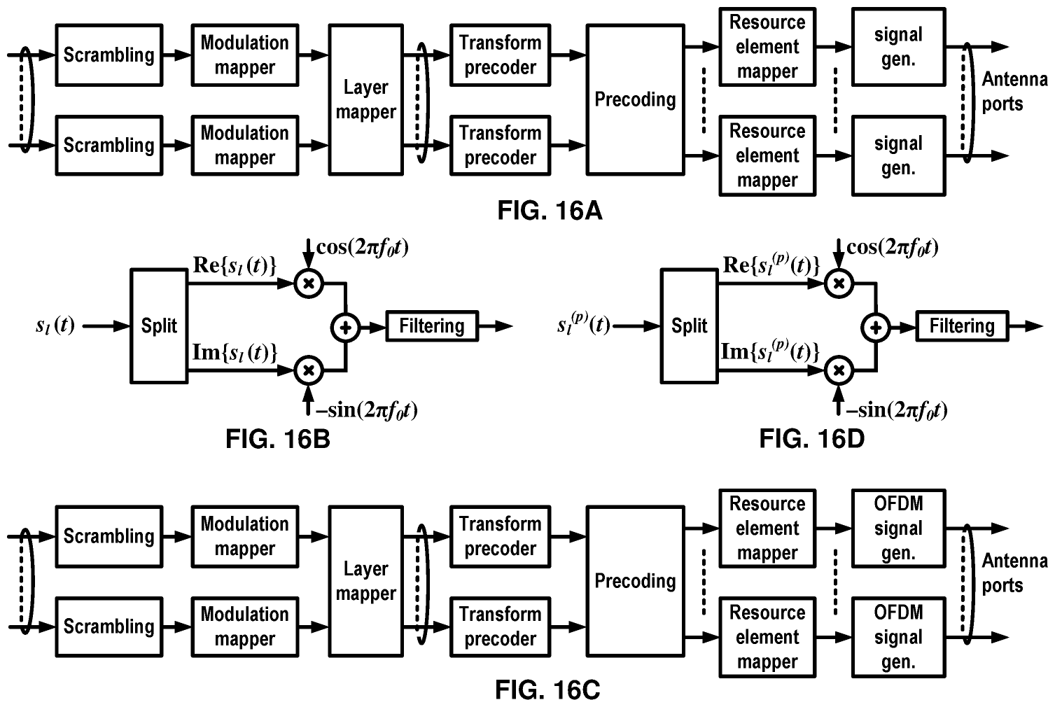

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual-connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

The hybrid-ARQ mechanism in the MAC layer targets very fast transmissions. A wireless device may provide feedback on success or failure of downlink transmissions to a base station after each received transport block. It may be possible to attain a very low error rate probability of the HARQ feedback, which may come at a cost in transmission resources such as power. For example, a feedback error rate of 0.1-1% may be reasonable, which may result in a HARQ residual error rate of a similar order. This residual error may be sufficiently low in many cases. In some services requiring ultra-reliable delivery of data with low latency, e.g., URLLC, this residual error rate may not be tolerable. In such cases, the feedback error rate may be decreased and an increased cost in feedback signaling may be accepted, and/or additional retransmissions may be performed without relying on feedback signaling, which comes at a decreased spectral efficiency.

HARQ protocol may be a primary way of handling retransmissions in a wireless technology, e.g., NR. In case of an erroneously received packet, a retransmission may be required. Despite it not being possible to decode the packet, a received signal may still contain information, which may be lost by discarding the erroneously received packet. A HARQ with soft combining may address the shortcoming. In HARQ with soft combining, wireless device stores the erroneously received packet in a buffer memory, and later combines with one or more retransmissions to obtain a single, combined packet that may be more reliable than its constituents. Decoding of the error-correction code operates on the combined signal.

Retransmissions of codeblock groups, e.g. part of a transport block, may be handled by the physical layer and/or MAC layer. The basis for HARQ mechanism comprises of multiple stop-and-wait protocols, each operating on a single transport block. In a stop-and-wait protocol, a transmitter stops and waits for an acknowledgment after each transmitted transport block. This protocol requires a single bit indicating positive or negative acknowledgment of the transport block; however, the throughput is low due to waiting after each transmission. Multiple stop-and-wait processes may operate in parallel, e.g., while waiting for acknowledgment from one HARQ process, the transmitter may transmit data of another HARQ process. The multiple parallel HARQ processes may form a HARQ entity, allowing continuous transmission of data. The wireless device may have one HARQ entity per carrier. A HARQ entity may support spatial multiplexing of more than four layers to a single device in the downlink, where two transport blocks may be transmitted in parallel on the same transport channel. The HARQ entity may have two sets of HARQ processes with independent HARQ acknowledgments.

A wireless technology may use asynchronous HARQ protocol in downlink and/or uplink, e.g., the HARQ process which the downlink and/or uplink transmission relates to, may be explicitly and/or implicitly signaled. For example, the downlink control information (DCI) scheduling a downlink transmission may signal the corresponding HARQ process. Asynchronous HARQ operation may allow dynamic TDD operation, and may be more efficient when operating in unlicensed spectra, where it may not be possible to guarantee that scheduled radio resources are available at the time for synchronous retransmissions.

Large transport block sizes may be segmented into multiple codeblocks prior to coding, each with its own CRC, in addition to an overall TB CRC. Errors may be detected on individual codeblocks based on their CRC, as well as on the overall TB. The base station may configure the wireless device with retransmissions based on groups of codeblocks, e.g., codeblock groups (CBGs). If per-CBG retransmission is configured, feedback is provided pre CBG. A TB may comprise of one or more CBGs. A CBG that a codeblock belongs to may be determined based on an initial transmission and may be fixed.

In downlink, retransmissions may be scheduled in a same way as new data. For example, retransmissions may be scheduled at any time and any frequency location within the downlink cell and/or BWP. A downlink scheduling assignment may contain necessary HARQ-related control signaling, e.g., HARQ process number; new-data indicator (NDI); CBG transmit indicator (CBGTI) and CBG flush indicator (CBGFI) in case per-CBG retransmission is configured; and/or information to handle the transmission of the acknowledgment (ACK/NACK) in the uplink, such as timing and resource indication information.

Upon receiving a scheduling assignment in the DCI, the wireless device tries to decode the transport block (TB), e.g., after soft combining with previous attempts. Transmissions and retransmissions may be scheduled in a same framework. The wireless device may determine whether the transmission is a new transmission or a retransmission based on the NDI field in the DCI. An explicit NDI may be included for the scheduled TB as part of the scheduling information in the downlink. The NDI field may comprise one or more NDI bits per TB (and/or CBG). An NDI bit may be toggled for a new transmission, and not toggled for a retransmission. In case of a new transmission, the wireless device flushes the soft buffer. In case of a retransmission, the wireless device performs soft combining with the received data currently in the soft buffer for the corresponding HARQ process.

A time from a downlink data reception to a transmission of the corresponding HARQ ACK/NACK may be fixed, e.g., multiple subframes/slots/symbols (e.g., three ms). This scheme with pre-defined timing instants for ACK/NACK may not blend well with dynamic TDD and/or unlicensed operation. A more flexible scheme, capable of dynamically controlling the ACK/NACK transmission timing may be adopted. For example, a DL scheduling DCI may comprise a HARQ timing field to control/indicate the transmission timing of the ACK/NACK in the uplink. The HARQ timing field in the DCI may be used as an index into a pre-define and/or RRC-configured table, that provides information on when the wireless device may transmit the HARQ ACK/NACK relative to the reception of data (e.g., physical DL shared channel (PDSCH)).

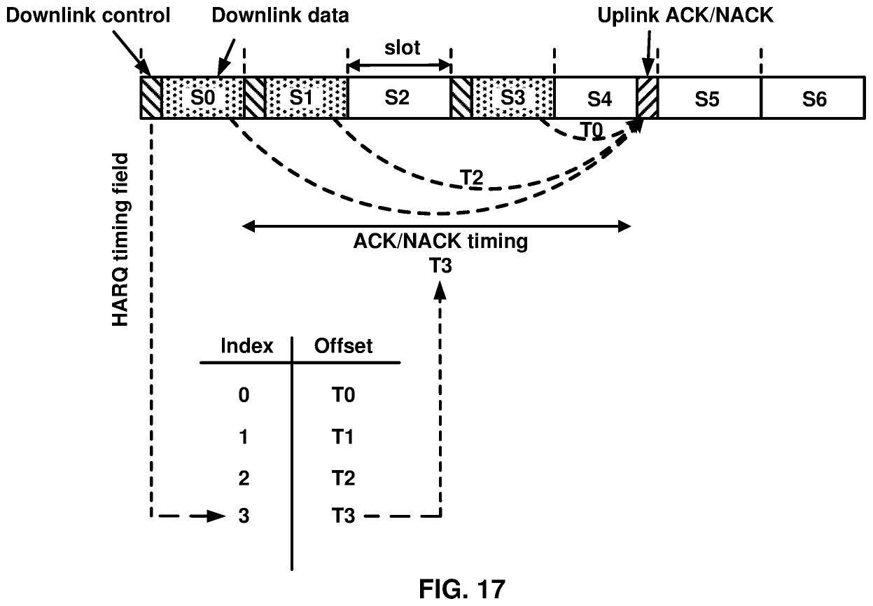

FIG. 17 shows an example of HARQ acknowledgment timing determination. In this example, three DCIs are received in slots S0 and S1 and S3 that schedule three downlink assignments in the same slots. In each downlink assignment, different acknowledgment timing indices are indicated, e.g., in S0: 3, in S1: 2, and in S3: 0. The indicated indices (HARQ timing filed) point to the HARQ timing table, e.g., for S0: T3 in indicated that points to S4 for transmission of the uplink ACK/NACK, for S1: T2 in indicated that points to S4 for transmission of the uplink ACK/NACK, for S3: T0 in indicated that points to S4 for transmission of the uplink ACK/NACK. As a result, all three downlink assignments are acknowledged in the same slot, S4. The wireless device multiplexes the three acknowledgments and transmits in slot S4.

All wireless devices may support a baseline processing time/capability. Some wireless devices may support additional aggressive/faster processing time/capability. A wireless device may report to a base station a processing capability, e.g. per sub-carrier spacing.

A wireless device may determine a resource for HARQ ACK/NACK transmission, e.g. frequency resource and/or PUCCH format and/or code domain, based on a location of a PDCCH scheduling the transmission. The scheduling DCI may comprise a field, e.g., PUCCH resource indicator (PRI) field, that indicates the resource for the HARQ ACK/NACK transmission. The PRI field may be an index selecting one of a plurality of pre-defined and/or RRC-configured resource sets.

A wireless device may multiplex a plurality of acknowledgments that are scheduled for transmission in the uplink at the same time/slot, for example, in a carrier aggregation scenario and/or when per-CBG retransmission is configured. The UE may multiplex multiple ACK/NACK bits of multiple TBs and/or CBGs into one multi-bit acknowledgment message. The multiple ACK/NACK bits may be multiplexed using a semi-static codebook and/or a dynamic codebook. RRC configuration may select between the semi-static codebook and the dynamic codebook.

The semi-static codebook may be viewed as a matrix consisting of a time domain dimension and a component-carrier (and/or CBG and/or MIMO layer) dimension, both of which may be semi-statically configured and/or pre-defined. A size of the time domain dimension may be given by a maximum and/or a minimum HARQ ACK/NACK timing indicated in the pre-defined and/or RRC-configured table of HARQ ACK/NACK timings. A size of the component-carrier domain may be given by a number of simultaneous TBs and/or CBGs across all component carriers. A codebook size may be fixed for a semi-static codebook. A number of bits to transmit in a HARQ report is determined based on the fixed codebook size. An appropriate format (e.g., PUCCH format) for uplink control signaling may be selected based on the number of bits. Each entry of the matrix may represent a decoding outcome, e.g. positive (ACK) or negative (NACK) acknowledgments, of the corresponding transmission. One or more of the entries of the codebook matrix may not correspond to a downlink transmission opportunity (e.g., a PDSCH occasion), for which a NACK is reported. This may increase a codebook robustness, e.g., in case of missed downlink assignments, and the base station may schedule a retransmission of the missed TB/CBG. The size of the semi-static codebook may be very large.

The dynamic codebook may be used to address the issue with the potentially large size of the semi-static codebook. With the dynamic codebook, only the ACK/NACK information of scheduled assignments may be included in the report, e.g., not all carriers as in semi-static codebook. A size of the dynamic codebook may be dynamically varying, e.g., as a function of a number of scheduled carriers. To maintain a same understanding of the dynamic codebook size, which is prone to error in the downlink control signaling, a downlink assignment index (DAI) may be included in the scheduling DCI. The DAI field may comprise a counter DAI (cDAI) and a total DAI (tDAI), e.g., in case of carrier aggregation. The counter DAI in the scheduling DCI indicates a number of scheduled downlink transmissions up to the point the DCI was received, in a carrier first, time second manner. The total DAI in the scheduling DCI indicates a total number of scheduled downlink transmissions across all carriers up to the point the DCI was received. A highest cDAI at a current time is equal to the tDAI at this time.

A wireless device may receive a downlink assignment from a base station. The wireless device may receive the downlink assignment on a physical downlink control channel (PDCCH). The downlink assignment may indicate that there are one or more transmissions on one or more downlink shared channels (DL-SCHs) for a particular MAC entity. The downlink assignment may provide hybrid automatic repeat request (HARQ) information of the one or more transmissions.

For each PDCCH occasion during which a UE monitors PDCCH and for each serving cell, the UE may receive a downlink assignment for the MAC entity's C-RNTI or TC-RNTI. The UE may consider the NDI to have been toggled, e.g., when this is a first downlink assignment for the TC-RNTI. The downlink assignment may be for the MAC entity's C-RNTI, and previous downlink assignment indicated to a HARQ entity of the same HARQ process may be a downlink assignment received for the MAC entity's CS-RNTI and/or a configured downlink assignment (e.g., semi-persistent scheduling (SPS)), and the UE may consider the NDI to have been toggled regardless of a value of the NDI. The MAC entity may indicate a presence of a downlink assignment and deliver the associated HARQ information (e.g., HARQ process number, NDI, etc.) to the HARQ entity.

The UE may receive a downlink assignment for a PDCCH occasion for a serving cell for the MAC entity's CS-RNTI. The UE may consider the NDI for the corresponding HARQ process not to have been toggled, and may indicate a presence of a downlink assignment and deliver the associated HARQ information to the HARQ entity, e.g. when the NDI in the received HARQ information is 1.

The NDI in the received HARQ information may be 0, and the PDCCH contents may indicate SPS deactivation. The UE may clear a configured downlink assignment for this serving cell (if any). A timer, e.g., timeAlignmentTimer, associated with a TAG containing the serving cell on which the HARQ feedback is to be transmitted may be running, and the UE may indicate a positive acknowledgment (ACK) for the SPS deactivation to the PHY layer.

The NDI in the received HARQ information may be 0, and the PDCCH content may indicate SPS activation. The UE may store the downlink assignment for this serving cell and the associated HARQ information as configured downlink assignment, and may initialize or re-initialize the configured downlink assignment for this serving cell to start in an associated PDSCH duration and to recur according to a configured periodicity.

For each serving cell and each configured downlink assignment (e.g., SPS PDSCH), if configured and activated, the MAC entity may instruct the PHY layer to receive, in this PDSCH duration, transport block on the DL-SCH according to the configured downlink assignment and to deliver it to the HARQ entity, e.g., if the PDSCH duration does not overlap with a PDSCH duration of a downlink assignment received on a PDCCH for this serving cell. The MAC entity may set the HARQ process number/ID to the HARQ process ID associated with this PDSCH duration, and may consider the NDI bit for the corresponding HARQ process to have been toggled. The MAC entity may indicate the presence of a configured downlink assignment (SPS PDSCH) and deliver the stored HARQ information to the HARQ entity.

The MAC entity may include a HARQ entity for each Serving Cell, which maintains a number of parallel HARQ processes. Each HARQ process may be associated with a HARQ process identifier/number. The HARQ entity directs HARQ information and associated TBs/CBGs received on the DL-SCH to the corresponding HARQ processes. A number of parallel DL HARQ processes per HARQ entity may be pre-defined or configured by RRC. The HARQ process may support one TB when the physical layer is not configured for downlink spatial multiplexing. The HARQ process may support one or two TBs when the physical layer is configured for downlink spatial multiplexing.

The MAC entity may be configured with repetition, e.g., pdsch-AggregationFactor>1, which provides a number of transmissions of a TB within a bundle of the downlink assignment. Bundling operation may rely on the HARQ entity for invoking the same HARQ process for each transmission that is part of the same bundle. After an initial transmission, pdsch-AggregationFactor−1 HARQ retransmissions may follow within a bundle.

When a transmission takes place for the HARQ process, one or two (in case of downlink spatial multiplexing) TBs and the associated HARQ information may be received from the HARQ entity. For each received TB and associated HARQ information, the HARQ process may consider the transmission to be a new transmission if the NDI, when provided, has been toggled compared to the value of the previous received transmission corresponding to this TB, and/or if this is a very first received transmission for this TB (e.g., there is no previous NDI for this TB). Otherwise, the HARQ process may consider this transmission to be a retransmission.

The MAC entity may attempt to decode the data, e.g., if this is a new transmission. The MAC entity may instruct the PHY layer to combine the received data with the data currently in the soft buffer for this TB and attempt to edcode the combined data, e.g., when this is a retransmission and/or the data for this TB has not yet been successfully decoded. The MAC entity may deliver the decoded MAC PDU to upper layers and/or the disassembly and demultiplexing entity, e.g. when the data for this TB is successfully decoded. The MAC entity may instruct the PHY layer to replace the data in the soft buffer for this TB with the data which the MAC entity attempted to decode, e.g. when the decoding is unsuccessful. The MAC entity may receive a retransmission with a TB size same as or different from the last TB size signalled for this TB.

A UE may receive a PDSCH without receiving a corresponding PDCCH (e.g., a configured downlink assignment and/or SPS PDSCH), and/or receive a PDCCH indicating a SPS PDSCH release. The UE may generate a corresponding HARQ-ACK information bit. If a UE is not configured with per-CBG retransmission (e.g., provided PDSCH-CodeBlockGroupTransmission), the UE may generate one HARQ-ACK information bit per transport block. For a HARQ-ACK information bit, a UE may generate an ACK, e.g. if the UE detects a DCI format 1_0 that provides a SPS PDSCH release and/or correctly decodes a transport block. For a HARQ-ACK information bit, a UE may generate a NACK if the UE does not correctly decode the transport block. A UE may or may not expect to be indicated to transmit HARQ-ACK information for more than one SPS PDSCH receptions in a same PUCCH.

A UE may multiplex UCI in a PUCCH transmission that overlaps with a PUSCH transmission. The UE may multiplex only HARQ-ACK information, if any, from the UCI in the PUSCH transmission (e.g. piggyback), and may not transmit the PUCCH, e.g., if the UE multiplexes aperiodic and/or semi-persistent CSI reports in the PUSCH.

A UE may not expect a PUCCH resource that results from multiplexing overlapped PUCCH resources, if applicable, to overlap with more than one PUSCHs, e.g., if each of the more than one PUSCHs includes aperiodic CSI reports.

A UE may not expect to detect a DCI format scheduling a PDSCH reception and/or a SPS PDSCH release and indicating a resource for a PUCCH transmission with corresponding HARQ-ACK information in a slot, e.g., if the UE previously detects a DCI format scheduling a PUSCH transmission in the slot and if the UE multiplexes HARQ-ACK information in the PUSCH transmission.

If a UE multiplexes aperiodic CSI in a PUSCH and the UE would multiplex UCI that includes HARQ-ACK information in a PUCCH that overlaps with the PUSCH and the timing conditions for overlapping PUCCHs and PUSCHs are fulfilled, the UE may multiplex only the HARQ-ACK information in the PUSCH and may not transmit the PUCCH.

If a UE transmits multiple PUSCHs in a slot on respective serving cells that include first PUSCHs that are scheduled by DCI format(s) 0_0 and/or DCI format(s) 0_1 and second PUSCHs configured by respective ConfiguredGrantConfig or semiPersistentOnPUSCH, and the UE would multiplex UCI in one of the multiple PUSCHs, and the multiple PUSCHs fulfil the conditions for UCI multiplexing, the UE may multiplex the UCI in a PUSCH from the first PUSCHs.

If a UE transmits multiple PUSCHs in a slot on respective serving cells and the UE would multiplex UCI in one of the multiple PUSCHs and the UE does not multiplex aperiodic CSI in any of the multiple PUSCHs, the UE may multiplex the UCI in a PUSCH of the serving cell with the smallest ServCellIndex subject to the conditions for UCI multiplexing being fulfilled. If the UE transmits more than one PUSCHs in the slot on the serving cell with the smallest ServCellIndex that fulfil the conditions for UCI multiplexing, the UE may multiplex the UCI in the earliest PUSCH that the UE transmits in the slot.

If a UE transmits a PUSCH over multiple slots and the UE would transmit a PUCCH with HARQ-ACK and/or CSI information over a single slot and in a slot that overlaps with the PUSCH transmission in one or more slots of the multiple slots, and the PUSCH transmission in the one or more slots fulfills the conditions for multiplexing the HARQ-ACK and/or CSI information, the UE may multiplex the HARQ-ACK and/or CSI information in the PUSCH transmission in the one or more slots. The UE may not multiplex HARQ-ACK and/or CSI information in the PUSCH transmission in a slot from the multiple slots, e.g., if the UE would not transmit a single-slot PUCCH with HARQ-ACK and/or CSI information in the slot in case the PUSCH transmission was absent.

If the PUSCH transmission over the multiple slots is scheduled by a DCI format 0_1, the same value of a DAI field may be applicable for multiplexing HARQ-ACK information in the PUSCH transmission in any slot from the multiple slots where the UE multiplexes HARQ-ACK information.

A HARQ-ACK information bit value of 0 represents a negative acknowledgement (NACK) while a HARQ-ACK information bit value of 1 represents a positive acknowledgement (ACK).

Dynamic scheduling may be a mode of operation in a wireless technology, e.g. NR. For each transmission time interval (TTI), e.g., a slot and/or a subframe, a scheduler (e.g., base station) may use control signaling to instruct a device to transmit or receive. It is flexible and can adapt to rapid variations in traffic behavior, but may require increased control signaling. The wireless technology may support transmission schemes not relying on dynamic grants/assignments.

In downlink, semi-persistent scheduling (SPS) may be supported. For a SPS configuration, a base station may provide a periodicity and/or an offset of the SPS occasions via RRC signaling and/or MAC CE signaling. The base station may transmit a SPS activation DCI via a PDCCH to activate the SPS. In an example, a first SPS activation DCI may comprise activations of one or more SPS configurations. The wireless device may use a first RNTI, e.g. CS-RNTI and/or C-RNTI for the SPS activation DCI. The SPS activation DCI may carry resource allocation information, e.g., time domain allocation, frequency domain allocation, BWP indicator, PRB bundling size indicator, CSI-RS trigger, MCS, NDI, DAI, and one or more first parameters for HARQ-ACK feedback, e.g., PDSCH-to-HARQ-feedback timing, CBGTI, and CBGFI, and one or more second parameters to support transmissions e.g., antenna ports, TCI, SRS request, power control, etc.

Once, the base station has activated a SPS configuration at a time m, the base station may transmit one or more data via PDSCH without accompanying a control channel/DCI/PDCCH via transmission occasions, where the transmission occasions is determined based on the resource allocation information carried via the SPS activation DCI and the periodicity and/or the offset of the SPS occasions. A wireless device may apply the resource allocations, the one or more first parameters for HARQ-ACK feedback and the one or more second parameters for subsequent data transmissions based on the SPS activation DCI and the SPS configuration. For example, the wireless device applies a same PDSCH-to-HARQ-feedback timing for each PDSCH transmitted via the SPS occasions. The base station may transmit a second SPS activation DCI to update one or more parameters or may transmit a SPS release DCI to deactivate the SPS configuration.

A HARQ process number for each SPS PDSCH occasion may be derived from a time when the downlink data transmission via the corresponding SPS PDSCH occasion starts. For configured downlink assignments, the HARQ Process ID associated with the slot where the DL transmission starts is derived from the following equation: HARQ Process ID=[floor (CURRENT_slot×10/(numberOfSlotsPerFrame×periodicity))] modulo nrofHARQ-Processes, wherein CURRENT_slot=[(SFN×numberOfSlotsPerFrame)+slot number in the frame] and numberOfSlotsPerFrame refers to the number of consecutive slots per frame.

Upon activation of SPS, the wireless device may receive downlink data transmission, e.g. periodically, according to a RRC configured periodicity, and using transmission parameters indicated in the PDCCH activating the transmission (activation DCI). Hence, control signaling may be used once and a signaling overhead may be reduced. After the activation/enabling of SPS, the wireless device may continue monitoring one or more sets of candidate PDCCHs (e.g., search space sets) for uplink and downlink scheduling commands. The base station may dynamically schedule downlink assignments for HARQ retransmission(s). For example, the base station may initially schedule downlink transmission of a first TB via a SPS PDSCH occasion, and dynamically schedule one or more retransmissions of the first TB via one or more downlink assignments.

A wireless device may validate, for scheduling activation (e.g., SPS activation) and/or scheduling release (e.g., SPS release/deactivation), a DL SPS assignment PDCCH. The wireless device may validate the SPS activation DCI and/or the SPS release/deactivation DCI. The SPS activation/deactivation DCI format may have a CRC scrambled with a first RNTI, e.g., CS-RNTI or C-RNTI. The base station may configure the wireless device the first RNTI, e.g., via RRC signaling. The SPS activation/deactivation DCI may comprise a field, indicating that this DCI format is for SPS activation/deactivation. For example, an NDI field of the DCI format may be set to a pre-defined value, e.g. 0, for the enabled transport block. The wireless device may determine the received DCI format is for SPS activation/release based on the field indicating the pre-defined value.

A validation of the DCI format may be achieved if one or more fields for the DCI format are set to one or more pre-defined values. For example, a first field of the DCI format corresponding to a HARQ process number may be set to all ‘0’s. For example, a second field of the DCI format corresponding to a redundancy version may be set to all ‘0’s (e.g., ‘00’). For example, a redundancy version for an enabled TB in an SPS activation DCI may be set to a pre-defined value, e.g. ‘00’. The wireless device may determine a DL SPS activation, e.g. if a received DCI format comprises of the first and the second fields set to the pre-defined values. For example, a third field corresponding to an MCS may be set to all ‘1’s in a DCI format for SPS release. For example, a fourth field corresponding to a frequency domain resource allocation may be set to all ‘1’s in a DCI format for SPS release. The wireless device may determine a DL SPS release, e.g. if a received DCI format comprises of the first and the second and the third and the fourth fields, all set to the pre-defined values. The wireless device may consider the information fields in the DCI format as a valid activation and/or release of one or more DL SPSs, e.g., if the validation is achieved. The wireless device may discard the information fields in the DCI format e.g. if the validation is not achieved.

The wireless device may provide/send HARQ-ACK information in response to receiving one or more DCIs indicating DL SPS activation and/or release. The wireless device may send the HARQ-ACK information in response to a SPS PDSCH release, e.g., after a time offset from a last symbol of a PDCCH providing the SPS release. The time offset may be one or more (e.g. N) symbols. The time offset may be determined based on a UE processing capability and/or subcarrier spacing of the PDCCH reception.

A UE may receive one or more RRC messages from the base station, comprising parameters for HARQ configuration. The parameters may indicate configuration of a semi-static codebook (e.g. Type-1 HARQ-ACK codebook), e.g., when the parameter pdsch-HARQ-ACK-Codebook=semi-static. The UE may report HARQ-ACK information for a corresponding PDSCH reception (e.g., SPS PDSCH reception) and/or SPS PDSCH release in a HARQ-ACK codebook. The UE may transmit the HARQ-ACK codebook in a slot indicated by a value of a PDSCH-to-HARQ-feedback timing indicator field in a corresponding DCI format (e.g. DCI format 1_0 or DCI format 1_1). The UE may report NACK value(s) for HARQ-ACK information bit(s) in a semi-static HARQ-ACK codebook that the UE transmits in a slot not indicated by a value of a PDSCH-to-HARQ-feedback timing indicator field in a corresponding DCI format.

The UE may be configured with repetition and/or slot aggregation. The UE may report HARQ-ACK information for a PDSCH reception that ends in a first slot (e.g. slot n) in a HARQ-ACK codebook that the UE includes in a PUCCH or PUSCH transmission in a second slot (e.g. slot n+k). The second slot may be indicated by an offset (e.g. k) from the first slot. For example, the offset (e.g. k) may be a number of slots indicated in a corresponding DCI format, e.g., by a PDSCH-to-HARQ-feedback timing indicator field. For example, the offset (e.g. k) may be a number of slots provided by RRC signaling, e.g., by parameter dl-DataToUL-ACK. The RRC signaling may be used, for example, when the PDSCH-to-HARQ-feedback timing indicator field is not present in the DCI format. The UE may set a value for each corresponding HARQ-ACK information bit to NACK, e.g., when the UE reports HARQ-ACK information for the PDSCH reception in a slot other than the second slot (e.g. slot n+k).

The UE may determine a set of occasions for candidate PDSCH reception for one or more serving cells and one or more UL and/or DL BWPs (e.g. active UL BWP(s) and/or active DL BWP(s)). The UE may transmit HARQ-ACK information corresponding to the set of occasions in a second slot, e.g. in a PUCCH or PUSCH. The determination may be based on a set of slot timing values (e.g. candidate K1 values). The set of slot timing values may be associated with one or more active UL BWPs.

For example, a slot timing value, K1, may be provided by a first set of slot timing values (e.g. a pre-defined set {1,2,3,4,5,6,7,8}, or a set configured by RRC signaling), for example, when the UE is configured to monitor PDCCH for a first DCI format (e.g. fallback DCI/DCI format 1_0) and not configured to monitor PDCCH for a second DCI format (e.g. non-fallback DCI/DCI format 1_1) on a serving cell. The first DCI format may indicate a first slot timing value, K1, from the first set of slot timing values.

The slot timing value, K1, may be provided by a second set of slot timing values. For example, the base station may configure the second set via RRC signaling, e.g. via parameter dl-DataToUL-ACK, which may comprise one or more values from a pre-defined set of numbers (e.g. 0 to 15). The second set may be used when the UE is configured to monitor PDCCH for the second DCI format (e.g. non-fallback DCI/DCI format 1_1). The second DCI format may indicate a second slot timing value, K1, from the second set of slot timing values.

The UE may receive a PDSCH (e.g. SPS PDSCH) in a first slot, and transmit the HARQ-ACK information corresponding to the PDSCH in a second slot, e.g. via a PUCCH and/or PUSCH. The second slot may be K1 slots after the first slot. A value of the K1 may be indicated via the DCI scheduling/activating the PDSCH.

Once the UE determines a PUCCH and/or PUSCH resource for HARQ-ACK codebook transmission, UE multiplexes one or more HARQ-ACK bits of one or more PDSCHs mapped to that PUCCH and/or PUSCH resource based on a PDSCH HARQ-ACK codebook. The PDSCH HARQ-ACK codebook may be configured by RRC signaling, e.g. a parameter pdsch-HARQ-ACK-Codebook may be configured as semi-static (type-1) or dynamic (type-2) codebook.

A location in a HARQ-ACK codebook (e.g. the Type-1/semi-static HARQ-ACK codebook) for HARQ-ACK information corresponding to a SPS PDSCH release may be same as for a corresponding SPS PDSCH reception. The location in the HARQ-ACK codebook for SPS PDSCH reception may be fixed and determined based on a timing of the SPS PDSCH reception. The location in the HARQ-ACK codebook for SPS PDSCH release may be fixed and determined based on a timing of a PDCCH reception indicating the SPS PDSCH release. A UE may not expect to receive SPS PDSCH release and unicast PDSCH in a same slot.

A UE may receive one or more RRC messages from the base station, comprising parameters for HARQ configuration. The parameters may indicate configuration of a dynamic codebook (e.g. Type-1 HARQ-ACK codebook), e.g., when the parameter pdsch-HARQ-ACK-Codebook=dynamic. The UE may determine monitoring occasions for PDCCH with a DCI format (e.g. DCI format 1_0 or DCI format 1_1) for scheduling PDSCH receptions (e.g. SPS PDSCH reception) and/or SPS PDSCH release, e.g. on an active DL BWP of a serving cell. The UE may transmit a HARQ-ACK information corresponding to the PDSCH reception and/or SPS PDSCH release in a slot, e.g. in a PUCCH or PUSCH. The UE may determine the slot based on a field in the DCI format, e.g. PDSCH-to-HARQ-feedback timing indicator field values for PUCCH transmission.

A set of PDCCH monitoring occasions for one or more DCI formats (e.g. DCI format 1_0 or DCI format 1_1) for scheduling PDSCH receptions and/or SPS PDSCH release may be defined as the union of PDCCH monitoring occasions across active DL BWPs of configured serving cells. The PDCCH monitoring occasions in the set may be ordered in ascending order of start time of a search space set associated with the PDCCH monitoring occasion. A cardinality of the set of PDCCH monitoring occasions may define a total number M of PDCCH monitoring occasions. A value of a counter downlink assignment indicator (cDAI) field in a DCI format may denote an accumulative number, e.g. of {serving cell, PDCCH monitoring occasion}-pair(s), in which PDSCH reception(s) or SPS PDSCH release associated with a DCI format is present, up to a current serving cell and current PDCCH monitoring occasion, e.g. first in ascending order of serving cell index and then in ascending order of PDCCH monitoring occasion index. A value of a total DAI, when present, in DCI format (e.g. DCI format 1_1) may denote a total number, e.g. of {serving cell, PDCCH monitoring occasion}-pair(s), in which PDSCH reception(s) or SPS PDSCH release associated with a DCI format is present, up to a current PDCCH monitoring occasion. The value of tDAI may be updated from PDCCH monitoring occasion to PDCCH monitoring occasion.

The UE may multiplex (e.g. append) a HARQ-ACK information bit associated with an SPS PDSCH reception at the end of a HARQ-ACK codebook, e.g. when dynamic codebook is configured. The UE may determine a location of a HARQ-ACK information bit associated with an SPS PDSCH release based on a cDAI and a tDAI in the PDCCH indicating the SPS PDSCH release.

In an example, with Bandwidth Adaptation (BA), a receive and a transmit bandwidth of a wireless device may not be as large as a bandwidth of a cell. The receive bandwidth and/or the transmit bandwidth of the wireless device may be adjusted. In an example, the width of the receive bandwidth and/or the transmit bandwidth may be ordered to change (e.g. to shrink during a period of low activity to save power). In an example, the location of the receive bandwidth and/or the transmit bandwidth may move in the frequency domain (e.g. to increase scheduling flexibility). In an example, the subcarrier spacing of the receive bandwidth and/or the transmit bandwidth may be ordered to change (e.g. to allow for different services). A subset of the total cell bandwidth of a cell may be referred to as a Bandwidth Part (BWP). BA may be achieved by configuring the wireless device with one or more BWPs and telling the wireless device which of the configured one or more BWPs is currently the active BWP.

A base station (gNB) may configure a wireless device (UE) with uplink (UL) BWPs and downlink (DL) BWPs to enable BA on a PCell. If carrier aggregation is configured, the gNB may configure the UE with at least DL BWP(s) (e.g., there may be no UL BWPS in the UL) to enable BA on an SCell.

For the PCell, an initial BWP may be a BWP used for initial access. In an example, the wireless device may operate on the initial BWP (e.g., initial UL/DL BWP) during the initial access.

For the SCell, an initial BWP may be a BWP configured for the UE to first operate at the SCell when the SCell is activated. In an example, in response to the SCell being activated, the wireless device may operate on the initial BWP.

In an example, a base station may configure a wireless device with one or more BWPs. In paired spectrum (e.g. FDD), a wireless device may switch a first DL BWP and a first UL BWP of the one or more BWPs independently. In unpaired spectrum (e.g. TDD), a wireless device may switch a second DL BWP and a second UL BWP of the one or more BWPs simultaneously. Switching between the configured one or more BWPs may happen via a DCI or an inactivity timer (e.g., BWP inactivity timer). In an example, when the inactivity timer is configured for a serving cell, an expiry of the inactivity timer associated to that cell may switch an active BWP of the serving cell to a default BWP. The default BWP may be configured by the network.

In an example, for FDD systems, when configured with BA, one UL BWP for each uplink carrier (e.g., SUL, NUL) and one DL BWP may be active at a time in an active serving cell. BWPs other than the one UL BWP and the one DL BWP that the UE may be configured with may be deactivated.

In an example, for TDD systems, one DL/UL BWP pair may be active at a time in an active serving cell. BWPs other than the one DL/UL BWP pair that the UE may be configured with may be deactivated.

In an example, operating on the one UL BWP and the one DL BWP (or the one DL/UL pair) may enable reasonable UE battery consumption. On deactivated BWPs, the UE may not monitor PDCCH, may not transmit on PUCCH, PRACH and UL-SCH.

In an example, when configured with BA, a wireless device may monitor a first PDCCH on an active BWP of a serving cell. In an example, the wireless device may not monitor a second PDCCH on an entire DL frequency/bandwidth of the cell. In an example, the wireless device may not monitor the second PDCCH on deactivated BWPs. In an example, a BWP inactivity timer may be used to switch the active BWP to a default BWP of the serving cell. In an example, the wireless device may (re)-start the BWP inactivity timer in response to successful PDCCH decoding on the serving cell. In an example, the wireless device may switch to the default BWP in response to an expiry of the BWP inactivity timer.

In an example, a wireless device may be configured with one or more BWPs for a serving cell (e.g., PCell, SCell). In an example, the serving cell may be configured with at most a first number (e.g., four) BWPs. In an example, for an activated serving cell, there may be one active BWP at any point in time.

In an example, a BWP switching for a serving cell may be used to activate an inactive BWP and deactivate an active BWP at a time. In an example, the BWP switching may be controlled by a PDCCH indicating a downlink assignment or an uplink grant. In an example, the BWP switching may be controlled by an inactivity timer (e.g. bwp-InactivityTimer). In an example, the BWP switching may be controlled by a MAC entity in response to initiating a Random Access procedure. In an example, the BWP switching may be controlled by an RRC signalling.

In an example, in response to RRC (re-)configuration of firstActiveDownlinkBWP-Id (e.g., included in RRC signaling) and/or firstActiveUplinkBWP-Id (e.g., included in RRC signaling) for a serving cell (e.g., SpCell), the wireless device may activate a DL BWP indicated by the firstActiveDownlinkBWP-Id and/or an UL BWP indicated by the firstActiveUplinkBWP-Id, respectively without receiving a PDCCH indicating a downlink assignment or an uplink grant. In an example, in response to an activation of an SCell, the wireless device may activate a DL BWP indicated by the firstActiveDownlinkBWP-Id and/or an UL BWP indicated by the firstActiveUplinkBWP-Id, respectively without receiving a PDCCH indicating a downlink assignment or an uplink grant.

In an example, an active BWP for a serving cell may be indicated by RRC signaling and/or PDCCH. In an example, for unpaired spectrum (e.g., time-division-duplex (TDD)), a DL BWP may be paired with a UL BWP, and BWP switching may be common (e.g., simultaneous) for the UL BWP and the DL BWP.

In an example, for an active BWP of an activated serving cell (e.g., PCell, SCell) configured with one or more BWPs, a wireless device may perform, on the active BWP, at least one of: transmitting on UL-SCH on the active BWP; transmitting on RACH on the active BWP if PRACH occasions are configured; monitoring a PDCCH on the active BWP; transmitting, if configured, PUCCH on the active BWP; reporting CSI for the active BWP; transmitting, if configured, SRS on the active BWP; receiving DL-SCH on the active BWP; (re-) initializing any suspended configured uplink grants of configured grant Type 1 on the active BWP according to a stored configuration, if any, and to start in a symbol based on some procedures.

In an example, for a deactivated BWP of an activated serving cell configured with one or more BWPs, a wireless device may not perform at least one of: transmitting on UL-SCH on the deactivated BWP; transmitting on RACH on the deactivated BWP; monitoring a PDCCH on the deactivated BWP; transmitting PUCCH on the deactivated BWP; reporting CSI for the deactivated BWP; transmitting SRS on the deactivated BWP, receiving DL-SCH on the deactivated BWP. In an example, for a deactivated BWP of an activated serving cell configured with one or more BWPs, a wireless device may clear any configured downlink assignment and configured uplink grant of configured grant Type 2 on the deactivated BWP; may suspend any configured uplink grant of configured Type 1 on the deactivated (or inactive) BWP.

In an example, a wireless device may initiate a random-access procedure (e.g., contention-based random access, contention-free random access) on a serving cell (e.g., PCell, SCell).

In an example, the base station may configure PRACH occasions for an active UL BWP of the serving cell of the wireless device. In an example, the active UL BWP may be identified with an uplink BWP ID (e.g., bwp-Id configured by higher layers (RRC)). In an example, the serving cell may be an SpCell. In an example, an active DL BWP of the serving cell of the wireless device may be identified with a downlink BWP ID (e.g., bwp-Id configured by higher layers (RRC)). In an example, the uplink BWP ID may be different from the downlink BWP ID. In an example, when the wireless device initiates the random-access procedure and the base station configures PRACH occasions for the active UL BWP and the serving cell is an SpCell, in response to the downlink BWP ID of the active DL BWP being different from the uplink BWP ID of the active UL BWP, a MAC entity of the wireless device may switch from the active DL BWP to a DL BWP, of the serving cell, identified with a second downlink BWP ID. In an example, the switching from the active DL BWP to the DL BWP may comprise setting the DL BWP as a second active DL BWP of the serving cell. In an example, the second downlink BWP ID may be the same as the uplink BWP ID. In response to the switching, the MAC entity may perform the random-access procedure on the DL BWP (e.g., the second active DL BWP) of the serving cell (e.g., SpCell) and the active UL BWP of the serving cell. In an example, in response to the initiating the random-access procedure, the wireless device may stop, if running, a BWP inactivity timer (e.g., bwp-InactivityTimer configured by higher layers (RRC)) associated with the DL BWP of the serving cell.

In an example, the base station may configure PRACH occasions for an active UL BWP of the serving cell of the wireless device. In an example, the serving cell may not be an SpCell. In an example, the serving cell may be an SCell. In an example, when the wireless device initiates the random-access procedure and the base station configures PRACH occasions for the active UL BWP and the serving cell is not an SpCell, a MAC entity of the wireless device may perform the random-access procedure on a first active DL BWP of an SpCell (e.g., PCell) and the active UL BWP of the serving cell. In an example, in response to the initiating the random-access procedure, the wireless device may stop, if running, a second BWP inactivity timer (e.g., bwp-InactivityTimer configured by higher layers (RRC)) associated with a second active DL BWP of the serving cell. In an example, in response to the initiating the random-access procedure and the serving cell being the SCell, the wireless device may stop, if running, a first BWP inactivity timer (e.g., bwp-InactivityTimer configured by higher layers (RRC)) associated with the first active DL BWP of the SpCell.

In an example, the base station may not configure PRACH occasions for an active UL BWP of the serving cell of the wireless device. In an example, when the wireless device initiates the random-access procedure on the serving cell, in response to the PRACH occasions not being configured for the active UL BWP of the serving cell, a MAC entity of the wireless device may switch from the active UL BWP to an uplink BWP (initial uplink BWP) of the serving cell. In an example, the uplink BWP may be indicated by an RRC signaling (e.g., initialUplinkBWP). In an example, the switching from the active UL BWP to the uplink BWP may comprise setting the uplink BWP as a current active UL BWP of the serving cell. In an example, the serving cell may be an SpCell. In an example, when the wireless device initiates the random-access procedure on the serving cell and the PRACH occasions are not configured for the active UL BWP of the serving cell, in response to the serving cell being an SpCell, the MAC entity may switch from an active DL BWP of the serving cell to a downlink BWP (e.g., initial downlink BWP) of the serving cell. In an example, the downlink BWP may be indicated by an RRC signaling (e.g., initialDownlinkBWP). In an example, the switching from the active DL BWP to the downlink BWP may comprise setting the downlink BWP as a current active DL BWP of the serving cell. In response to the switching, the MAC entity may perform the random-access procedure on the uplink BWP of the serving cell and the downlink BWP of the serving cell. In an example, in response to the initiating the random-access procedure, the wireless device may stop, if running, a BWP inactivity timer (e.g., bwp-InactivityTimer configured by higher layers (RRC)) associated with the downlink BWP (e.g., the current active DL BWP) of the serving cell.

In an example, the base station may not configure PRACH occasions for an active UL BWP of the serving cell (e.g., SCell) of the wireless device. In an example, when the wireless device initiates the random-access procedure on the serving cell, in response to the PRACH occasions not being configured for the active UL BWP of the serving cell, a MAC entity of the wireless device may switch from the active UL BWP to an uplink BWP (initial uplink BWP) of the serving cell. In an example, the uplink BWP may be indicated by an RRC signaling (e.g., initialUplinkBWP). In an example, the switching from the active UL BWP to the uplink BWP may comprise setting the uplink BWP as a current active UL BWP of the serving cell. In an example, the serving cell may not be an SpCell. In an example, the serving cell may be an SCell. In an example, in response to the serving cell not being the SpCell, the MAC entity may perform the random-access procedure on the uplink BWP of the serving cell and an active downlink BWP of an SpCell. In an example, in response to the initiating the random-access procedure, the wireless device may stop, if running, a second BWP inactivity timer (e.g., bwp-InactivityTimer configured by higher layers (RRC)) associated with a second active DL BWP of the serving cell. In an example, in response to the initiating the random-access procedure and the serving cell being the SCell, the wireless device may stop, if running, a first BWP inactivity timer (e.g., bwp-InactivityTimer configured by higher layers (RRC)) associated with the active DL BWP of the SpCell.

In an example, a MAC entity of a wireless device may receive a PDCCH for a BWP switching (e.g., UL BWP and/or DL BWP switching) of a serving cell. In an example, there may not be an ongoing random-access procedure associated with the serving cell when the MAC entity receives the PDCCH. In an example, in response to not being an ongoing random-access procedure associated with the serving cell when the MAC entity receives the PDCCH for the BWP switching of the serving cell, the MAC entity may perform the BWP switching to a BWP, of the serving cell, indicated by the PDCCH.

In an example, a MAC entity of a wireless device may receive a PDCCH for a BWP switching (e.g., UL BWP and/or DL BWP switching) of a serving cell. In an example, the PDCCH may be addressed to C-RNTI of the wireless device. In an example, there may be an ongoing random-access procedure associated with the serving cell. In an example, the wireless device may complete the ongoing random-access procedure associated with the serving cell (successfully) in response to the receiving the PDCCH addressed to the C-RNTI. In an example, in response to the completing the ongoing random-access procedure associated with the serving cell (successfully), the MAC entity may perform the BWP switching to a BWP, of the serving cell, indicated by the PDCCH.

In an example, a MAC entity of a wireless device may receive a PDCCH for a BWP switching (e.g., UL BWP and/or DL BWP switching) for a serving cell. In an example, there may be an ongoing random-access procedure associated with the serving cell in the MAC entity when the MAC entity receives the PDCCH. In an example, in response to being an ongoing random-access procedure associated with the serving cell when the MAC entity receives the PDCCH for the BWP switching of the serving cell, it may be up to UE implementation whether to perform the BWP switching or ignore the PDCCH for the BWP switching.

In an example, the MAC entity may perform the BWP switching in response to the receiving the PDCCH for the BWP switching (other than successful contention resolution for the random-access procedure). In an example, the performing the BWP switching may comprise switching to a BWP indicated by the PDCCH. In an example, in response to the performing the BWP switching, the MAC entity may stop the ongoing random access procedure and may initiate a second random-access procedure after the performing the BWP switching.

In an example, the MAC entity may ignore the PDCCH for the BWP switching. In an example, in response to the ignoring the PDCCH for the BWP switching, the MAC entity may continue with the ongoing random access procedure on the serving cell.

In an example, a base station may configure an activated serving cell of a wireless device with a BWP inactivity timer.

In an example, the base station may configure the wireless device with a default DL BWP ID for the activated serving cell (e.g., via RRC signaling including defaultDownlinkBWP-Id parameter). In an example, an active DL BWP of the activated serving cell may not be a BWP indicated by the default DL BWP ID.

In an example, the base station may not configure the wireless device with a default DL BWP ID for the activated serving cell (e.g., via RRC signaling including defaultDownlinkBWP-Id parameter). In an example, an active DL BWP of the activated serving cell may not be an initial downlink BWP (e.g., via RRC signaling including initialDownlinkBWP parameter) of the activated serving cell.

In an example, when the base station configures the wireless device with the default DL BWP ID and the active DL BWP of the activated serving cell is not the BWP indicated by the default DL BWP ID; or when the base station does not configure the wireless device with the default DL BWP ID and the active DL BWP is not the initial downlink BWP, the wireless device may start or restart the BWP inactivity timer associated with the active DL BWP of the activated serving cell in response to receiving a PDCCH, on the active DL BWP, indicating a downlink assignment or an uplink grant. In an example, the PDCCH may be addressed to C-RNTI. In an example, the PDCCH may be addressed to CS-RNTI.

In an example, when the base station configures the wireless device with the default DL BWP ID and the active DL BWP of the activated serving cell is not the BWP indicated by the default DL BWP ID; or when the base station does not configure the wireless device with the default DL BWP ID and the active DL BWP is not the initial downlink BWP, the wireless device may start or restart the BWP inactivity timer associated with the active DL BWP of the activated serving cell in response to receiving a PDCCH, for the active DL BWP, indicating a downlink assignment or an uplink grant. In an example, the PDCCH may be addressed to C-RNTI. In an example, the PDCCH may be addressed to CS-RNTI.

In an example, the wireless device may receive the PDCCH when there is no ongoing random-access procedure associated with the activated serving cell. In an example, the wireless device may receive the PDCCH when there is an ongoing random-access procedure associated with the activated serving cell and the ongoing random-access procedure is completed successfully in response to the receiving the PDCCH addressed to a C-RNTI of the wireless device.

In an example, when the base station configures the wireless device with the default DL BWP ID and the active DL BWP of the activated serving cell is not the BWP indicated by the default DL BWP ID; or when the base station does not configure the wireless device with the default DL BWP ID and the active DL BWP is not the initial downlink BWP, the wireless device may start or restart the BWP inactivity timer associated with the active DL BWP of the activated serving cell in response to transmitting a first MAC PDU in a configured uplink grant or receiving a second MAC PDU in a configured downlink assignment.

In an example, the wireless device may transmit the first MAC PDU and/or receive the second MAC PDU when there is no ongoing random-access procedure associated with the activated serving cell.

In an example, the BWP inactivity timer associated with the active DL BWP of the activated serving cell may expire.

In an example, the base station may configure the wireless device with the default DL BWP ID. In an example, when the base station configures the wireless device with the default DL BWP ID, in response to the BWP inactivity timer expiring, a MAC entity of the wireless device may perform BWP switching to a BWP indicated by the default DL BWP ID.

In an example, the base station may not configure the wireless device with the default DL BWP ID. In an example, when the base station does not configure the wireless device with the default DL BWP ID, in response to the BWP inactivity timer expiring, a MAC entity of the wireless device may perform BWP switching to the initial downlink BWP (e.g., initialDownlinkBWP in RRC signalling).

In an example, a wireless device may initiate a random-access procedure on a secondary cell (e.g., SCell). In an example, the wireless device may monitor for a random-access response for the random-access procedure on a SpCell. In an example, when the wireless device initiates the random-access procedure on the secondary cell, the secondary cell and the SpCell may be associated with the random-access procedure in response to the monitoring the random-access response to the SpCell.

In an example, a wireless device may receive a PDCCH for a BWP switching (e.g., UL and/or DL BWP switching). In an example, a MAC entity of the wireless device may switch from a first active DL BWP of the activated serving cell to a BWP (e.g., DL BWP) of the activated serving cell in response to the receiving the PDCCH. In an example, the switching from the first active DL BWP to the BWP may comprise setting the BWP as a current active DL BWP of the activated serving cell. In an example, the wireless device may deactivate the first active DL BWP in response to the switching.

In an example, the base station may configure the wireless device with a default DL BWP ID. In an example, the BWP may not be indicated (or identified) by the default DL BWP ID. In an example, when the base station configures the wireless device with the default DL BWP ID and the MAC entity of the wireless device switches from the first active DL BWP of the activated serving cell to the BWP, the wireless device may start or restart the BWP inactivity timer associated with the BWP (e.g., the current active DL BWP) in response to the BWP not being the default DL BWP (or the BWP not being indicated by the default DL BWP ID).

In an example, the base station may not configure the wireless device with a default DL BWP ID. In an example, the BWP may not be the initial downlink BWP of the activated serving cell. In an example, when the base station does not configure the wireless device with the default DL BWP ID and the MAC entity of the wireless device switches from the first active DL BWP of the activated serving cell to the BWP, the wireless device may start or restart the BWP inactivity timer associated with the BWP (e.g., the current active DL BWP) in response to the BWP not being the initial downlink BWP.

In an example, when configured with carrier aggregation (CA), a base station may configure a wireless device with a secondary cell (e.g., SCell). In an example, a wireless device may receive an SCell Activation/Deactivation MAC CE activating the secondary cell. In an example, the secondary cell may be deactivated prior to the receiving the SCell Activation/Deactivation MAC CE. In an example, when a wireless device receives the SCell Activation/Deactivation MAC CE activating the secondary cell, the wireless device may activate a downlink BWP of the secondary cell and activate an uplink BWP of the secondary cell in response to the secondary cell being deactivated prior to the receiving the SCell Activation/Deactivation MAC CE. In an example, the downlink BWP may be indicated by the firstActiveDownlinkBWP-Id. In an example, the uplink BWP may be indicated by the firstActiveUplinkBWP-Id.

In an example, the base station may configure a wireless device with a BWP inactivity timer for the activated secondary cell. In an example, an sCellDeactivationTimer associated with the activated secondary cell may expire. In an example, in response to the sCellDeactivationTimer expiring, the wireless device may stop the BWP inactivity timer associated with the activated secondary cell. In an example, in response to the sCellDeactivationTimer expiring, the wireless device may deactivate an active downlink BWP (e.g., and an active UL BWP if exists) associated with the activated secondary cell.

In an example, when configured for operation in bandwidth parts (BWPs) of a serving cell, a wireless device (e.g., a UE) may be configured, by higher layers with a parameter BWP-Downlink, a first set of BWPs (e.g., at most four BWPs) for receptions, by the UE, (e.g., DL BWP set) in a downlink (DL) bandwidth for the serving cell.

In an example, when configured for operation in bandwidth parts (BWPs) of a serving cell, a wireless device (e.g., a UE) may be configured, by higher layers with a parameter BWP-Uplink, a second set of BWPs (e.g., at most four BWPs) for transmissions, by the UE, (e.g., UL BWP set) in a uplink (UL) bandwidth for the serving cell.

In an example, the base station may not provide a wireless device with a higher layer parameter initialDownlinkBWP. In response to the not providing the wireless device with the higher layer parameter initialDownlinkBWP, an initial active DL BWP may be defined, for example, by a location and a number of contiguous PRBs, and a subcarrier spacing (SCS) and a cyclic prefix for PDCCH reception in a control resource set (CORESET) for Type0-PDCCH common search space (CSS) set. In an example, the contiguous PRBs may start from a first PRB with a lowest index among PRBs of the CORESET for the Type0-PDCCH CSS set.

In an example, the base station may provide a wireless device with a higher layer parameter initialDownlinkBWP. In an example, an initial active DL BWP may be provided by the higher layer parameter initialDownlinkBWP in response to the providing.

In an example, for operation on a cell (e.g., primary cell, secondary cell), a base station may provide a wireless device with an initial active UL BWP by a higher layer parameter (e.g., initialUplinkBWP). In an example, when configured with a supplementary uplink carrier (SUL), the base station may provide the wireless device with a second initial active uplink BWP on the supplementary uplink carrier by a second higher layer parameter (e.g., initialUplinkBWP in supplementaryUplink).

In an example, a wireless device may have a dedicated BWP configuration.

In an example, in response to the wireless device having the dedicated BWP configuration, the wireless device may be provided by a higher layer parameter (e.g., firstActiveDownlinkBWP-Id). The higher layer parameter may indicate a first active DL BWP for receptions.

In an example, in response to the wireless device having the dedicated BWP configuration, the wireless device may be provided by a higher layer parameter (e.g., firstActiveUplinkBWP-Id). The higher layer parameter may indicate a first active UL BWP for transmissions on a carrier (e.g., SUL, NUL) of a serving cell (e.g., primary cell, secondary cell).

In an example, for a DL BWP in a first set of BWPs or an UL BWP in a second set of BWPs, a base station may configure a wireless device for a serving cell with at least one of: a subcarrier spacing provided by a higher layer parameter subcarrierSpacing; a cyclic prefix provided by a higher layer parameter cyclicPrefix; an index in the first set of BWPs or in the second set of BWPs by a higher layer parameter bwp-Id (e.g., bwp-Id); a third set of BWP-common and a fourth set of BWP-dedicated parameters by a higher layer parameter bwp-Common and a higher layer parameter bwp-Dedicated, respectively. In an example, the base station may further configure the wireless device for the serving cell with a common RB N_{BWP}^{start}=O_{carrier}+RBₛₜₐᵣₜ and a number of contiguous RBs N_{BWP}^{size}=L_{RB} provided by a higher layer parameter locationAndBandwidth. In an example, the higher layer parameter locationAndBandwidth may indicate an offset RBₛₜₐᵣₜ and a length L_{RB} as Resource indicator value (RIV), setting N_{BWP}^{size}=275, and a value O_{carrier} provided by a higher layer parameter offsetToCarrier for the higher layer parameter subcarrierSpacing

In an example, for an unpaired spectrum operation, a DL BWP, from a first set of BWPs, with a DL BWP index provided by a higher layer parameter bwp-Id (e.g., bwp-Id) may be linked with an UL BWP, from a second set of BWPs, with an UL BWP index provided by a higher layer parameter bwp-Id (e.g., bwp-Id) when the DL BWP index of the DL BWP is same as the UL BWP index of the UL BWP.

In an example, a DL BWP index of a DL BWP may be same as an UL BWP index of an UL BWP. In an example, for an unpaired spectrum operation, a wireless device may not expect to receive a configuration (e.g., RRC configuration), where a first center frequency for the DL BWP is different from a second center frequency for the UL BWP in response to the DL BWP index of the DL BWP being the same as the UL BWP index of the UL BWP.

In an example, for a DL BWP in a first set of BWPs on a serving cell (e.g., primary cell), a base station may configure a wireless device with one or more control resource sets (CORESETs) for every type of common search space (CSS) sets and for UE-specific search space (USS). In an example, the wireless device may not expect to be configured without a common search space set on a primary cell (or on the PSCell), in an active DL BWP.

In an example, a base station may provide a wireless device with a higher layer parameter controlResourceSetZero and a higher layer parameter searchSpaceZero in a higher layer parameter PDCCH-ConfigSIB1 or a higher layer parameter PDCCH-ConfigCommon. In an example, in response to the providing, the wireless device may determine a CORESET for a search space set from the higher layer parameter controlResourcesetZero, and may determine corresponding PDCCH monitoring occasions. An active DL BWP of a serving cell may not be an initial DL BWP of the serving cell. When the active DL BWP is not the initial DL BWP of the serving cell, the wireless device may determine the PDCCH monitoring occasions for the search space set in response to a bandwidth of the CORESET being within the active DL BWP and the active DL BWP having the same SCS configuration and same cyclic prefix as the initial DL BWP.

In an example, for an UL BWP in a second set of BWPs of a serving cell (e.g., primary cell or PUCCH SCell), a base station may configure a wireless device with one or more resource sets (e.g., time-frequency resources/occasions) for PUCCH transmissions.

In an example, a UE may receive PDCCH and PDSCH in a DL BWP according to a configured subcarrier spacing and CP length for the DL BWP.

In an example, a UE may transmit PUCCH and PUSCH in an UL BWP according to a configured subcarrier spacing and CP length for the UL BWP.

In an example, a bandwidth part indicator field may be configured in a DCI format (e.g., DCI format 1_1). In an example, a value of the bandwidth part indicator field may indicate an active DL BWP, from a first set of BWPs, for one or more DL receptions. In an example, the bandwidth part indicator field may indicate a DL BWP different from the active DL BWP. In an example, in response to the bandwidth part indicator field indicating the DL BWP different from the active DL BWP, the wireless device may set the DL BWP as a current active DL BWP. In an example, the setting the DL BWP as a current active DL BWP may comprise activating the DL BWP and deactivating the active DL BWP.

In an example, a bandwidth part indicator field may be configured in a DCI format (e.g., DCI format 0_1). In an example, a value of the bandwidth part indicator field may indicate an active UL BWP, from a second set of BWPs, for one or more UL transmissions. In an example, the bandwidth part indicator field may indicate an UL BWP different from the active UL BWP. In an example, in response to the bandwidth part indicator field indicating the UL BWP different from the active UL BWP, the wireless device may set the UL BWP as a current active UL BWP. In an example, the setting the UL BWP as a current active UL BWP may comprise activating the UL BWP and deactivating the active UL BWP.

In an example, a DCI format (e.g., DCI format 1_1) indicating an active DL BWP change may comprise a time domain resource assignment field. The time domain resource assignment field may provide a slot offset value for a PDSCH reception. In an example, the slot offset value may be smaller than a delay required by a wireless device for the active DL BWP change. In an example, in response to the slot offset value being smaller than the delay required by the wireless device for the active DL BWP change, the wireless device may not expect to detect the DCI format indicating the active DL BWP change.

In an example, a DCI format (e.g., DCI format 0_1) indicating an active UL BWP change may comprise a time domain resource assignment field. The time domain resource assignment field may provide a slot offset value for a PUSCH transmission. In an example, the slot offset value may be smaller than a delay required by a wireless device for the active UL BWP change. In an example, in response to the slot offset value being smaller than the delay required by the wireless device for the active UL BWP change, the wireless device may not expect to detect the DCI format indicating the active UL BWP change.

In an example, a wireless device may receive a PDCCH in a slot of a scheduling cell. In an example, the wireless device may detect a DCI format (e.g., DCI format 1_1), in the PDCCH of the scheduling cell, indicating an active DL BWP change for a serving cell. In an example, the DCI format may comprise a time domain resource assignment field. The time domain resource assignment field may provide a slot offset value for a PDSCH transmission. In an example, the slot offset value may indicate a second slot. In an example, in response to the detecting the DCI format indicating the active DL BWP change, the wireless device may not be required to receive or transmit in the serving cell during a time duration from the end of a third symbol of the slot until the beginning of the second slot.

In an example, a wireless device may receive a PDCCH in a slot of a scheduling cell. In an example, the wireless device may detect a DCI format (e.g., DCI format 0_1), in the PDCCH of the scheduling cell, indicating an active UL BWP change for a serving cell. In an example, the DCI format may comprise a time domain resource assignment field. The time domain resource assignment field may provide a slot offset value for a PUSCH transmission. In an example, the slot offset value may indicate a second slot. In an example, in response to the detecting the DCI format indicating the active UL BWP change, the wireless device may not be required to receive or transmit in the serving cell during a time duration from the end of a third symbol of the slot until the beginning of the second slot.

In an example, a UE may expect to detect a DCI format 0_1 indicating active UL BWP change/switch, or a DCI format 1_1 indicating active DL BWP change/switch, when a corresponding PDCCH for the detected DCI format 0_1 or the detected DCI format 1_1 is received within first 3 symbols of a slot. In an example, a UE may not expect to detect a DCI format 0_1 indicating active UL BWP change/switch, or a DCI format 1_1 indicating active DL BWP change/switch, if a corresponding PDCCH is received after first 3 symbols of a slot.

In an example, an active DL BWP change may comprise switching from the active DL BWP of a serving cell to a DL BWP of the serving cell. In an example, the switching from the active DL BWP to the DL BWP may comprise setting the DL BWP as a current active DL BWP and deactivating the active DL BWP.

In an example, an active UL BWP change may comprise switching from the active UL BWP of a serving cell to a UL BWP of the serving cell. In an example, the switching from the active UL BWP to the UL BWP may comprise setting the UL BWP as a current active UL BWP and deactivating the active UL BWP.

In an example, for a serving cell (e.g., PCell, SCell), a base station may provide a wireless device with a higher layer parameter defaultDownlinkBWP-Id. In an example, the higher layer parameter defaultDownlinkBWP-Id may indicate a default DL BWP among the first set of (configured) BWPs of the serving cell.

In an example, a base station may not provide a wireless device with a higher layer parameter defaultDownlinkBWP-Id. In response to not being provided by the higher layer parameter defaultDownlinkBWP-Id, the wireless device may set the initial active DL BWP as a default DL BWP. In an example, in response to not being provided by the higher layer parameter defaultDownlinkBWP-Id, the default DL BWP may be the initial active DL BWP.

In an example, a base station may provide a wireless device with a higher layer parameter BWP-InactivityTimer. In an example, the higher layer parameter BWP-InactivityTimer may indicate a BWP inactivity timer with a timer value for a serving cell (e.g., primary cell, secondary cell). In an example, when provided with the higher layer parameter BWP-InactivityTimer and the BWP inactivity timer is running, the wireless device may decrement the BWP inactivity timer at the end of a subframe for frequency range 1 (e.g., FR1, sub-6 GHz) or at the end of a half subframe for frequency range 2 (e.g., FR2, millimeter-waves) in response to not restarting the BWP inactivity timer during an interval of the subframe for the frequency range 1 or an interval of the half subframe for the frequency range 2.

In an example, a wireless device may perform an active DL BWP change for a serving cell in response to an expiry of a BWP inactivity timer associated with the serving cell. In an example, the wireless device may not be required to receive or transmit in the serving cell during a time duration from the beginning of a subframe for frequency range 1 or of half of a subframe for frequency range 2. The time duration may start/be immediately after the expiry of the BWP inactivity timer and may last until the beginning of a slot where the wireless device can receive and/or transmit.

In an example, a base station may provide a wireless device with a higher layer parameter firstActiveDownlinkBWP-Id of a serving cell (e.g., secondary cell). In an example, the higher layer parameter firstActiveDownlinkBWP-Id may indicate a DL BWP on the serving cell (e.g., secondary cell). In an example, in response to the being provided by the higher layer parameter firstActiveDownlinkBWP-Id, the wireless device may use the DL BWP as a first active DL BWP on the serving cell.

In an example, a base station may provide a wireless device with a higher layer parameter firstActiveUplinkBWP-Id on a carrier (e.g., SUL, NUL) of a serving cell (e.g., secondary cell). In an example, the higher layer parameter firstActiveUplinkBWP-Id may indicate an UL BWP. In an example, in response to the being provided by the higher layer parameter firstActiveUplinkBWP-Id, the wireless device may use the UL BWP as a first active UL BWP on the carrier of the serving cell.

In an example, for paired spectrum operation, a UE may not expect to transmit a PUCCH with HARQ-ACK information on a PUCCH resource indicated by a DCI format 1_0 or a DCI format 1_1 if the UE changes its active UL BWP on a primary cell between a time of a detection of the DCI format 1_0 or the DCI format 1_1 and a time of a corresponding PUCCH transmission with the HARQ-ACK information.

In an example, a UE may not monitor PDCCH when the UE performs RRM measurements over a bandwidth that is not within the active DL BWP for the UE.

In an example, a DL BWP index (ID) may be an identifier for a DL BWP. One or more parameters in an RRC configuration may use the DL BWP-ID to associate the one or more parameters with the DL BWP. In an example, the DL BWP ID=0 may be associated with the initial DL BWP.

In an example, an UL BWP index (ID) may be an identifier for an UL BWP. One or more parameters in an RRC configuration may use the UL BWP-ID to associate the one or more parameters with the UL BWP. In an example, the UL BWP ID=0 may be associated with the initial UL BWP.

If a higher layer parameter firstActiveDownlinkBWP-Id is configured for an SpCell, a higher layer parameter firstActiveDownlinkBWP-Id indicates an ID of a DL BWP to be activated upon performing the reconfiguration.

If a higher layer parameter firstActiveDownlinkBWP-Id is configured for an SCell, a higher layer parameter firstActiveDownlinkBWP-Id indicates an ID of a DL BWP to be used upon MAC-activation of the SCell.

If a higher layer parameter firstActiveUplinkBWP-Id is configured for an SpCell, a higher layer parameter firstActiveUplinkBWP-Id indicates an ID of an UL BWP to be activated upon performing the reconfiguration.

If a higher layer parameter firstActiveUplinkBWP-Id is configured for an SCell, a higher layer parameter firstActiveUplinkBWP-Id indicates an ID of an UL BWP to be used upon MAC-activation of the SCell.

In an example, a wireless device, to execute a reconfiguration with sync, may consider an uplink BWP indicated in a higher layer parameter firstActiveUplinkBWP-Id to be an active uplink BWP.

In an example, a wireless device, to execute a reconfiguration with sync, may consider a downlink BWP indicated in a higher layer parameter firstActiveDownlinkBWP-Id to be an active downlink BWP.

The amount of data traffic carried over cellular networks is expected to increase for many years to come. The number of users/devices is increasing, and each user/device accesses an increasing number and variety of services, e.g. video delivery, large files, images. This requires not only high capacity in the network, but also provisioning of very high data rates to meet customer expectations on interactivity and responsiveness. More spectrum is therefore needed for cellular operators to meet the increasing demand. Considering user expectations of high data rates along with seamless mobility, it is beneficial that more spectrum be made available for deploying macro cells as well as small cells for cellular systems.

Striving to meet the market demands, there has been increasing interest from operators in deploying some complementary access utilizing unlicensed spectrum to meet the traffic growth. This is exemplified by the large number of operator-deployed Wi-Fi networks and the 3GPP standardization of interworking solutions with Wi-Fi, e.g., LTE/WLAN interworking. This interest indicates that unlicensed spectrum, when present, may be an effective complement to licensed spectrum for cellular operators to address the traffic explosion in some scenarios, such as hotspot areas. For example, licensed assisted access (LAA) and/or new radio on unlicensed band(s) (NR-U) may offer an alternative for operators to make use of unlicensed spectrum while managing one radio network, thus offering new possibilities for optimizing the network's efficiency.

In an example embodiment, Listen-before-talk (LBT) may be implemented for transmission in an unlicensed cell. The unlicensed cell may be referred to as a LAA cell and/or a NR-U cell. The unlicensed cell may be operated as non-standalone with an anchor cell in a licensed band or standalone without an anchor cell in a licensed band. LBT may comprise a clear channel assessment (CCA). For example, in an LBT procedure, equipment may apply a CCA before using the unlicensed cell or channel. The CCA may comprise an energy detection that determines the presence of other signals on a channel (e.g., channel is occupied) or absence of other signals on a channel (e.g., channel is clear). A regulation of a country may impact the LBT procedure. For example, European and Japanese regulations mandate the usage of LBT in the unlicensed bands, such as the 5 GHz unlicensed band. Apart from regulatory requirements, carrier sensing via LBT may be one way for fairly sharing the unlicensed spectrum among different devices and/or networks attempting to utilize the unlicensed spectrum.

In an example embodiment, discontinuous transmission on an unlicensed band with limited maximum transmission duration may be enabled. Some of these functions may be supported by one or more signals to be transmitted from the beginning of a discontinuous downlink transmission in the unlicensed band. Channel reservation may be enabled by the transmission of signals, by an NR-U node, after or in response to gaining channel access based on a successful LBT operation. Other nodes may receive the signals (e.g., transmitted for the channel reservation) with an energy level above a certain threshold that may sense the channel to be occupied. Functions that may need to be supported by one or more signals for operation in unlicensed band with discontinuous downlink transmission may comprise one or more of the following: detection of the downlink transmission in unlicensed band (including cell identification) by wireless devices; time & frequency synchronization of wireless devices.

In an example embodiment, downlink transmission and frame structure design for operation in an unlicensed band may employ subframe, (mini-)slot, and/or symbol boundary alignment according to timing relationships across serving cells aggregated by carrier aggregation. This may not imply that base station transmissions start at the subframe, (mini-)slot, and/or symbol boundary. Unlicensed cell operation (e.g., LAA and/or NR-U) may support transmitting PDSCH, for example, when not all OFDM symbols are available for transmission in a subframe according to LBT. Delivery of necessary control information for the PDSCH may also be supported.

An LBT procedure may be employed for fair and friendly coexistence of a 3GPP system (e.g., LTE and/or NR) with other operators and technologies operating in unlicensed spectrum. For example, a node attempting to transmit on a carrier in unlicensed spectrum may perform a CCA as a part of an LBT procedure to determine if the channel is free for use. The LBT procedure may involve energy detection to determine if the channel is being used. For example, regulatory requirements in some regions, e.g., in Europe, specify an energy detection threshold such that if a node receives energy greater than the threshold, the node assumes that the channel is being used and not free. While nodes may follow such regulatory requirements, a node may optionally use a lower threshold for energy detection than that specified by regulatory requirements. A radio access technology (e.g., LTE and/or NR) may employ a mechanism to adaptively change the energy detection threshold. For example, NR-U may employ a mechanism to adaptively lower the energy detection threshold from an upper bound. An adaptation mechanism may not preclude static or semi-static setting of the threshold. In an example Category 4 LBT (CAT4 LBT) mechanism or other type of LBT mechanisms may be implemented.

Various example LBT mechanisms may be implemented. In an example, for some signals, in some implementation scenarios, in some situations, and/or in some frequencies no LBT procedure may be performed by the transmitting entity. In an example, Category 1 (CAT1, e.g., no LBT) may be implemented in one or more cases. For example, a channel in unlicensed band may be hold by a first device (e.g., a base station for DL transmission), and a second device (e.g., a wireless device) takes over the for a transmission without performing the CAT1 LBT. In an example, Category 2 (CAT2, e.g. LBT without random back-off and/or one-shot LBT) may be implemented. The duration of time determining that the channel is idle may be deterministic (e.g., by a regulation). A base station may transmit an uplink grant indicating a type of LBT (e.g., CAT2 LBT) to a wireless device. CAT1 LBT and CAT2 LBT may be employed for Channel occupancy time (COT) sharing. For example, a base station (a wireless device) may transmit an uplink grant (resp. uplink control information) comprising a type of LBT. For example, CAT1 LBT and/or CAT2 LBT in the uplink grant (or uplink control information) may indicate, to a receiving device (e.g., a base station, and/or a wireless device) to trigger COT sharing. In an example, Category 3 (CAT3, e.g. LBT with random back-off with a contention window of fixed size) may be implemented. The LBT procedure may have the following procedure as one of its components. The transmitting entity may draw a random number N within a contention window. The size of the contention window may be specified by the minimum and maximum value of N. The size of the contention window may be fixed. The random number N may be employed in the LBT procedure to determine the duration of time that the channel is sensed to be idle before the transmitting entity transmits on the channel. In an example, Category 4 (CAT4, e.g. LBT with random back-off with a contention window of variable size) may be implemented. The transmitting entity may draw a random number N within a contention window. The size of contention window may be specified by the minimum and maximum value of N. The transmitting entity may vary the size of the contention window when drawing the random number N. The random number N may be used in the LBT procedure to determine the duration of time that the channel is sensed to be idle before the transmitting entity transmits on the channel.

In an example, a wireless device may employ uplink (UL) LBT. The UL LBT may be different from a downlink (DL) LBT (e.g. by using different LBT mechanisms or parameters) for example, since the NR-U UL may be based on scheduled access which affects a wireless device's channel contention opportunities. Other considerations motivating a different UL LBT comprise, but are not limited to, multiplexing of multiple wireless devices in a subframe (slot, and/or mini-slot).

In an example, DL transmission burst(s) may be a continuous (unicast, multicast, broadcast, and/or combination thereof) transmission by a base station (e.g., to one or more wireless devices) on a carrier component (CC). UL transmission burst(s) may be a continuous transmission from one or more wireless devices to a base station on a CC. In an example, DL transmission burst(s) and UL transmission burst(s) on a CC in an unlicensed spectrum may be scheduled in a TDM manner over the same unlicensed carrier. Switching between DL transmission burst(s) and UL transmission burst(s) may require an LBT (e.g., CAT1 LBT, CAT2 LBT, CAT3 LBT, and/or CAT4 LBT). For example, an instant in time may be part of a DL transmission burst or an UL transmission burst.

Channel occupancy time (COT) sharing may be employed in NR-U. COT sharing may be a mechanism by which one or more wireless devices share a channel that is sensed as idle by at least one of the one or more wireless devices. For example, one or more first devices may occupy a channel via an LBT (e.g., the channel is sensed as idle based on CAT4 LBT) and one or more second devices may share the channel using an LBT (e.g., 25 us LBT) within a maximum COT (MCOT) limit. For example, the MCOT limit may be given per priority class, logical channel priority, and/or wireless device specific. COT sharing may allow a concession for UL in unlicensed band. For example, a base station may transmit an uplink grant to a wireless device for a UL transmission. For example, a base station may occupy a channel and transmit, to one or more wireless devices a control signal indicating that the one or more wireless devices may use the channel. For example, the control signal may comprise an uplink grant and/or a particular LBT type (e.g., CAT1 LBT and/or CAT2 LBT). The one or more wireless device may determine COT sharing based at least on the uplink grant and/or the particular LBT type. The wireless device may perform UL transmission(s) with dynamic grant and/or configured grant (e.g., Type 1, Type2, autonomous UL) with a particular LBT (e.g., CAT2 LBT such as 25 us LBT) in the configured period, for example, if a COT sharing is triggered. A COT sharing may be triggered by a wireless device. For example, a wireless device performing UL transmission(s) based on a configured grant (e.g., Type 1, Type2, autonomous UL) may transmit an uplink control information indicating the COT sharing (UL-DL switching within a (M)COT). A starting time of DL transmission(s) in the COT sharing triggered by a wireless device may be indicated in one or more ways. For example, one or more parameters in the uplink control information indicate the starting time. For example, resource configuration(s) of configured grant(s) configured/activated by a base station may indicate the starting time. For example, a base station may be allowed to perform DL transmission(s) after or in response to UL transmission(s) on the configured grant (e.g., Type 1, Type 2, and/or autonomous UL). There may be a delay (e.g., at least 4 ms) between the uplink grant and the UL transmission. The delay may be predefined, semi-statically configured (via an RRC message) by a base station, and/or dynamically indicated (e.g., via an uplink grant) by a base station. The delay may not be accounted in the COT duration.

In an example, single and multiple DL to UL and UL to DL switching within a shared COT may be supported. Example LBT requirements to support single or multiple switching points, may comprise: for a gap of less than 16 us: no-LBT may be used; for a gap of above 16 us but does not exceed 25 us: one-shot LBT may be used; for single switching point, for a gap from DL transmission to UL transmission exceeds 25 us: one-shot LBT may be used; for multiple switching points, for a gap from DL transmission to UL transmission exceeds 25 us, one-shot LBT may be used.

In an example, a signal that facilitates its detection with low complexity may be useful for wireless device power saving, improved coexistence, spatial reuse at least within the same operator network, serving cell transmission burst acquisition, etc. In an example, a radio access technology (e.g., LTE and/or NR) may employ a signal comprising at least SS/PBCH block burst set transmission. Other channels and signals may be transmitted together as part of the signal. In an example, the signal may be a discovery reference signal (DRS). There may be no gap within a time span that the signal is transmitted at least within a beam. In an example, a gap may be defined for beam switching. In an example, a block-interlaced based PUSCH may be employed. In an example, the same interlace structure for PUCCH and PUSCH may be used. In an example, interlaced based PRACH may be used.

In an example, initial active DL/UL BWP may be approximately 20 MHz for a first unlicensed band, e.g., in a 5 GHz unlicensed band. An initial active DL/UL BWP in one or more unlicensed bands may be similar (e.g., approximately 20 MHz in a 5 GHz and/or 6 GHz unlicensed spectrum), for example, if similar channelization is used in the one or more unlicensed bands (e.g., by a regulation).

In an example, HARQ acknowledge and negative acknowledge (A/N) for the corresponding data may be transmitted in a shared COT (e.g., with a CAT2 LBT). In some examples, the HARQ A/N may be transmitted in a separate COT (e.g., the separate COT may require a CAT4 LBT). In an example, when UL HARQ feedback is transmitted on unlicensed band, a radio access technology (e.g., LTE and/or NR) may support flexible triggering and multiplexing of HARQ feedback for one or more DL HARQ processes. HARQ process information may be defined independent of timing (e.g., time and/or frequency resource) of transmission. In an example, UCI on PUSCH may carry HARQ process ID, NDI, RVID. In an example, Downlink Feedback Information (DFI) may be used for transmission of HARQ feedback for configured grant.

In an example, CBRA and CFRA may be supported on SpCell. CFRA may be supported on SCells. In an example, an RAR may be transmitted via SpCell, e.g., non-standalone scenario. In an example, an RAR may be transmitted via SpCell and/or SCell, e.g., standalone scenario. In an example, a predefined HARQ process ID for an RAR.

In an example, carrier aggregation between licensed band NR (PCell) and NR-U (SCell) may be supported. In an example, NR-U SCell may have both DL and UL, or DL-only. In an example, dual connectivity between licensed band LTE (PCell) and NR-U (PSCell) may be supported. In an example, Stand-alone NR-U where all carriers are in one or more unlicensed bands may be supported. In an example, an NR cell with DL in unlicensed band and UL in licensed band or vice versa may be supported. In an example, dual connectivity between licensed band NR (PCell) and NR-U (PSCell) may be supported.

In an example, a radio access technology (e.g., LTE and/or NR) operating bandwidth may be an integer multiple of 20 MHz, for example, if absence of Wi-Fi cannot be guaranteed (e.g. by regulation) in an unlicensed band (e.g., 5 GHz, 6 GHZ, and/or sub-7 GHz) where the radio access technology (e.g., LTE and/or NR) is operating. In an example, a wireless device may performance or more LBTs in units of 20 MHz. In an example, receiver assisted LBT (e.g., RTS/CTS type mechanism) and/or on-demand receiver assisted LBT (e.g., for example receiver assisted LBT enabled only when needed) may be employed. In an example, techniques to enhance spatial reuse may be used.

In an operation in an unlicensed band (e.g., LTE eLAA/feLAA and/or NR-U), a wireless device may measure (averaged) received signal strength indicator (RSSI) and/or may determine a channel occupancy (CO) of one or more channels. For example, the wireless device may report channel occupancy and/or RSSI measurements to the base station. It may be beneficial to report a metric to represent channel occupancy and/or medium contention. The channel occupancy may be defined as a portion (e.g., percentage) of time that RSSI was measured above a configured threshold. The RSSI and the CO measurement reports may assist the base station to detect the hidden node and/or to achieve a load balanced channel access to reduce the channel access collisions.

Channel congestion may cause an LBT failure. The probability of successful LBT may be increased for random access and/or for data transmission if, for example, the wireless device selects the cell/BWP/channel with the lowest channel congestion or load. For example, channel occupancy aware RACH procedure may be considered to reduce LBT failure. For example, the random access backoff time for the wireless device may be adjusted based on channel conditions (e.g., based on channel occupancy and/or RSSI measurements). For example, a base station may (semi-statically and/or dynamically) transmit a random access backoff. For example, the random access backoff may be predefined. For example, the random access backoff may be incremented after or in response to one or more random access response reception failures corresponding to one or more random access preamble attempts.

In unlicensed operation (e.g. NR-U), it may be beneficial for the UE to transmit a HARQ ACK/NACK for a corresponding data in a same shared COT. For example, the UE may receive a DL transmission (e.g. PDCCH and/or PDSCH) in a COT and may transmit a HARQ ACK/NACK of the DL transmission in the COT. For example, the base station may acquire/initiate the COT by performing one or more LBT procedures. The UE may transmit one or more HARQ ACK/NACK information for one or more corresponding DL transmissions (e.g. PDCCH and/or PDSCH) in the same shared COT, if possible, considering a UE processing time required between the received DL transmission and the HARQ ACK/NACK transmission. A gap (e.g. up to 16 □s) may be allowed between an end of a DL transmission and the immediate transmission of a HARQ feedback to accommodate for a hardware turnaround time. The base station may schedule UL/DL transmissions (e.g. CSI reporting or SRS, or other PUSCH, or CSI-RS, or other PDSCH) in the time between one DL transmission for a UE and the corresponding UL transmission of HARQ feedback for the same UE within a shared COT. The scheduled UL/DL transmissions in the time gap may be pre-configured and/or pre-determined transmissions, e.g. for reducing signaling overhead.

The UE may transmit one or more HARQ feedbacks of one or more DL transmissions in a separate COT (e.g. second COT) from the COT the corresponding DL transmission(s) was received (e.g. first COT). The base station may configure/signal a non-numerical value of the PDSCH-to-HARQ-feedback timing indicator (e.g. K1 value) in a DCI scheduling the PDSCH and/or a DCI releasing DL SPS. The non-numerical value indicates to the UE that the timing and resource for HARQ-ACK feedback transmission for the corresponding PDSCH/PDCCH will be determined later. A first DCI format (e.g. DCI format 1_0) may not support signaling a non-numerical value for the PDSCH-to-HARQ-feedback timing indicator.

In unlicensed operation, one or more HARQ ACK/NACK transmission opportunities for one or more given HARQ processes may be lost/missed, e.g. due to LBT failure. The base station may provide multiple and/or supplemental time and/or frequency domain transmission opportunities to enhance the HARQ feedback mechanism. The base station may trigger/request and/or enable multiplexing of one or more HARQ feedbacks for one or more DL HARQ processes. One or more HARQ feedbacks corresponding to one or more DL transmissions of a channel occupancy (COT) may be reported in the same channel occupancy. One or more HARQ feedbacks corresponding to DL transmissions of a channel occupancy may be reported outside of that channel occupancy.

The base station may request/trigger one or more HARQ feedbacks of one or more DL transmissions, wherein the one or more DL transmissions may be from one or more earlier COTs. For example, the one or more DL transmissions may be scheduled in COT x, and the one or more corresponding HARQ feedbacks may be scheduled/triggered in COT x+y, wherein y may be equal to or greater than 1, and x may be an index of a COT. For example, a DCI indicating the COT structure information may indicate the index of the COT.

The UE may be configured to report one or more HARQ feedbacks for one or more DL transmissions from one or more earlier COTs, e.g. with or without an explicit request/trigger from the base station.

The PDSCH-to-HARQ-feedback timing indicator (K1 value) in the DCI scheduling the PDSCH may indicate an UL resource (e.g. PUCCH and/or PUSCH) in a next COT. For example, the UE may receive a PDSCH/PDCCH in a first COT, and transmit the corresponding HARQ feedback in a second COT, e.g. based on the PDSCH-to-HARQ-feedback timing indicator (K1 value) in the DCI. For example, the second COT may be the next COT after the first COT (e.g. cross-COT HARQ-ACK feedback). A second DCI may provide the HARQ feedback timing and resource information to the UE. The second DCI may indicate an LBT category for transmission of the HARQ feedback in the second COT. The second DCI may be received before or after the first DCI.

The base station (BS) may configure via RRC signaling, a non-numerical value for HARQ feedback timing, e.g. dl-DataToUL-ACK, that may be signaled by a scheduling DCI, e.g. via parameter PDSCH-to-HARQ-feedback timing indicator. The non-numerical value may indicate that the UE may store/defer the HARQ A/N feedback result for the corresponding PDSCH/PDCCH, and may not provide any timing for the transmission of this HARQ A/N feedback result.

A HARQ feedback timing parameter in a DCI, e.g., PDSCH-to-HARQ-feedback timing indicator, may indicate multiple timing values for multiple candidate HARQ feedback transmission opportunities. The UE may select one of the multiple HARQ feedback transmission opportunities and transmit the HARQ feedback via that one.

The BS may configure a UE with enhanced dynamic codebook for HARQ feedback operation. The BS may trigger a group of DL transmissions, e.g. PDSCHs, for example, in an enhanced dynamic codebook operation. For example, one or more fields in a DCI may indicate one or more PDSCHs/PDCCHs to be acknowledged via an indicated UL resource. For example, the group of DL transmissions may comprise one or more HARQ processes, and/or may overlap with one or more slots/subframes, and/or may derived from a dynamic time window. The DCI may be carrying a DL scheduling assignment and/or an Ul grant and/or a DCI not carrying a scheduling grant. The DCI may comprise one or more HARQ feedback timing values indicating the UL resource.

A DCI scheduling a DL assignment, e.g. PDSCH, may associate the PDSCH to a group. For example, the DCI may comprise a field indicating a group index. For example, a PDSCH scheduled by a first DCI format (e.g. DCI format 1_0) may be associated with a pre-defined group (e.g. PDSCH group #0). For example, an SPS PDSCH occasion may be associated with a pre-defined group. For example, and SPS PDSCH occasion may be associated with a first group, wherein the activation DCI indicates an index of the first group. For example, an SPS release PDCCH may be associated with a pre-defined group. For example, the SPS release PDCCH may indicate an index of a group.

The base station may schedule a first PDSCH with a PDSCH-to-HARQ-feedback timing, e.g. K1 value, in a COT with a first group index. The PDSCH-to-HARQ-feedback timing may have a non-numerical value. The BS may schedule one or more PDSCHs after the first PDSCH in the same COT, and may assign the first group index to the one or more PDSCHs. At least one of the one or more PDSCHs may be scheduled with a numerical K1 value.

The DCI may indicate a new ACK-feedback group indicator (NFI) for each PDSCH group. The NFI may operate as a toggle bit. For example, the UE may receive a DCI that indicates the NFI is toggled for a PDSCH group. The UE may discard one or more HARQ feedbacks for one or more PDSCHs in the PDSCH group. The one or more PDSCHs may be associated/scheduled with one or more non-numerical K1 values and/or numerical K1 values. The UE may expect DAI values of the PDSCH group to be reset.

The UE may be configured with enhanced dynamic codebook. The UE receive a first DCI format (e.g. DCI format 1_0) scheduling one or more PDSCHs. The one or more PDSCHs may be associated with a PDSCH group (e.g. a pre-defined PDSCH group, e.g. group #0). The first DCI format may not indicate an NFI value for the PDSCH group. The UE may determine the NFI value based on a second DCI format (e.g. DCI format 1_1) indicating the NFI value for the PDSCH group. The UE may detect the second DCI format since a last scheduled PUCCH and before a PUCCH occasion, wherein the second PUCCH occasion may comprise HARQ feedback corresponding to a PDSCH scheduled with the first DCI format. The last scheduled PUCCH may comprise HARQ feedback for the PDSCH group. The UE may not detect the second DCI that indicates the NFI value for the PDSCH group, and the UE may assume that the one or more PDSCHs scheduled by the first DCI format do not belong to any PDSCH group, and the UE may report the HARQ feedback of at least one PDSCH scheduled by the first DCI format since a latest PUCCH occasion.

A DCI may request/trigger HARQ feedback for one or more groups of PDSCHs, e.g. via a same PUCCH/PUSCH resource. HARQ feedbacks for multiple DL transmissions, e.g. PDSCHs, in a same group, may be transmitted/multiplexed in a same PUCCH/PUSCH resource. Counter DAI and total DAI values may be incremented/accumulated within a PDSCH group.

A UE may postpone transmission of HARQ-ACK information corresponding to PDSCH(s) in a PUCCH for K1 values that result in a time T, being the time between a last symbol of the PDSCH(s) and a starting symbol of the PUCCH, that is less than a required processing time for PUCCH transmission.

The UE may receive a downlink signal (e.g. RRC and/or DCI) scheduling a PDSCH. The UE may be configured with enhanced dynamic codebook HARQ feedback operation. The PDSCH may be scheduled with a non-numerical value for PDSCH-to-HARQ-feedback timing, e.g. K1. The UE may derive/determine a HARQ-ACK timing information for the PDSCH by a next/later DCI. The next DCI may be a DL DCI scheduling one or more PDSCHs. The next DCI may comprise a numerical K1 value, indicating one or more PUCCH/PUSCH resources for HARQ feedback transmission of one or more DL transmissions, comprising the PDSCH. The next DCI may trigger HARQ feedback transmission for one or more PDSCH groups comprising a group of the PDSCH. The UE may derive/determine the HARQ-ACK timing information for the PDSCH by a last/earlier DCI.

The UE may receive a first DCI scheduling a PDSCH with non-numerical K1 value. For (non-enhanced) dynamic HARQ-ACK codebook, the UE may determine/derive a HARQ-ACK timing for the PDSCH scheduled with non-numerical K1 value, by a second DCI. The second DCI may schedule a second PDSCH with a numerical K1 value. The UE may receive the second DCI after the first DCI.

The base station may transmit a DCI requesting/triggering HARQ feedback of a HARQ-ACK codebook containing one or more or all, DL HARQ processes (e.g. one-shot feedback request). The one-shot feedback request may be for one or more or all component carriers configured for the UE. One-shot feedback may be configured separately from a HARQ-ACK codebook configuration. For example, one-shot feedback may be applied to semi-static HARQ-ACK codebook and/or (non-enhanced) dynamic HARQ-ACK codebook and/or enhanced dynamic HARQ-ACK codebook.

The UE may transmit HARQ feedback of one or more PDSCHs in response to receiving a one-shot feedback request. A last/latest PDSCH for which an acknowledgment is reported in response to receiving the one-shot feedback request, may be determined as a last PDSCH within a UE processing time capability (e.g. baseline capability, N1). The UE may report HARQ-ACK feedback for one or more earlier PDSCHs scheduled with non-numerical K1 value. The one-shot feedback may be requested in a UE-specific DCI. The one-shot feedback may request HARQ feedbacks to be reported in a PUCCH. The HARQ feedback may be piggybacked (e.g. appended) on a PUSCH.

The UE may be configured to monitor feedback request for one-shot HARQ-ACK codebook feedback. The feedback may be requested in a DCI format (e.g. DCI format 1_1). The DCI format may or may not schedule DL transmission (e.g. PDSCH). The DCI format may comprise a first field (e.g. a frequency domain resource allocation field) indicating a first value. The UE may determine that the DCI format does not schedule a PDSCH in response to the first field indicating the first value. The UE may ignore/discard one or more second fields of the DCI format (e.g., a HARQ process number and/or NDI field) in response to the determining. The UE may be scheduled to report one-shot feedback and one or more other HARQ-ACK feedbacks in a same slot/subframe/resource, and the UE may report only the one-shot feedback.

In a one-shot codebook, one or more NDI bits may follow one or more HARQ-ACK information bits for each of one or more TBs. The HARQ-ACK information bits and the corresponding NDI may be ordered in the one-shot codebook as follows: first in an increasing order of CBG index, second in an increasing order of TB index, third in an increasing order of HARQ process ID, and fourth in an increasing order of serving cell index.

The UE may be configured with one or more active SPS PDSCH configurations in DL.

In some embodiments, a wireless device and a base station must have a common understanding of a HARQ-ACK codebook size, which for a semi-static codebook, depends on the number of occasions for candidate PDSCH receptions on a set of downlink slots associated with the PUCCH transmission on the active UL BWP. When there is a BWP switching, a numerology (slot duration) of the BWP may change, and/or one or more PDSCH-to-HARQ feedback timing values (K1) configured for the BWP may change, and/or a PDSCH time domain allocation associated with the PDSCH configuration of the BWP may change. This may complicate the determination of the HARQ-ACK codebook size, e.g., when there is a PDSCH reception with pending HARQ-ACK information. Thus, in existing technologies, pending HARQ-ACK information is discarded, and is not considered in HARQ-ACK codebook determination. The wireless device may drop/skip/not report/report NACK for a HARQ-ACK information of one or more PDSCH occasions and/or SPS PDSCH releases in a semi-static codebook, for example, when the wireless device switches a BWP (e.g. DL BWP and/or UL BWP) after the one or more PDSCH occasions and/or SPS PDSCH releases, and before/at a same time as a corresponding PUCCH/PUSCH slot.

In some embodiments, the wireless device may transmit the HARQ-ACK for a PDSCH, that is scheduled with non-numerical K1 value, via one-shot HARQ feedback. The wireless device may not include the HARQ-ACK for a PDSCH, that is scheduled with non-numerical K1 value, in a semi-static codebook. The wireless device may include the HARQ-ACK for a PDSCH, that is scheduled with non-numerical K1 value, in a semi-static codebook. With semi-static codebook, HARQ-ACK timing for a PDSCH scheduled with a non-numerical K1 may be derived based on the next DL DCI scheduling PDSCH with a numerical K1 value. A wireless device may report HARQ-ACK in the appended bit container. With dynamic codebook, HARQ-ACK timing for a PDSCH scheduled with DCI indicting a non-numerical K1 may be derived based on the next DCI scheduling PDSCH with a numerical K1 value. The wireless device may expect that DAI is reset for PDSCH transmitted later than N1 symbols before PUCCH transmission.

Non-numerical value of K1 may be configured for dynamic/semi-static codebook, enhanced dynamic codebook and/or one-shot codebook. For dynamic codebook, HARQ-ACK timing for a PDSCH scheduled with non-numerical value for K1 may be derived by the next DCI scheduling PDSCH with a numerical K1 value. To complete the codebook design, the associated DAI value may be accumulated accordingly. For semi-static codebook, the HARQ-ACK timing for a PDSCH scheduled with non-numerical value for K1 may be derived by the next DCI scheduling PDSCH with a numerical K1 value. Valid HARQ-ACK for a PDSCH with a non-numerical value for K1 may be reported in a PUCCH/PUSCH according to PDSCH time domain resource, e.g. if it is in the candidate PDSCH occasions of the PUCCH/PUSCH. Additional HARQ-ACK bit for the PDSCH may be appended to the semi-static codebook for candidate PDSCH occasions, e.g. if this PDSCH is earlier than the first candidate PDSCH occasion. Considering there is no assist information in semi-static codebook to identify the mis-detected PDSCH outside candidate PDSCH occasions, the reserved bit for PDSCH with non-numerical K1 may always be present. A set of K1 may be configured per UL BWP rather than per DL CC. The reserved HARQ-ACK bit for PDSCH with non-numerical value for K1 may be added for each configured DL CC. Furthermore, to avoid any confusion of ‘latest PDSCH with non-numerical K1’, the base station may ensure at most one appended PDSCH outside candidate PDSCH occasions per DL CC.

A serving cell may be configured with one or more BWPs. The BWP switching for a serving cell may be used to activate an inactive BWP and/or deactivate an active BWP at a time. The BWP switching may be controlled by a PDCCH indicating a downlink assignment and/or an uplink grant. The BWP switching may be controlled by a BWP inactivity timer (e.g. bwp-InactivityTimer). The BWP switching may be controlled by RRC signaling. The BWP switching may be controlled by the MAC entity itself upon initiation of Random Access procedure. Upon RRC (re-)configuration of first active DL BWP (e.g. firstActiveDownlinkBWP-Id) and/or first active UL BWP (e.g. firstActiveUplinkBWP-Id) for SpCell or activation of an SCell, the DL BWP and/or UL BWP indicated by firstActiveDownlinkBWP-Id and/or firstActiveUplinkBWP-Id respectively may be active without receiving PDCCH indicating a downlink assignment or an uplink grant. The active BWP for a Serving Cell may be indicated by either RRC or PDCCH. For unpaired spectrum, a DL BWP may be paired with a UL BWP, and BWP switching of a DL BWP may change the paired UL BWP, and/or BWP switching of an UL BWP may change the paired DL BWP.

The serving cell may be configured with a BWP inactivity timer (e.g. a duration of 2 ms, 3 ms, . . . , or 1920 ms). The running BWP inactivity timer may expire. The wireless device may perform BWP switching to a BWP indicated as a default DL BWP (if configured) when the BWP inactivity timer expires. The wireless device may perform BWP switching to a BWP indicated as initial DL BWP (e.g. if the default DL BWP is not configured) when the BWP inactivity timer expires. The wireless device may perform BWP switching to a BWP indicated by a DCI via a PDCCH (e.g. switches the active DL BWP) in response to receiving a DCI via the PDCCH, wherein the DCI comprises a BWP index. The wireless device may start/restart the BWP inactivity timer of the serving cell, e.g. when the wireless device switches the active DL BWP, which is not indicated as the default DL BWP or initial DL BWP. The wireless device may start/restart the BWP inactivity timer of the serving cell in response to receiving a scheduling DCI for the serving cell, wherein the scheduling DCI comprises resource assignments for downlink or uplink data. The wireless device may start/restart the BWP inactivity timer of the serving cell in response to receiving a scheduling DCI via the serving cell, wherein the scheduling DCI comprises resource assignments for downlink/uplink data for the serving cell or another serving cell.

A wireless device may be configured with a semi-static codebook (e.g. Type-1 HARQ-ACK codebook). The wireless device may determine a set of occasions for candidate PDSCH receptions and/or SPS PDSCH release(s) for a serving cell c, an active downlink BWP, and an active uplink BWP. The wireless device may transmit the HARQ-ACK information of the candidate PDSCH receptions and/or SPS PDSCH release, using the codebook in an uplink channel. The uplink channel may be PUCCH or PUSCH. A location in the Type-1 HARQ-ACK codebook for HARQ-ACK information corresponding to a single SPS PDSCH release may be same as for a corresponding SPS PDSCH reception. A location in the Type-1 HARQ-ACK codebook for HARQ-ACK information corresponding to multiple SPS PDSCH releases by a single DCI format may be same as for a corresponding SPS PDSCH reception with the lowest SPS configuration index among the multiple SPS PDSCH releases.

The wireless device may transmit the HARQ-ACK information in slot n_{U}. The wireless device may skip a PDSCH occasion and/or a SPS release in the semi-static HARQ-ACK codebook. For example, the wireless device may skip a PDSCH occasion and/or a SPS release when the scheduled slot n_{U} for the HARQ-ACK transmission starts at a same time as or after a slot for an active DL BWP change, e.g. on the serving cell c. For example, the wireless device may skip a PDSCH occasion and/or a SPS release when the scheduled slot n_{U} for the HARQ-ACK transmission starts at a same time as or after a slot for an active UL BWP change, e.g. on the PCell. For example, the wireless device may skip a PDSCH occasion and/or a SPS release when a DL slot corresponding to the UL slot n_{U} is before the slot for the active DL BWP change on the serving cell c. For example, the wireless device may skip a PDSCH occasion and/or a SPS release when a DL slot corresponding to the UL slot n_{U} is before the slot for the active UL BWP change on the PCell.

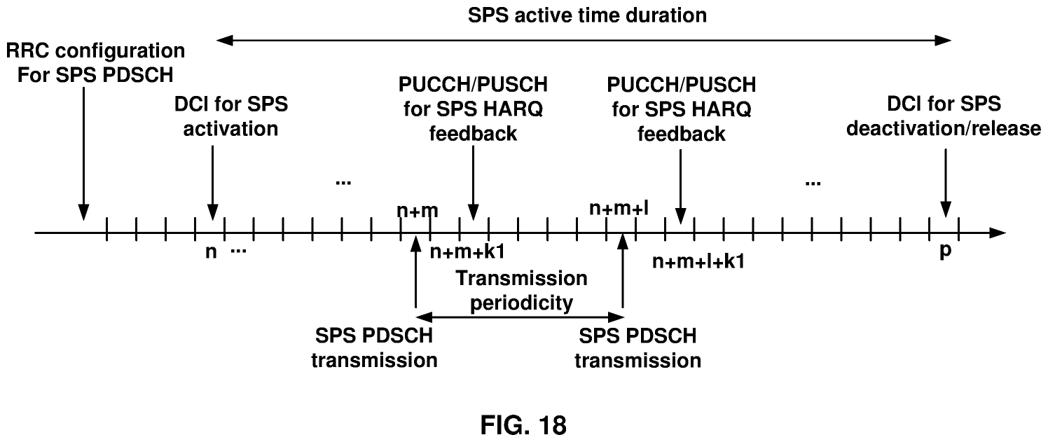

FIG. 18 shows an example of signaling for configuration, activation, transmission, and deactivation of SPS PDSCH, according to some embodiments. The UE may receive RRC signaling comprising configuration parameters of an SPS PDSCH configuration, e.g. a periodicity l. The UE may receive a DCI indicating activation the SPS PDSCH configuration in slot n. The activation DCI may indicate parameters for scheduling SPS PDSCH occasions, e.g. time offset m, and/or corresponding PUCCH occasions for HARQ feedback transmissions of the SPS PDSCH occasions, e.g. timing offset k1. The UE may determine a first SPS PDSCH occasion in slot n+m and may or may not receive the first PDSCH. The UE may determine a first PUCCH/PUSCH resource in slot n+m+k1 to transmit a first HARQ feedback corresponding to the first SPS PDSCH occasion. The UE may determine a second SPS PDSCH occasion based on the periodicity in slot n+m+l and may or may not receive the second PDSCH. The UE may determine a second PUCCH/PUSCH resource in slot n+m+l+k1 to transmit a second HARQ feedback corresponding to the second SPS PDSCH occasion, and so on. The UE may receive a second DCI in slot p, indicating a deactivation/release of the SPS PDSCH configuration. The UE may stop receiving DL data via PDSCH based on the SPS PDSCH configuration and the scheduling of the activation DCI. The SPS PDSCH configuration active time duration may be from slot n to slot p.

The UE may receive a first DCI format (e.g., fallback DCI, DCI format 10) activating an SPS PDSCH configuration. The UE may report a HARQ-ACK feedback of a PDSCH occasion of the SPS PDSCH configuration as part of a first PDSCH group, e.g., when configured with enhanced dynamic codebook. The first PDSCH group may be pre-defined (e.g. group #0) and/or configured via RRC signaling.

The UE may receive a first DCI format (e.g. non-fallback DCI, DCI format 1_1) activating an SPS PDSCH configuration. The UE may report a HARQ-ACK feedback of a PDSCH occasion of the SPS PDSCH configuration as part of a PDSCH group indicated by the activation DCI (the first DCI format), e.g., when configured with enhanced dynamic codebook.

A HARQ feedback corresponding to a SPS PDSCH may be requested/triggered one or more times, e.g. via enhanced dynamic codebook and/or one-shot feedback codebook. In an enhanced dynamic codebook, the SPS PDSCH may belong to a default PDSCH group (e.g. group #0). The UE may determine an NFI corresponding to the SPS PDSCH from the NFI indicated in a second DCI, e.g. a latest DCI. For example, the second DCI may be a first DCI format (e.g. non-fallback DCI, DCI format 1_1), scheduling one or more PDSCH of the same PDSCH group and/or triggering HARQ-ACK feedback of the same PDSCH group. The UE may report one or more HARQ-ACK feedbacks corresponding to one or more SPS PDSCH occasions since a latest toggling of the NFI corresponding to the PDSCH group, e.g. when HARQ-ACK feedback for the PDSCH group is requested/triggered. The UE may append (e.g. piggyback) the one or more HARQ-ACK bits corresponding to the one or more SPS PDSCH occasions to a HARQ-ACK codebook comprising other DL transmissions (e.g. PDSCHs dynamically scheduled via PDCCH) of the same PDSCH group.

In an enhanced dynamic codebook, SPS PDSCH may not belong to any PDSCH group, e.g., no PDSCH group index/ID associated with SPS PDSCH may be defined. The UE may use a first PUCCH format (e.g. PUCCH format 0/1) for the HARQ feedback transmission, e.g. when only one or more HARQ-ACK bits corresponding to SPS PDSCH are scheduled in the slot of the PUCCH. The one or more HARQ-ACK bits of SPS PDSCH may be retransmitted using one-shot feedback.

Other group-based HARQ-ACK bits may collide with the HARQ-ACK bit corresponding to SPS PDSCH. The UE may multiplex all HARQ-ACK bits in one PUCCH, and map the HARQ-ACK bit corresponding to SPS PDSCH to the end of HARQ-ACK codebook. The UE may retransmit the HARQ-ACK bit corresponding to SPS PDSCH, e.g., when the multiplexed group-based HARQ-ACK is triggered for retransmission.

The UE may not expect to receive a DL DCI activating SPS PDSCH indicating a non-numerical K1 value.

A first PDSCH group index indicated in a first DCI activating a SPS PDSCH configuration may be the same a second PDSCH group index indicated in a second DCI deactivating/releasing the SPS PDSCH configuration.

The UE may append (e.g. piggyback) one or more HARQ feedback bits for one or more SPS PDSCH and/or one or more SPS release at the end of a HARQ codebook. The one or more HARQ feedback bits may not belong to any PDSCH groups defined by enhanced dynamic codebook. The one or more HARQ feedback bits may not be retransmitted. The UE may retransmit the one or more HARQ feedback bits if the UE receives a one-shot feedback request/trigger.

The UE may be configured with semi-static HARQ-ACK codebook. The UE may append an additional bit per TB/CBG at the end of HARQ-ACK bits for a corresponding DL component carrier in a semi-static HARQ-ACK codebook, e.g. when the UE is configured with a non-numerical K1 value (e.g. included in the configuration of the higher layer parameter dl-DataToUL-ACK) for at least one PUCCH configuration for a configured DL component carrier. The UE may report a HARQ-ACK value corresponding to a PDSCH scheduled with non-numerical K1 using one or more bits of the semi-static HARQ-ACK codebook, e.g. when the semi-static HARQ-ACK codebook includes an occasion for candidate PDSCH reception corresponding to the PDSCH scheduled with non-numerical K1. The UE may report a HARQ-ACK feedback of a latest PDSCH of one or more PDSCHs scheduled with non-numerical K1 value using an appended bit at the end of the semi-static HARQ-ACK codebook, e.g., when the semi-static HARQ-ACK codebook does not include an occasion for the one or more PDSCHs. The UE may not expect to receive more than one PDSCH scheduled with non-numerical K1 value for which semi-static HARQ-ACK codebook may not include a bit/location corresponding to that PDSCH. The UE may report NACK for one or more appended bits (e.g. per TB/CBG) at the end of the semi-static HARQ-ACK codebook, e.g. if there is no PDSCH scheduled with non-numerical K1 value to be reported in the semi-static HARQ-ACK codebook. The UE may not include any appended bits at the end of the semi-static HARQ-ACK codebook, e.g. when a non-numerical K1 value is not configured (e.g. not included in the configuration of the higher layer parameter dl-DataToUL-ACK) for any PUCCH configuration for a component carrier, and the UE is configured with semi-static HARQ-ACK codebook.

The UE may exclude one or more slots outside a gNB-initiated COT from a DL association set determining a size of semi-static HARQ-ACK codebook.

In existing technologies, for a SPS configuration, a base station may indicate, via an activation DCI for the SPS configuration or via a RRC signaling, one numerical value or a reserved non-numerical value for a PDSCH-to-HARQ-feedback timing for HARQ feedback transmission in unlicensed bands. The non-numerical value indicates to the UE that the timing and resource for HARQ-ACK feedback transmission for the corresponding PDSCH/PDCCH will be determined later. When the PDSCH-to-HARQ-feedback timing is a numerical value, it directly indicates an UL channel for HARQ-ACK feedback transmission, and a wireless device may attempt to transmit a HARQ-ACK feedback for each SPS occasion based on the numerical value. This may be inefficient in unlicensed bands and/or TDD systems, where the semi-static uplink transmissions for the SPS HARQ-ACK feedback may collide/overlap with unavailable time resources, e.g., DL slots/symbols based on TDD UL-DL configuration and/or time slots requiring LBT procedures where the LBTs may fail. The wireless device may drop an uplink transmission (e.g., PUCCH comprising SPS HARQ-ACK) if it collides with symbols that cannot be used for uplink transmissions. The wireless device may or may not succeed in LBTs, which may degrade reliability of HARQ-ACK feedbacks. For example, when a wireless device is not able to transmit a HARQ-ACK feedback due to collision with DL/flexible symbol(s) and/or LBT failure, the base station may not know whether the DL transmission has been successfully received or not and whether there is a need for retransmission or not, so unnecessary retransmissions may follow.

For example, the base station may not have transmitted any PDSCH in one or more SPS occasions due to failure of LBT. In such a case, transmission of HARQ-ACK feedback may not be beneficial. If a DL SPS is configured with a numerical timing value for HARQ feedback transmission, the corresponding UL channel (e.g. PUCCH) for many of the instances may happen to be outside a channel occupancy. It may require additional UL transmissions and/or LBT procedures with reduced probability of success because the base station has not been able to reserve the UL channel for the HARQ feedback transmission. This approach may not be efficient and may result in additional UL transmissions with reduced reliability and reduced likelihood of accessing the UL channel.

Based on existing technologies, the wireless device may drop/not transmit a PUCCH comprising DL SPS HARQ-ACK if the PUCCH transmission collides with one or more symbols that may not be used for uplink transmission. The one or more symbols may be DL symbols. The one or more symbols may be flexible symbols. For example, semi-static TDD configuration (e.g., TDD-UL-DL-ConfigurationCommon, or TDD-UL-DL-ConfigDedicated) may indicate that the one or more symbols are DL symbol(s) and/or flexible symbol(s). For example, a DCI comprising slot format indication (SFI) may indicate that the one or more symbols are DL symbol(s) and/or flexible symbol(s). For a dynamically scheduled PDSCH and corresponding PUCCH resource for HARQ-ACK, the network may dynamically determine the time slot and symbols of the PUCCH such that a collision with DL/flexible symbols is avoided, however, for SPS PDSCH with periodic and semi-statically configured PUCCH resources, the collision may be inevitable. In unpaired spectrum, DL heavy configurations and/or multiple SPS configurations may result in frequent dropping of the SPS HARQ-ACK, which may waste the resources, delay the data communication, and degrade the system performance. A system performance may be enhanced by avoiding SPS HARQ-ACK dropping for TDD due to collision of PUCCH with DL/flexible symbols.

In an example, PUCCH resources may be scheduled by a numerical PDSCH-to-HARQ-feedback timing value for a DL SPS configuration. The pre-configured/semi-statically configured/fixed feedback timing values may result in multiple separate PUCCH resources for transmission of multiple HARQ-ACK information, which might as well be combined in a single PUCCH transmission. For example, a semi-statically configured PUCCH resource of a SPS PDSCH occasion may not be an efficient uplink resource for the base station to schedule other HARQ-ACK information transmission on the same PUCCH resource. For example, the PUCCH resource may not be within a COT duration. For example, the PUCCH resource may be only scheduled for the HARQ-ACK information of the SPS PDSCH occasion, not other HARQ-ACK information or any other uplink control information comprising CSI-report and/or SR. The base station may prefer to schedule a second PUCCH resource different than the PUCCH resource of a SPS PDSCH for dynamic scheduling of PDSCH HARQ-ACK transmission. This may result in multiple/separate HARQ-ACK transmissions which increases an UL overhead.

In the existing art, when the UE receives a SPS PDSCH after a first PDSCH, wherein the first PDSCH is scheduled/assigned with an inapplicable feedback timing value in the corresponding first DCI format, the UE may not transmit/multiplex the HARQ-ACK information for the first PDSCH in a PUCCH transmission scheduled for HARQ-ACK transmission of the SPS PDSCH. This implies that even though the semi-statically PUCCH resource of the SPS PDSCH is already existing, it may not be an efficient resource for transmission of other HARQ-ACK information. Thus, if the HARQ-ACK information of the SPS PDSCH is of considerable importance (e.g., some critical data is transmitted and/or is not NACK), the semi-statically configured PUCCH resource might not be efficient/reliable for transmission of the HARQ-ACK information of the SPS PDSCH as well.

On the other hand, if the DL SPS is configured with a non-numerical timing value for the HARQ feedback transmission, it may result in increased downlink (DCI) signaling and/or increased latency in the HARQ feedback transmission. For example, sometimes an UL channel (e.g. PUCCH) may be available for a corresponding PDSCH (e.g., the corresponding PDSCH is transmitted in a COT and resource of the UL channel is within the COT, or the resource of the UL channel do not overlap with a DL/flexible symbol). With a fixed non-numerical value for the HARQ-ACK feedback, even if the wireless device has available uplink resource for the HARQ-ACK feedback, the wireless device may postpone the HARQ-ACK feedback transmission until it receives a DCI indicating a numerical timing value that schedules another UL channel. This approach may not efficient or flexible.

There is a need to avoid dropping (e.g., by dynamically and flexibly controlling the timing of) the HARQ feedback transmission for DL SPS, for example, due to the unavailability of UL resources and/or traffic dynamics and special characteristics of communications (e.g., COT, channel access in unlicensed bands, and/or DL/flexible symbols in TDD operations). Embodiments may enable the wireless device to postpone/defer a HARQ feedback transmission of a SPS PDSCH occasion/reception, in response to the corresponding PUCCH resource being unavailable (e.g., due to LBT failure and/or COT expiration and/or TDD DL/flexible collision).

Existing technologies change PDSCH-to-HARQ-feedback timing between a numerical value and a non-numerical value by updating one or more parameters of SPS via transmission of SPS activation DCI(s). This approach may not be possible, for example, when a base station fails to acquire the channel. In such an instance, the base station may not be able to transmit any DCI to a wireless device to adapt the PDSCH-to-HARQ-feedback timing. Moreover, this approach would require higher DCI overheads to maintain a SPS configuration and may not be scalable with a number of SPS configurations.

Embodiments of the present disclosure enable flexible control over the timing of HARQ feedback transmission for DL SPS in unlicensed band without relying on SPS activation DCIs by determining a HARQ feedback timing value based on some criteria. For example, by enabling the wireless device to select between a first numerical timing value and a second non-numerical timing value or a third numerical timing value based on, for example, a second or third downlink control information and/or a channel occupancy timing. Embodiments of the present disclosure may reduce a latency in HARQ feedback transmission and at the same time, a likelihood of HARQ feedback transmission may be increased and the wireless device overhead for transmitting the HARQ feedback of the DL SPS may be reduced as well.

In an example, a wireless device may utilize a first PDSCH-to-HARQ-feedback timing of a previous or a next DCI scheduling a PDSCH to adjust/temporarily adapt a second PDSCH-to-HARQ-feedback timing of a SPS PDSCH/a SPS occasion. For example, the previous DCI scheduling a PDSCH close to the SPS PDSCH/the SPS occasion indicates that the first PDSCH-to-HARQ-feedback timing is non-numerical value, the wireless device may apply the non-numerical value for the SPS PDSCH/the SPS occasion to determine the second PDSCH-to-HARQ-feedback timing. For example, the previous DCI scheduling a PDSCH close to the SPS PDSCH/the SPS occasion indicates, by a first PDSCH-to-HARQ-feedback timing that is numerical value, a first UL channel (e.g. PUCCH) that is different than a second UL channel, indicated by the second PDSCH-to-HARQ-feedback timing of the SPS PDSCH/SPS occasion, the wireless device may override/discard the second UL channel and/or the second PDSCH-to-HARQ-feedback timing for the SPS PDSCH/the SPS occasion, and may use the first UL channel to transmit the HARQ-ACK feedback of the SPS PDSCH. In an example, a wireless device may receive a numerical value for a PDSCH-to-HARQ-feedback timing for a SPS configuration. For a SPS PDSCH/a SPS occasion of the SPS configuration, the wireless device may apply the numerical value for the PDSCH-to-HARQ-feedback timing when resource of a PUCCH carrying HARQ-ACK feedback for the SPS PDSCH/the SPS occasion belongs to a COT (e.g., the wireless device may not need to perform Cat 4 LBT). For example, the COT may comprise the SPS PDSCH transmission. Otherwise, the wireless device may apply the non-numerical value for the PDSCH-to-HARQ-feedback timing.

In an example, a wireless device may receive a numerical value for a PDSCH-to-HARQ-feedback timing for a SPS configuration. The wireless device may determine that a resource of an uplink carrying a HARQ-ACK feedback corresponding to a SPS PDSCH or a SPS occasion based on the PDSCH-to-HARQ-feedback timing value, belongs to a same channel occupancy (COT) as a COT of the SPS PDSCH or the SPS occasion. In response to the determining, the wireless device may transmit the uplink carrying the HARQ-ACK feedback corresponding to the SPS PDSCH. Otherwise, the wireless device may not transmit the HARQ-ACK feedback. For example, the wireless device may not transmit the HARQ-ACK feedback when the SPS PDSCH or the SPS occasion is not belonging to any COT. For example, the wireless device may not transmit the HARQ-ACK feedback when the resource of the uplink determined based on the PDSCH-to-HARQ-feedback timing belongs to a different COT from the COT of the SPS PDSCH or the SPS occasion or may not be belonging to any COT.

A wireless device may not transmit a HARQ feedback of a DL transmission via an UL channel that is not within a same channel occupancy as the DL transmission. A wireless device may not transmit a HARQ feedback of a DL transmission via an UL channel that is only scheduled for the DL transmission.

Per an example embodiment of the present disclosure, a UE may receive one or more RRC messages comprising parameters of one or more semi-persistent scheduling (e.g. SPS PDSCH) configurations and/or one or more uplink control channel (e.g. PUCCH) configurations. The UE may determine a PUCCH resource of the one or more PUCCH configurations for transmitting HARQ feedback information of a SPS PDSCH occasion. For example, the UE may receive a DCI activating a SPS PDSCH configuration. For example, the one or more RRC messages may indicate a periodicity of the SPS PDSCH occasions (e.g. 10 ms or 20 ms or 32 ms or . . . 640 ms) and/or a number of HARQ processes for the data transmission (e.g. transport blocks). For example, the parameters of the one or more SPS configurations may indicate the periodicity of the SPS PDSCH occasions. The activation DCI may comprise scheduling information of the SPS PDSCH configuration(s). For example, the activation DCI may comprise one or more first fields that indicate time/frequency resources (e.g. offsets and/or number of symbols/resource blocks) of the SPS PDSCH occasions, wherein the SPS PDSCH occasions repeat at each period based on the indicated time/frequency resources. The activation DCI may further comprise one or more second fields indicating UL resources for HARQ feedback transmission of the SPS PDSCH occasions. For example, the one or more second fields may comprise a PDSCH-to-HARQ-feedback timing (e.g., K1) value. The K1 value may indicate a time offset from each of the SPS PDSCH occasions at each period to a corresponding PUCCH resource for HARQ feedback transmission of the that SPS PDSCH occasion. For example, the time offset may be a number of slots/symbols/subframes. For example, the UE may apply the time offset indicated by the K1 value to a last time instance (e.g. slot) of the SPS PDSCH occasion (e.g. slot n), to determine a time instance of the PUCCH (e.g. slot n+K1). The UE may use one or more pre-configured information (e.g. PUCCH formats and/or dl-DataToUL-ACK, etc.) and/or one or more information fields in the activation DCI (e.g. PUCCH resource indicator (PRI)) to determine the PUCCH resource in the PUCCH slot. The SPS PDSCH occasion may correspond to any instance of the periodic SPS, e.g. at any period after activation and before deactivation.

The UE may receive a DCI (e.g. DCI format 2_0) comprising one or more fields indicating a COT structure information, e.g. a length of the COT and/or a remaining channel occupancy duration for a serving cell. For example, the UE may be configured/provided with one or more RRC parameters (e.g. CO-DurationPerCell-r16 and/or CO-DurationList-r16). The DCI may indicate a number of remaining symbols and/or slots from a reception of the DCI (e.g. from beginning of a slot that the DCI is received/detected) to an end of the COT. In an example, the UE may not be configured/provided with the one or more RRC parameters (e.g. CO-DurationPerCell-r16 and/or CO-DurationList-r16). The UE may determine an end and/or remaining duration of the COT for the serving cell based on one or more slot format indications in one or more DCIs (e.g. DCI format 2_0). For example, the one or more DCIs may comprise one or more fields indicating the one or more slot format indications. For example, the one or more slot format indications (SFIs) may indicate slot formats (e.g. UL or DL or flexible direction) of a number of symbols. For example, a remaining channel occupancy duration may be a number of slots and/or symbols, starting from a slot where the UE detects the DCI, that the one or more SFIs indicate/provide corresponding slot formats.

The UE may determine that a first SPS PDSCH occasion/instance (e.g. at a first period) of a first SPS PDSCH configuration, once configured and activated, overlaps with one or more symbols of one or more slots of a first COT duration. For example, the BS may initiate the first COT by performing one or more LBT procedures indicating an idle/available channel. The UE may receive the COT information, such as remaining COT duration, via a detected DCI. The UE may determine one or more symbols of one or more slots associated with the remaining COT duration. For example, the remaining COT duration may comprise the one or more symbols of the one or more slots according to a numerology of the active DL BWP of the serving cell. The first SPS PDSCH occasion may comprise one or more first symbols. The one or more first symbols may be indicated by one or more scheduling parameters in the SPS activation DCI, e.g. time domain resource allocation (TDRA) field. The UE may determine that the first SPS PDSCH occasion is scheduled in the first COT, e.g., by determining that the one or more symbols of the first COT comprise/overlap with at least one of the one or more symbols of the first SPS PDSCH occasion.

The UE may determine a first PUCCH resource associated with the first SPS PDSCH occasion. For example, the activation DCI may comprise a first HARQ feedback timing value, e.g. K1 value. The K1 value may indicate a time offset from the first SPS PDSCH occasion to the first PUCCH resource/slot. For example, the time offset may comprise a number of slots and/or symbols and/or frames and/or subframe. For example, the time offset may be in milli-seconds. The first PUCCH resource may comprise one or more second symbols. The UE may determine the one or more second symbols of the first PUCCH resource based on one or more RRC configuration parameters (e.g. PUCCH-Config, PUCCH-Resource, PUCCH-format0/1/2/3/4, dl-DataToUL-ACK, etc.) and/or one or more information fields of the activation DCI (e.g. PRI and/or PDSCH-to-HARQ-feedback timing indicator (K1 value)).

The UE may determine that the one or more second symbols of the first PUCCH resource associated with the first SPS PDSCH occasion overlap (e.g. partially or fully) with one or more symbols of one or more slots of the first COT duration. The first SPS PDSCH occasion may be scheduled in the first COT, e.g. may overlap with the first COT duration. The first PUCCH resource may be scheduled in the first COT, e.g. overlap with the first COT duration. The UE may transmit HARQ feedback information of the first SPS PDSCH occasion via the first PUCCH resource, e.g. in the same COT duration as the corresponding PDSCH. The UE may report ACK (e.g. a positive bit) for the HARQ feedback information for successfully received/decoded data of a CBG/TB received via the first SPS PDSCH occasion. The UE may report NACK (e.g. a negative bit) for the HARQ feedback information for unsuccessfully received/decoded data of a CBG/TB of the first SPS PDSCH occasion, e.g., the UE may not detect the PDSCH in the first SPS PDSCH occasion.

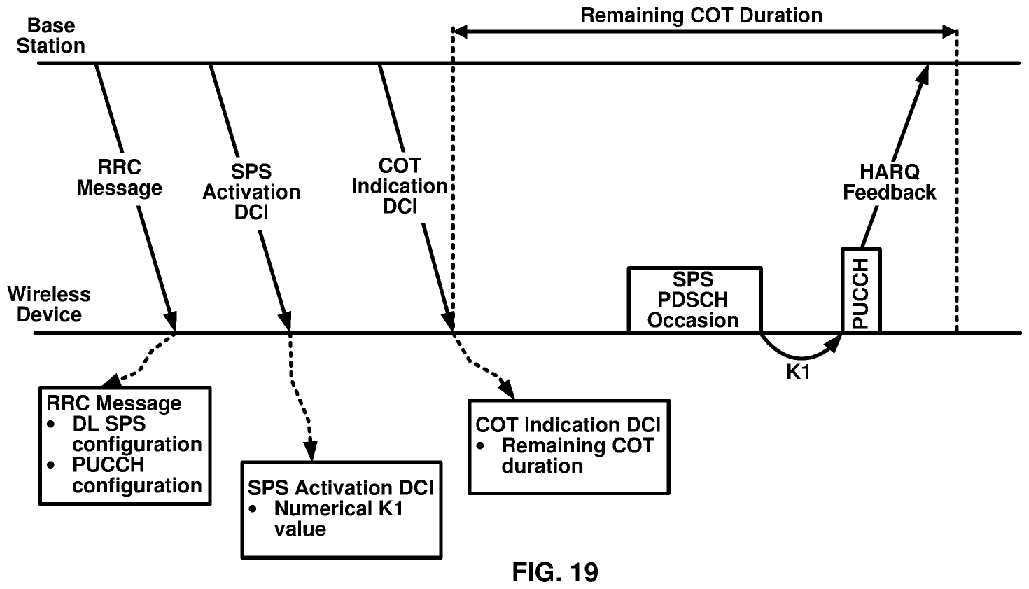

FIG. 19 shows an example of SPS PDSCH and corresponding PUCCH resource scheduling, according to some embodiments. The UE (wireless device) receives RRC signaling comprising DL SPS configuration and/or PUCCH configuration. The DL SPS configuration may comprise SPS PDSCH periodicity. The PUCCH configuration may comprise parameters indicating PUCCH resources, e.g. PUCCH-Config, PUCCH-Resource, PUCCH-format0/1/2/3/4, dl-DataToUL-ACK (set of available K1 values), etc. The UE may receive a first DCI, e.g. SPS activation DCI, comprising scheduling information of SPS PDSCH and corresponding PUCCH resource. The activation DCI comprises a PDSCH-to-HARQ-feedback timing, K1 value (from the RRC-configured set of K1 values), indicating a numerical value as a time offset from the SPS PDSCH to the corresponding PUCCH resource. The UE receives a second DCI indicating COT structure information, e.g. remaining COT duration. The UE determines that the SPS PDSCH occasion and the corresponding PUCCH resource indicated by the numerical K1 value are located in/overlap (e.g. fully or partially) with the remaining COT duration. The UE may or may not receive DL data via the SPS PDSCH occasion. The UE transmits the HARQ feedback information regarding the DL data reception in the SPS PDSCH occasion via the corresponding PUCCH resource.

The UE may determine the first PUCCH resource associated with the first SPS PDSCH occasion based on at least the K1 value in the activation DCI. The K1 value may be numerical. The UE may determine that one or more second symbols of the first PUCCH resource associated with the first SPS PDSCH occasion do not overlap (e.g. partially or fully) with one or more symbols of one or more slots of the first COT duration. The first SPS PDSCH occasion may be scheduled in/within the first COT, e.g. may overlap with the first COT duration. The first PUCCH resource may be scheduled out of the first COT, e.g. not overlap with the first COT duration. The UE may not transmit HARQ feedback information of the first SPS PDSCH occasion via the first PUCCH resource, e.g. outside the COT duration of the SPS PDSCH.

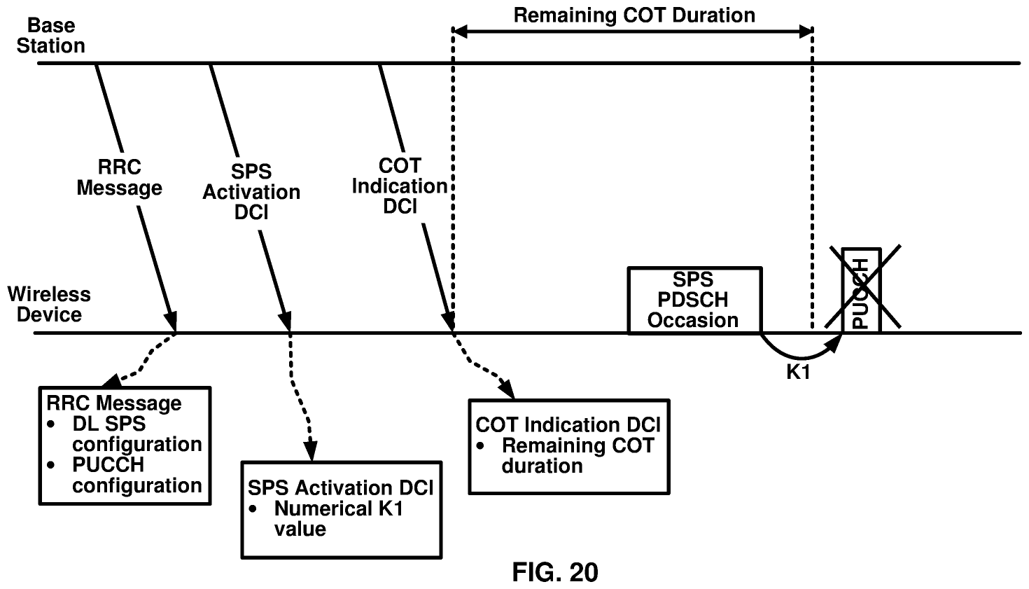

FIG. 20 shows an example of SPS PDSCH and corresponding PUCCH resource scheduling, according to some embodiments. The UE (wireless device) receives RRC signaling comprising DL SPS configuration and/or PUCCH configuration. The UE may receive a first DCI, e.g. SPS activation DCI, comprising scheduling information of SPS PDSCH and corresponding PUCCH resource. The activation DCI comprises a PDSCH-to-HARQ-feedback timing, K1 value, indicating a numerical value as a time offset from the SPS PDSCH to the corresponding PUCCH resource. The UE receives a second DCI indicating COT structure information, e.g. remaining COT duration. The UE determines that the SPS PDSCH occasion is scheduled/located in and/or overlaps with (e.g. fully or partially) the remaining COT duration. The UE determines that the corresponding PUCCH resource, indicated by the numerical K1 value, is scheduled/located outside the remaining COT duration, e.g. does not overlap with the COT duration. For the COT duration expires before the PUCCH resource. The UE may or may not receive DL data via the SPS PDSCH occasion. The UE may not transmit the HARQ feedback information regarding reception/detection of the DL data in the SPS PDSCH occasion via the corresponding PUCCH resource that is outside the COT of the SPS PDSCH occasion.

The UE may discard the PUCCH resource, indicated by a numerical K1 value in the SPS activation DCI, e.g. in response to determining that the PUCCH resource is not within the same COT as the corresponding SPS PDSCH occasion. The UE may drop the HARQ feedback information of the SPS PDSCH occasion in response to determining that the corresponding PUCCH resource is not within the same COT as the SPS PDSCH occasion. The UE may transmit the HARQ feedback information of the SPS PDSCH occasion via the corresponding PUCCH resource that is not within the same COT as the SPS PDSCH occasion, in response to determining that HARQ feedback information comprises ACK (e.g. positive acknowledgment). The UE may transmit the HARQ feedback information of the SPS PDSCH occasion via the corresponding PUCCH resource that is not within the same COT as the SPS PDSCH occasion, in response to determining that HARQ feedback information comprises NACK (e.g. negative acknowledgment).

The base station may determine an implicit ACK in response to not receiving the HARQ feedback information via the scheduled PUCCH resource corresponding to the SPS PDSCH occasion, e.g. when the COT of the SPS PDSCH occasion expires before the corresponding PUCCH resource. The base station may determine an implicit NACK in response to not receiving the HARQ feedback information via the scheduled PUCCH resource corresponding to the SPS PDSCH occasion, e.g. when the COT of the SPS PDSCH occasion expires before the corresponding PUCCH resource.

The base station may not transmit DL data via the SPS PDSCH occasion, e.g., in response to determining that the corresponding PUCCH resource is out of the COT that comprises the SPS PDSCH occasion. The base station may not transmit DL data via the SPS PDSCH occasion, e.g., in response to determining that the COT of the SPS PDSCH occasion expires before the corresponding PUCCH resource. The BS may schedule other transmission(s) that may overlap with the SPS PDSCH occasion, e.g. in response to determining that the COT of the SPS PDSCH occasion expires before the corresponding PUCCH resource. The BS may reschedule the DL data corresponding to the SPS PDSCH occasion, e.g. may transmit the DL data via a second PDSCH, in response to determining that the COT of the SPS PDSCH occasion expires before the corresponding PUCCH resource.

The UE may not receive/detect the DL data transmission via the SPS PDSCH occasion, e.g. in response to determining that the COT of the SPS PDSCH occasion expires before the corresponding PUCCH resource.

Per an example embodiment of the present disclosure, a UE may receive one or more RRC messages comprising configuration parameters of one or more DL SPS configurations and/or one or more PUCCH configurations. The one or more PUCCH resource configurations may indicate a set of available HARQ feedback timing values (one or more K1 values), e.g. via parameter dl-DataToUL-ACK. The UE may receive a first DCI, e.g. an SPS activation DCI. The SPS activation DCI may schedule/indicate a SPS PDSCH occasion. The SPS activation DCI may comprise a first numerical HARQ feedback timing value (K1 value), indicating a first PUCCH resource for transmission of the HARQ feedback corresponding to the SPS PDSCH occasion. The UE may receive one or more DL DCIs scheduling one or more DL transmissions, e.g. one or more first PDSCHs. The one or more DL DCIs may comprise one or more second HARQ feedback timing values (K1 values). The one or more second HARQ feedback timing values may be numerical values. The one or more second HARQ feedback timing values may indicate the first PUCCH resource. The UE may be scheduled/configured to transmit one or more uplink control information (UCI) via the first PUCCH resource. For example, the UE may be configured via RRC with one or more semi-static (e.g. periodic) transmission of scheduling request (SR). For example, the UE may transmit one or more SR information via the first PUCCH resource. For example, the UE may transmit one or more CSI reports (e.g. semi-persistent CSI report and/or periodic/aperiodic CSI-report) via the first PUCCH resource. The UE may transmit a HARQ-ACK codebook via the first PUCCH resource. The HARQ-ACK codebook may comprise the HARQ feedback information of the SPS PDSCH occasion and/or the HARQ feedback information of the one or more first PDSCHs scheduled via the one or more DL DCIs and/or HARQ feedback information of one or more SPS release PDCCHs. The UE may multiplex the HARQ-ACK information (e.g. the HARQ-ACK codebook) and/or the one or more SR information bits and/or the one or more CSI reports in the first PUCCH resource.

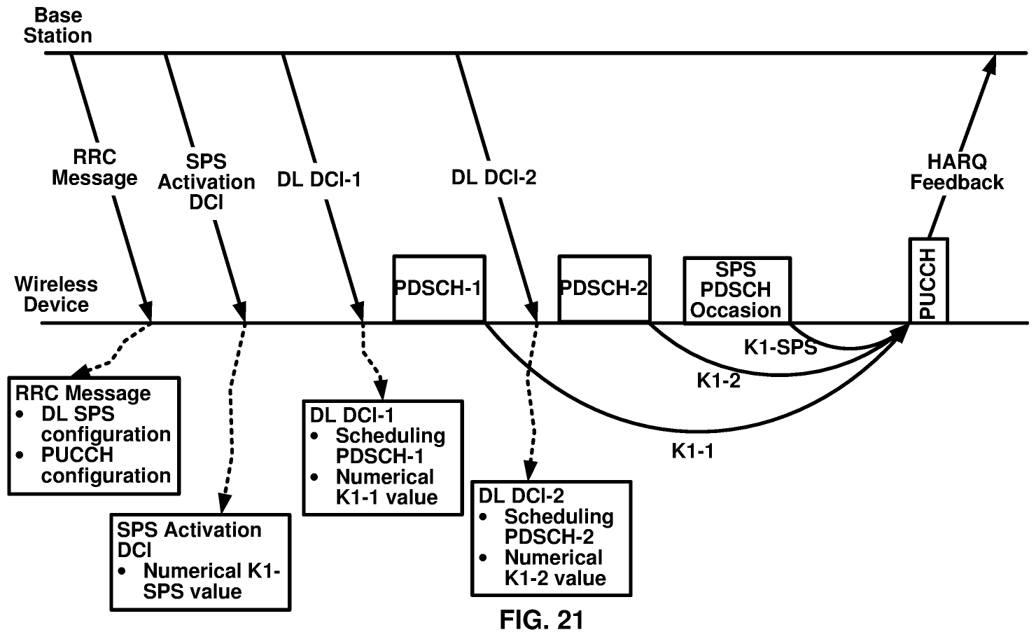

FIG. 21 shows an example of SPS PDSCH and corresponding PUCCH resource scheduling, according to some embodiments. The UE (wireless device) receives RRC signaling comprising DL SPS configuration and/or PUCCH configuration. The DL SPS configuration may comprise SPS PDSCH periodicity. The PUCCH configuration may comprise parameters indicating PUCCH resources, e.g. PUCCH-Config, PUCCH-Resource, PUCCH-format0/1/2/3/4, dl-DataToUL-ACK (set of available K1 values), etc. The UE may receive a first DCI, e.g. SPS activation DCI, comprising scheduling information of SPS PDSCH and corresponding PUCCH resource. The SPS activation DCI may schedule the SPS PDSCH occasion. The SPS activation DCI may comprise a first PDSCH-to-HARQ-feedback timing, K1-SPS value (from the RRC-configured set of K1 values), indicating a numerical value as a time offset from the SPS PDSCH to the corresponding PUCCH resource, e.g. a first PUCCH resource. The UE receives a second DCI, e.g. DL DCI-1, scheduling a first PDSCH, e.g. PDSCH-1. The DL DCI-1 may indicate a second PDSCH-to-HARQ-feedback timing, K1-1 value (from the RRC-configured set of K1 values), indicating a numerical value as a time offset from the PDSCH-1 to the first PUCCH resource. The UE receives a third DCI, e.g. DL DCI-2, scheduling a second PDSCH, e.g. PDSCH-2. The DL DCI-2 may indicate a third PDSCH-to-HARQ-feedback timing, K1-2 value (from the RRC-configured set of K1 values), indicating a numerical value as a time offset from the PDSCH-2 to the first PUCCH resource. The UE may transmit the HARQ feedback information of the SPS PDSCH occasions and/or the PDSCH-1 and/or the PDSCH-2 via the first PUCCH resource.

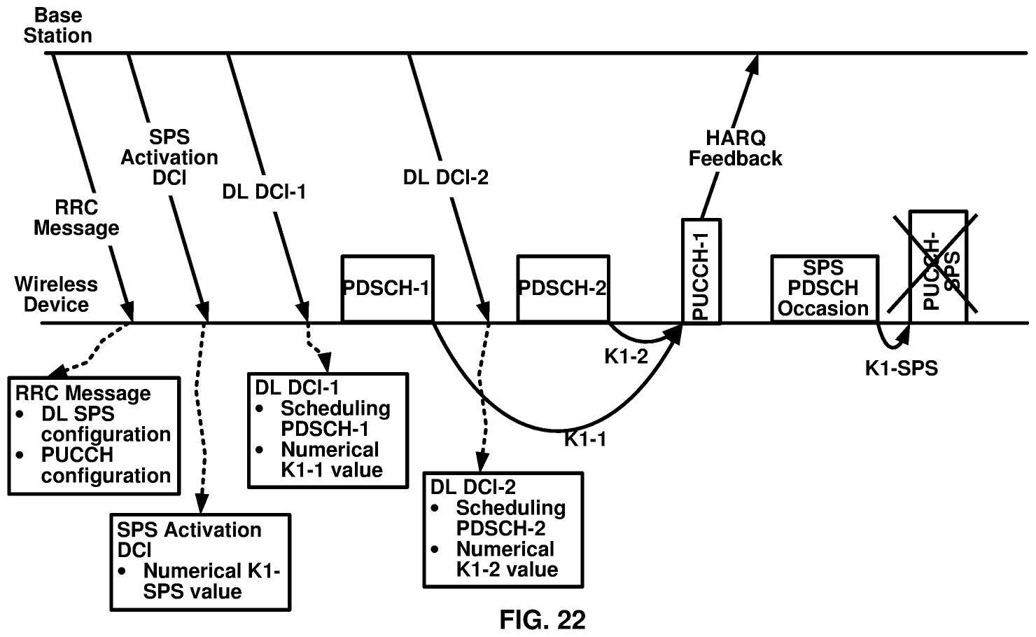

FIG. 22 shows an example of SPS PDSCH and corresponding PUCCH resource scheduling, according to some embodiments. The UE (wireless device) receives RRC signaling comprising DL SPS configuration and/or PUCCH configuration. The UE may receive a first DCI, e.g. SPS activation DCI, comprising scheduling information of SPS PDSCH and corresponding PUCCH resource. The SPS activation DCI may schedule the SPS PDSCH occasion. The SPS activation DCI may comprise a first PDSCH-to-HARQ-feedback timing, K1-SPS value (from the RRC-configured set of K1 values), indicating a numerical value as a time offset from the SPS PDSCH occasion to the corresponding PUCCH resource, e.g. a PUCCH-SPS. The UE receives a second DCI, e.g. DL DCI-1, scheduling a first PDSCH, e.g. PDSCH-1. The DL DCI-1 may indicate a second PDSCH-to-HARQ-feedback timing, K1-1 value (from the RRC-configured set of K1 values), indicating a second numerical value as a time offset from the PDSCH-1 to a second PUCCH resource, e.g. PUCCH-1. The UE receives a third DCI, e.g. DL DCI-2, scheduling a second PDSCH, e.g. PDSCH-2. The DL DCI-2 may indicate a third PDSCH-to-HARQ-feedback timing, K1-2 value (from the RRC-configured set of K1 values), indicating a third numerical value as a time offset from the PDSCH-2 to the second PUCCH resource, e.g. PUCCH-1. The UE may transmit HARQ feedback information comprising HARQ feedback of PDSCH-1 and/or HARQ feedback of PDSCH-2 via PUCCH 1. The UE may not transmit the HARQ feedback information of the SPS PDSCH via PUCCH-SPS, e.g. in response to determining that the PUCCH-SPS is only scheduled for HARQ feedback transmission of the SPS PDSCH occasion, and not the first and the second PDSCHs (PDSCH-1 and PDSCH-2).

The UE may transmit the HARQ feedback of the SPS PDSCH occasion via the PUCCH indicated by the timing value (K1) using a first PUCCH format, e.g. in response to determining that that the PUCCH resource is only scheduled for HARQ feedback transmission of the SPS PDSCH. The UE may transmit the HARQ feedback of the SPS PDSCH occasion via the PUCCH indicated by the timing value (K1) using a first PUCCH format, e.g. in response to determining that the COT of the SPS PDSCH occasion expires before the corresponding PUCCH resource.

The UE may discard the PUCCH resource, indicated by a numerical K1 value in the SPS activation DCI, e.g. in response to determining that the PUCCH resource is only scheduled for HARQ feedback transmission of the SPS PDSCH. For example, no CSI report and/or SR information and/or uplink data and/or HARQ feedback of other DL transmissions may be scheduled for the PUCCH resource. The UE may discard the PUCCH resource, indicated by a numerical K1 value in the SPS release DCI, e.g. in response to determining that the PUCCH resource is only scheduled for HARQ feedback transmission of the SPS release PDCCH. The UE may drop the HARQ feedback information of the SPS PDSCH occasion/SPS release PDCCH in response to determining that the corresponding PUCCH resource is only scheduled for the HARQ feedback of the SPS. The UE may transmit the HARQ feedback information of the SPS PDSCH occasion via the corresponding PUCCH resource that is only scheduled for SPS, in response to determining that HARQ feedback information comprises ACK (e.g. positive acknowledgment). The UE may transmit the HARQ feedback information of the SPS PDSCH occasion via the corresponding PUCCH resource that is only scheduled for SPS, in response to determining that HARQ feedback information comprises NACK (e.g. negative acknowledgment).

The base station may determine an implicit ACK in response to not receiving the HARQ feedback information via the scheduled PUCCH resource corresponding to the SPS PDSCH occasion, e.g. when the PUCCH resource is only scheduled for the HARQ feedback of the SPS. The base station may determine an implicit NACK in response to not receiving the HARQ feedback information via the scheduled PUCCH resource corresponding to the SPS PDSCH occasion, e.g. when the PUCCH resource is only scheduled for the HARQ feedback of the SPS.

The base station may not transmit DL data via the SPS PDSCH occasion, e.g., in response to determining that the corresponding PUCCH resource is only scheduled for the HARQ feedback of the SPS. The base station may not transmit DL data via the SPS PDSCH occasion, e.g., in response to determining that the PUCCH resource is only scheduled for the HARQ feedback of the SPS. The BS may schedule other transmission(s) that may overlap with the SPS PDSCH occasion, e.g. in response to determining that the PUCCH resource is only scheduled for the HARQ feedback of the SPS. The BS may reschedule the DL data corresponding to the SPS PDSCH occasion, e.g. may transmit the DL data via a second PDSCH, in response to determining that the PUCCH resource is only scheduled for the HARQ feedback of the SPS.

The UE may not receive/detect the DL data transmission via the SPS PDSCH occasion, e.g. in response to determining that the corresponding PUCCH resource is only scheduled for the HARQ feedback of the SPS.

A wireless device may not transmit a HARQ feedback of a DL transmission in a first UL channel, indicated by a first timing value (offset). The wireless device may transmit the HARQ feedback of the DL transmission in a second UL channel, indicated by a second timing value, for example, in response to determining that the first UL channel is not within a same channel occupancy as the DL transmission, and/or in response to determining that the first UL channel is only scheduled in association with the DL transmission, e.g. not for any other UL transmissions. The wireless device may transmit the HARQ feedback of the DL transmission via the second UL channel, for example, in response to determining that the second UL channel is within the same channel occupancy as the DL transmission, and/or is scheduled for one or more UL transmissions (e.g. other HARQ feedbacks and/or UL data and/or SR and/or CSI report). The second UL channel may be scheduled by a second DL control information, e.g. comprising the second timing value.

A wireless device may not transmit a HARQ feedback of a DL transmission via a first UL channel if the wireless device receives a one-shot feedback trigger. The one-shot feedback trigger may indicate a second UL channel. The one-shot feedback trigger may be received within a first time interval from the first UL channel and/or the DL transmission. A wireless device may not transmit a HARQ feedback of a DL transmission via a first UL channel if the wireless device receives a one-shot feedback trigger. The one-shot feedback trigger may indicate a second UL channel. The second UL channel may be within a first time interval from the first UL channel and/or the DL transmission. The wireless device may transmit the HARQ feedback of the DL transmission via the second UL channel.

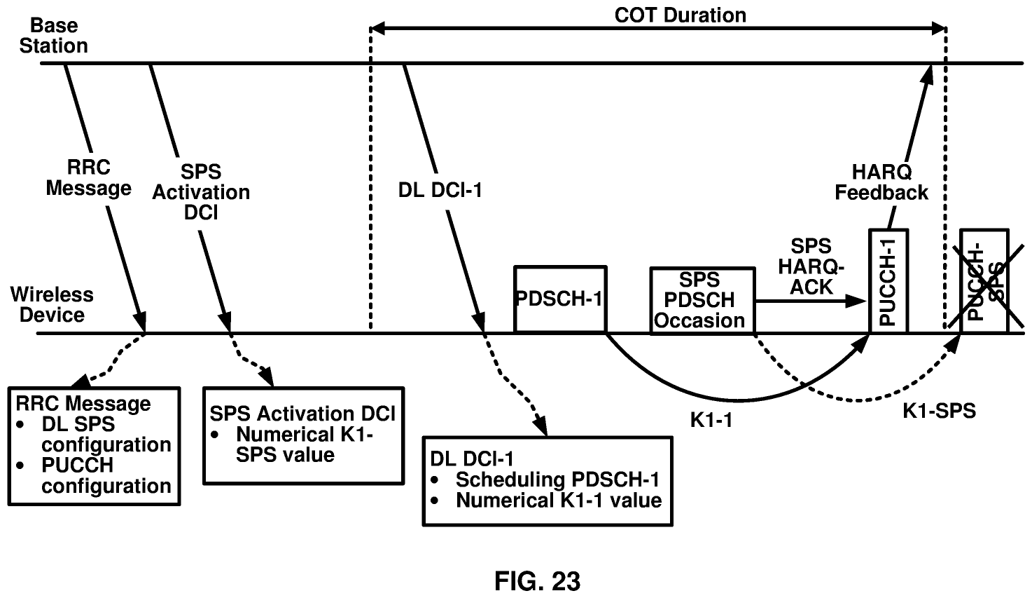

FIG. 23 shows an example of SPS PDSCH scheduling and the corresponding HARQ feedback transmission, according to some embodiments. The UE (wireless device) receives RRC signaling comprising DL SPS configuration and/or PUCCH configuration. The UE may receive a first DCI, e.g. SPS activation DCI, comprising scheduling information of SPS PDSCH and corresponding PUCCH resource. The SPS activation DCI may schedule the SPS PDSCH occasion, e.g. corresponding to an instance of a first period (e.g. any period) according to the DL SPS configuration. The SPS activation DCI may comprise a first PDSCH-to-HARQ-feedback timing, K1-SPS value (from the RRC-configured set of K1 values), indicating a numerical value as a time offset from the SPS PDSCH occasion to the corresponding PUCCH resource, e.g. PUCCH-SPS in FIG. 23. The SPS PDSCH occasion may overlap with a COT duration, e.g. the COT may be initiated by the base station. For example, the UE may receive a DCI indicating a remaining COT duration from the DCI reception. The COT duration may expire before the PUCCH-SPS. The UE may determine that the scheduled UL resource (e.g. PUCCH-SPS) for HARQ feedback transmission of the DL transmission (e.g. SPS PDSCH) is not available (e.g., within the same COT as the DL transmission). The UE receives a second DCI, e.g. DL DCI-1, scheduling a first PDSCH, e.g. PDSCH-1 in FIG. 23. The DL DCI-1 may indicate a second PDSCH-to-HARQ-feedback timing, K1-1 value (from the RRC-configured set of K1 values), indicating a second numerical value as a time offset from the PDSCH-1 to a second PUCCH resource, e.g. PUCCH-1 in FIG. 23. The dynamically scheduled PDSCH (e.g. PDSCH-1) and the corresponding PUCCH resource (e.g. PUCCH-1) may overlap/be within the same COT as the SPS PDSCH occasion. The UE may transmit first HARQ feedback information of PDSCH-1 via PUCCH-1. The UE may transmit second HARQ feedback information of the SPS PDSCH occasion via the second PUCCH resource (e.g. PUCCH-1) indicated by the second DCI, wherein the second PUCCH resource is available, e.g., is within the same COT as the SPS PDSCH occasion. The second PUCCH resource may be within a UE processing time from the SPS PDSCH occasion. For example, the PUCCH-1 may be at least a number of slots/symbols/milli-seconds after a last symbol of the SPS PDSCH occasion. The number of slots/symbols/milli-seconds may be pre-defined and/or pre-configured by RRC.

The UE may discard the PUCCH resource corresponding to an SPS PDSCH occasion (e.g. PUCCH-SPS in FIG. 23) and/or may transmit the HARQ feedback of SPS PDSCH/PDCCH occasion via a second PUCCH resource, e.g. in response to determining the second PUCCH resource is within a first time interval/window. The first time interval/window may start after the UE processing time from the SPS PDSCH occasion. The first time interval/window may be until the end of the COT duration comprising the SPS PDSCH. A duration of the first time interval/window may be per-defined and/or pre-configured by RRC signaling. The second PUCCH resource may be semi-statically configured, e.g., via RRC signaling. The second PUCCH resource may be periodic. The second PUCCH resource may be scheduled/indicated by a second DCI. The second DCI may comprise one or more DL assignments (e.g. DL DCI). The second DCI may be an SPS release DCI, indicating deactivation of one or more SPS PDSCH configurations. The one or more SPS PDSCH configurations may not be associated with the SPS PDSCH occasion. The second DCI may comprise a numerical HARQ feedback timing value indicating the second PUCCH resource. The second PUCCH resource may be within the same COT as the SPS PDSCH occasion. The UE may multiplex HARQ feedback information, comprising the HARQ feedback of the SPS PDSCH occasion, and/or SR information and/or CSI report(s) and/or UL data in the second PUCCH resource. The UE may override the semi-persistent scheduling information, e.g. SPS HARQ feedback timing value, in response to determining the second PUCCH resource being within the first time interval. For example, the UE may ignore the SPS HARQ feedback timing value (e.g. K1-SPS in FIG. 23).

The UE may discard the SPS PUCCH resource (the PUCCH resource indicated by a HARQ timing value in the SPS activation DCI) and/or may transmit the HARQ feedback of SPS PDSCH/PDCCH via a second PUCCH, e.g. in response to receiving a second DCI indicating the second PUCCH. The UE may receive/detect the second DCI via a PDCCH monitoring occasion. The PDCCH monitoring occasion may be before the SPS PDSCH occasion. The PDCCH monitoring occasion may be before the SPS PUCCH resource. The second DCI may be a last received/detected DCI before the SPS PDSCH occasion. The second DCI may be a last received/detected DCI before the SPS PUCCH resource. The second DCI may be last/latest DCI received within the same COT as the SPS PDSCH occasion. The second DCI may be a DL scheduling DCI, e.g. comprising one or more DL assignments. The second DCI may schedule a second PDSCH within a second time interval from the SPS PDSCH occasion. The second DCI may schedule a last PDSCH before the SPS PDSCH occasion. The second DCI may schedule a next PDSCH after the SPS PDSCH occasion. The second DCI may indicate/trigger/request a one-shot HARQ feedback transmission. The second DCI may be a SPS release DCI. The second DCI may be a last DCI received/detected since a last PUCCH. The second DCI may be received after the SPS PDSCH occasion. The second DCI may be received within the same COT as the SPS PDSCH occasion, e.g. before the COT expiration. The second DCI may indicate the second PUCCH resource via a numerical K1 value.

A wireless device may not transmit a HARQ feedback of a DL transmission (e.g. SPS PDSCH and/or SPS PDCCH) in a first UL channel (e.g. a first PUCCH), indicated by a first numerical timing value (offset, e.g. K1 value). The wireless device may store/postpone the HARQ feedback of the DL transmission in response to detecting/receiving an indication of a second non-numerical timing value (e.g. non-numerical K1 (n.n.K1) value). For example, the wireless device may receive/detect a DCI comprising the second non-numerical timing value. The wireless device may receive/detect the indication within a first time interval/window. The first time interval/window may start from a beginning of a channel occupancy duration comprising the DL transmission. The first time interval/window may start from a last UL channel (e.g. last PUCCH). The first time interval/window may comprise the DL transmission. The first time interval/window may have a first duration. The first time interval/window may be a first duration prior to the first UL channel. The first time interval/window may be a first duration prior to the DL transmission. The first duration may be pre-defined. The first duration may be pre-configured by RRC signaling. The first duration may be indicated via a DCI/MAC CE. The first time interval/window may have a variable duration. The first time interval/window may be until an end of the channel occupancy duration comprising the DL transmission. The first time interval/window may be until the first UL channel. For example, the first time interval/window may end before a first symbol of the first UL channel. The first time interval/window may end by a UE processing time before a first symbol of the first UL channel.

A wireless device may not transmit a HARQ feedback of a DL transmission (e.g. SPS PDSCH and/or SPS PDCCH) in a first UL channel (e.g. a first PUCCH), indicated by a first numerical timing value (offset, e.g. K1 value). The wireless device may store/postpone the HARQ feedback of the DL transmission in response to determining that a channel occupancy duration comprising the DL transmission ends/expires before the first UL channel. The wireless device may receive a downlink control information (DCI) indicating a COT structure information, e.g. a length of the COT and/or a remaining channel occupancy duration for a serving cell. For example, the UE may be configured/provided with one or more RRC parameters (e.g. CO-DurationPerCell-r16 and/or CO-DurationList-r16). The DCI may indicate a number of remaining symbols and/or slots from a reception of the DCI (e.g. from beginning of a slot that the DCI is received/detected) to an end of the COT. In an example, the UE may not be configured/provided with the one or more RRC parameters (e.g. CO-DurationPerCell-r16 and/or CO-DurationList-r16). The UE may determine an end and/or remaining duration of the COT for the serving cell based on one or more slot format indications in one or more DCIs (e.g. DCI format 2_0). For example, the one or more DCIs may comprise one or more fields indicating the one or more slot format indications. For example, the one or more slot format indications (SFIs) may indicate slot formats (e.g. UL or DL or flexible direction) of a number of symbols. For example, a remaining channel occupancy duration may comprise a number of slots and/or symbols, starting from a slot where the UE detects the DCI, that the one or more SFIs indicate/provide corresponding slot formats. The wireless device may determine that at least one symbol of the first UL channel do not overlap with the remaining symbols of the COT.

A wireless device may not transmit a HARQ feedback of a DL transmission (e.g. SPS PDSCH and/or SPS PDCCH) in a first UL channel (e.g. a first PUCCH), indicated by a first numerical timing value (offset, e.g. K1 value). The wireless device may store/postpone the HARQ feedback of the DL transmission in response to: determining that a channel occupancy duration comprising the DL transmission ends/expires before the first UL channel; and/or detecting/receiving an indication of a second non-numerical feedback timing value (e.g. non-numerical K1 (n.n.K1) value). For example, the wireless device may receive/detect a DCI comprising the second non-numerical feedback timing value. The wireless device may receive/detect the indication within a first time interval/window.

A wireless device may not transmit a HARQ feedback of a DL transmission (e.g. SPS PDSCH and/or SPS PDCCH) in a first UL channel (e.g. a first PUCCH), indicated by a first numerical feedback timing value (offset, e.g. K1 value). The wireless device may wait for an indication to transmit the HARQ feedback of the DL transmission (e.g. the SPS PDSCH/PDCCH occasion), e.g. in response to determining that a channel occupancy duration comprising the DL transmission ends/expires before the first UL channel; and/or detecting/receiving an indication of a second non-numerical feedback timing value (e.g. non-numerical K1 (n.n.K1) value). The wireless device may wait for a DCI comprising the indication. The indication may be a third numerical feedback timing value. The wireless device may detect/receive the DCI comprising one or more fields that indicate the third numerical feedback timing value. The third numerical feedback timing value may indicate a second UL channel (e.g. a second PUCCH). The wireless device may transmit the HARQ feedback of the DL transmission via the second UL channel. The second UL channel may not be within the channel occupancy duration comprising the DL transmission. The second UL channel may be within a next channel occupancy duration. The wireless device may perform at least a first LBT procedure to transmit the HARQ via the second UL channel. For example, the first LBT procedure may comprise no LBT and/or short LBT. The wireless device may discard the first UL channel. The wireless device may ignore the first numerical feedback timing value. The wireless device may override/overwrite the first numerical feedback timing value by the second non-numerical feedback timing value.

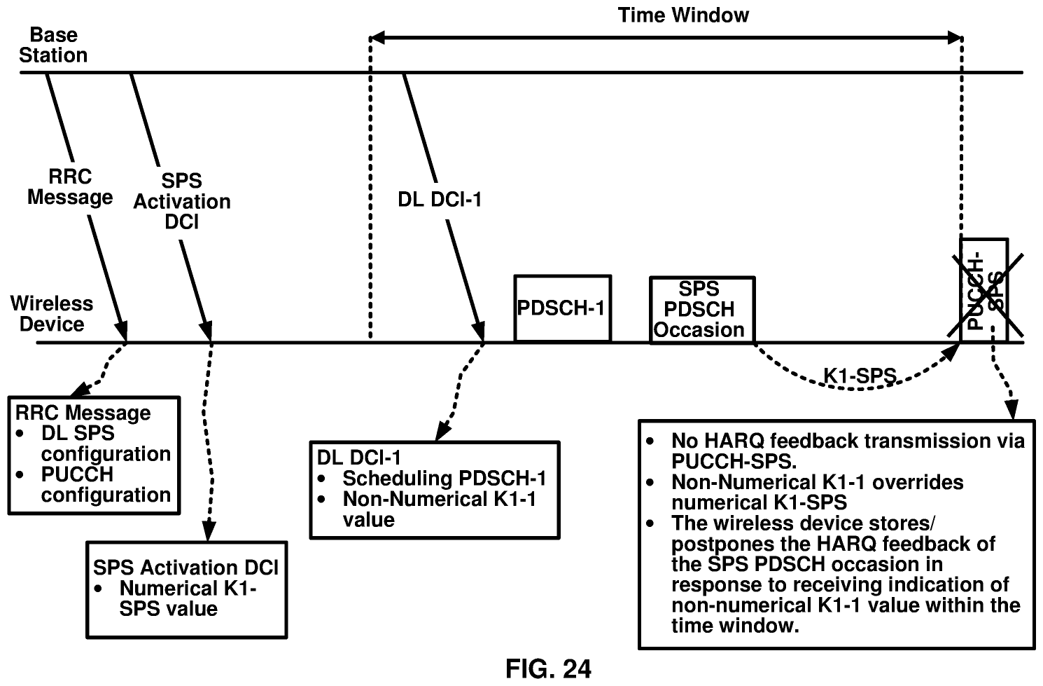

FIG. 24 shows an example, of SPS PDSCH scheduling, where a second non-numerical feedback timing value, received within a time window, overrides/overwrites a first numerical feedback timing value of the SPS PDSCH, according to some embodiments. As shown in FIG. 24, the wireless device (UE) receives RRC configuration comprising parameters of a DL SPS configuration and one or more PUCCH configurations. The UE receives a first DCI, e.g. SPS activation DCI. The SPS activation DCI comprises scheduling parameters of SPS PDSCHs, to be repeated at every period, wherein the periodicity is configured via the RRC message. The SPS activation DCI comprises one or more HARQ feedback timing fields, indicating a first HARQ feedback timing value, e.g. K1-SPS. The first HARQ feedback timing value may be a numerical value. The UE may determine a first instance of the DL SPS configuration, e.g. SPS PDSCH occasion in FIG. 24. The UE may determine a first PUCCH resource, e.g. PUCCH-SPS in FIG. 24, for HARQ feedback transmission of the SPS PDSCH occasion. The UE may determine the first PUCCH resource based on the PUCCH configuration parameters indicated by the RRC message and/or the first HARQ feedback timing value. The UE may determine a slot of the first PUCCH resource by applying the first HARQ feedback timing value (K1-SPS) to a last slot of the SPS PDSCH occasion. The UE may receive a second DCI, e.g. DL DCI-1 in FIG. 24. The second DCI may schedule one or more DL assignments. The second DCI may be an SPS release DCI, e.g. not associated with the SPS PDSCH occasion configuration. The second DCI may request/trigger/schedule a one-shot HARQ feedback. The second DCI may schedule a second PDSCH, e.g. PDSCH-1 in FIG. 24. The second DCI may comprise one or more fields indicating a second HARQ feedback timing value, e.g. K1-1. The second HARQ feedback timing value may be a non-numerical value, e.g. indicating to the UE to store/postpone one or more HARQ feedback transmissions. The UE may store HARQ feedback information of the SPS PDSCH occasions and/or the second PDSCH (PDSCH-1) in response to receiving the non-numerical value for the second HARQ feedback timing value. The UE may not transmit the HARQ feedback of the SPS PDSCH occasion via the first PUCCH resource scheduled by the SPS activation DCI. The UE may receive the second DCI within the time window. The time window may end by the first PUCCH resource (PUCCH-SPS). The time window may have a pre-defined/pre-configured duration. The time window may be a COT duration comprising the SPS PDSCH occasion. The non-numerical value for the second HARQ feedback timing, received during the time window may override/overwrite the numerical value for the first HARQ feedback timing of the SPS PDSCH. As shown in FIG. 24, the UE may receive the second DCI before the SPS PDSCH occasion. The second DCI may schedule one or more second PDSCHs before the SPS PDSCH occasion and/or after the SPS PDSCH occasion.

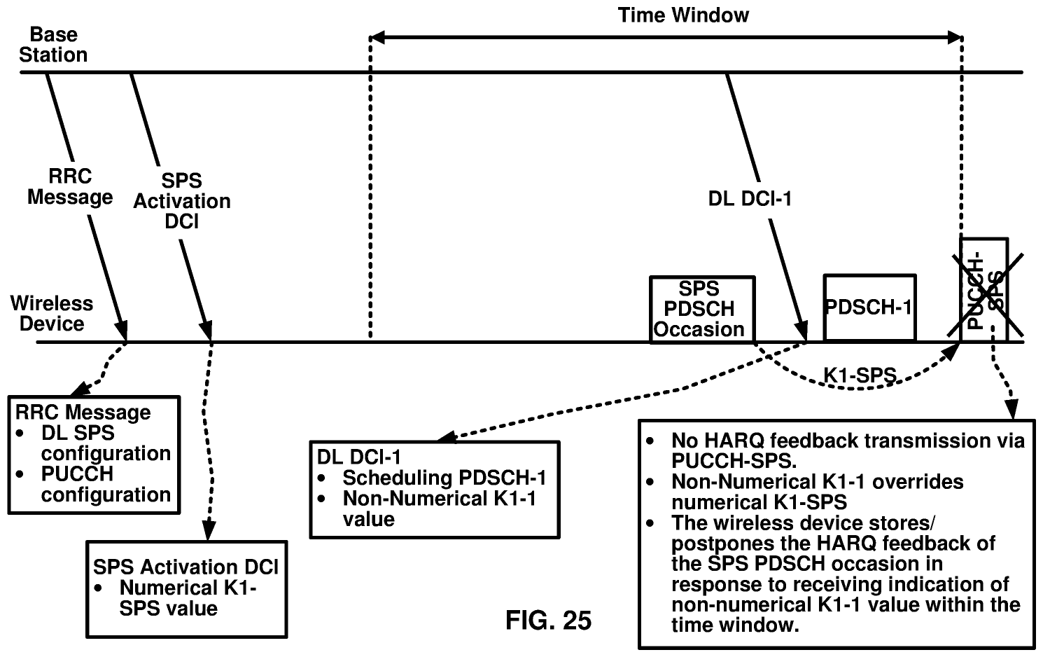

FIG. 25 shows and example of SPS PDSCH scheduling where a second non-numerical feedback timing value, received within a time window, overrides/overwrites a first numerical feedback timing value of the SPS PDSCH, according to some embodiments. The UE may not transmit a HARQ feedback of the SPS PDSCH occasion via a first PUCCH resource indicated by the first numerical timing value, e.g. in response to receiving the second non-numerical feedback timing value. As shown in FIG. 25, the UE may receive the second non-numerical feedback timing value within a time window, e.g. prior to the first PUCCH resource. The UE may receive/detect a second DCI (e.g. DL DCI-1), indicating the second non-numerical feedback timing value, after the SPS PDSCH occasion and/or before the first PUCCH resource. The second DCI may or may not schedule a DL assignment. A last symbol of a PDCCH monitoring occasion of the second DCI may be a time gap before a first symbol of the first PUCCH. The time gap may be the UE processing time.

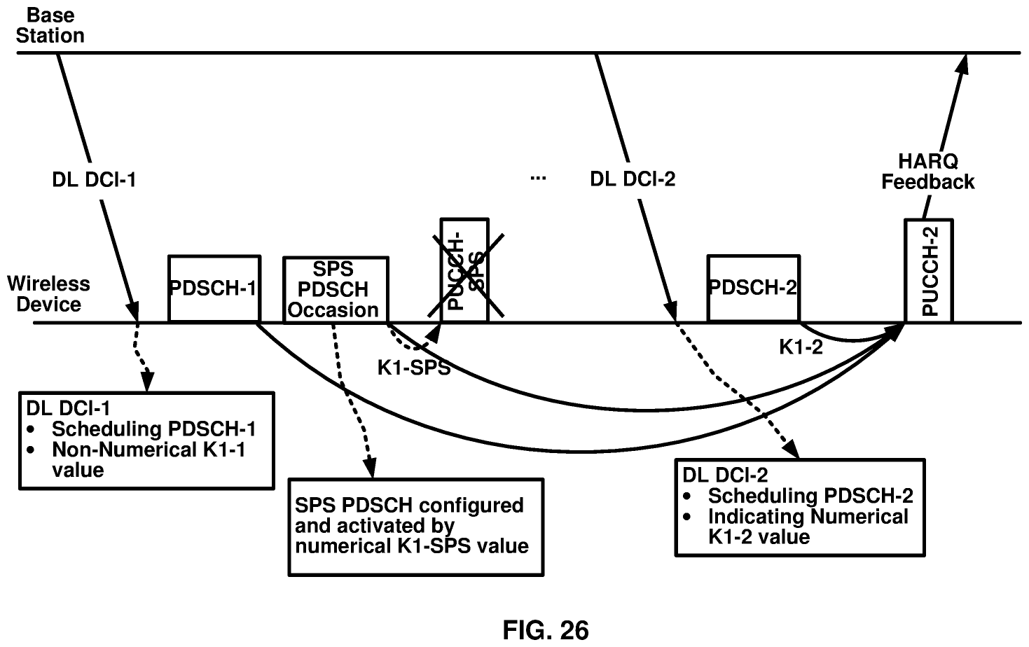

FIG. 26 shows an example of SPS PDSCH with postponed HARQ feedback transmission, according to some embodiments. As shown in FIG. 26, the wireless device may receive configuration and activation of a DL SPS. The DL SPS configuration may comprise a first HARQ feedback timing value, e.g. K1-SPS. The first HARQ feedback timing value may be numerical. The wireless device may determine a first PUCCH resource for HARQ feedback transmission of a first instance of SPS PDSCH (e.g. SPS PDSCH occasion in FIG. 26) based on the first HARQ feedback timing value. The timing from the downlink data reception (of the SPS PDSCH) to a transmission of the corresponding HARQ ACK/NACK (via the first PUCCH resource) may be fixed, e.g., multiple subframes/slots/symbols (e.g., three ms). This scheme with pre-defined timing instants for ACK/NACK may not blend well with dynamic TDD and/or unlicensed operation. A more flexible scheme, capable of dynamically controlling the ACK/NACK transmission timing may be desirable. For example, a DL scheduling DCI may comprise a HARQ timing field to control/indicate the transmission timing of the SPS ACK/NACK in the uplink. The HARQ timing field in the DCI may be used as an index into a pre-defined and/or RRC-configured table that provides information on when the wireless device may transmit the HARQ ACK/NACK relative to the reception of data. The wireless device may receive a second DCI, e.g. DL DCI-1 in FIG. 26, indicating a second HARQ feedback timing value. The second HARQ feedback timing value may be non-numerical. The second DCI may schedule one or more DL transmissions, e.g. PDSCH-1 in FIG. 26. The wireless device may store/postpone HARQ feedback information of the one or more DL transmissions and/or the SPS PDSCH occasion, e.g., in response to receiving the non-numerical value of the second HARQ feedback timing value. The wireless device may discard/ignore the first PUCCH resource and/or the first HARQ feedback timing value. The wireless device may not transmit the HARQ feedback of the SPS PDSCH occasion via the first PUCCH resource, e.g., in response to receiving the non-numerical indication via the second HARQ feedback timing value. The SPS PDSCH and/or the DL DCI-1 and/or the PDSCH-1 may be within a first channel occupancy. The first PUCCH resource may or may not be within the first channel occupancy. For example, the first channel occupancy may expire before the first PUCCH resource. For example, the first PUCCH resource may collide/overlap with at least one DL and/or flexible symbol. For example, the TDD configuration and/or SFI may indicate that the at least one symbol have a DL and/or flexible transmission direction. The UE may receive a third DCI, e.g. DL DCI-2. The third DCI may schedule one or more DL assignments, e.g. PDSCH-2 in FIG. 26. The third DCI and/or PDSCH-2 may be received in a next (second) channel occupancy, e.g. after the first channel occupancy. The third DCI may indicate a third HARQ feedback timing value, e.g. K1-2 in FIG. 26. The third HARQ feedback timing may indicate a second PUCCH resource for HARQ feedback transmission, e.g. of PDSCH-2. The second PUCCH resource may be K1-2 slots after a last slot of DL assignments scheduled by the third DCI. The wireless device may transmit a first HARQ feedback of the SPS PDSCH and/or a second HARQ feedback of PDSCH-1 and/or the third HARQ feedback of PDSCH-2 via the second PUCCH resource. The second PUCCH resource may be within the second channel occupancy. The second PUCCH resource may not collide/overlap with a DL and/or flexible symbol.

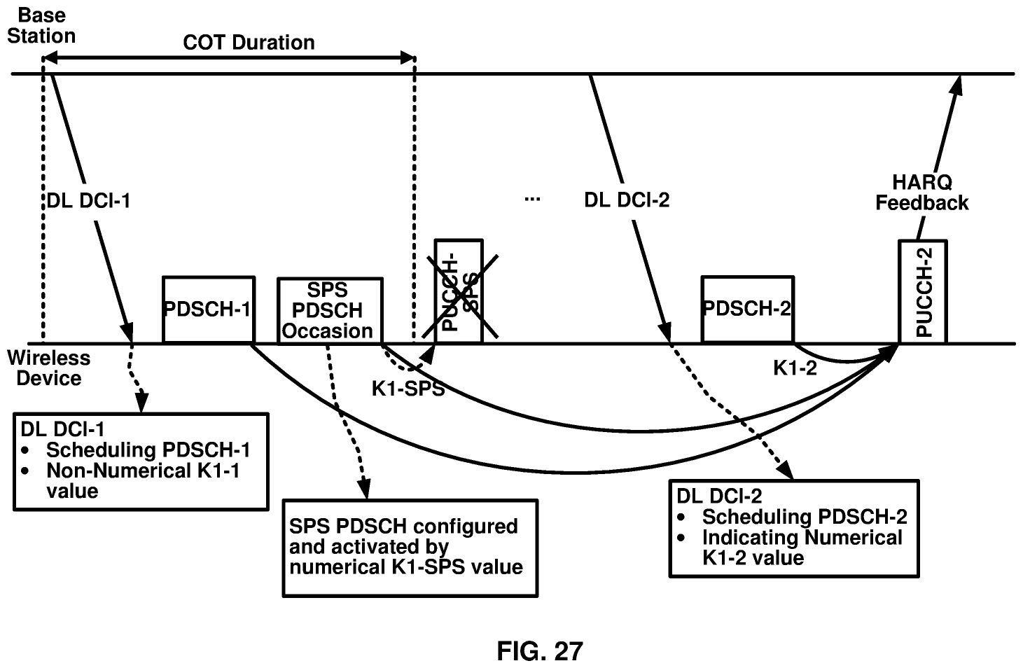

FIG. 27 shows an example of postponing HARQ feedback of SPS PDSCH based on receiving an indication of non-numerical HARQ feedback timing, according to some embodiments. The wireless device may receive the indication within the same COT as the SPS PDSCH occasion. The wireless device may not transmit the HARQ feedback of the SPS PDSCH occasion via a first PUCCH resource indicated by a first numerical HARQ feedback timing of the SPS configuration, e.g., in response to receiving the indication within a first time window. The first time window may be the COT of the SPS PDSCH occasion. The wireless device may discard the first PUCCH resource. The wireless device may override the first numerical HARQ feedback timing value of the SPS PDSCH occasion by a second non-numerical HARQ feedback timing value indicated by a second DCI (e.g. DL DCI-1). The wireless device may transmit the HARQ feedback of the SPS PDSCH via a second PUCCH resource indicate by a third DCI. The third DCI (e.g. DL DCI-2) may comprise a third numerical HARQ feedback timing value indicating the second PUCCH resource.

The wireless device may postpone HARQ feedback information of a first SPS PDSCH occasion, in response to determining that the corresponding PUCCH, e.g. first PUCCH resource, is not a good/valid/available PUCCH resource for uplink transmission. The wireless device may postpone HARQ feedback information of a first SPS PDSCH occasion, in response to determining that the corresponding PUCCH, e.g. first PUCCH resource, is not within the same channel occupancy as the first SPS PDSCH occasion (e.g., the corresponding COT expires before the first PUCCH resource). The wireless device may postpone HARQ feedback information of a first SPS PDSCH occasion, in response to determining that the corresponding PUCCH, e.g. first PUCCH resource, is only scheduled for the HARQ feedback transmission of the first SPSP PDSCH occasion. The wireless device may postpone HARQ feedback information of a first SPS PDSCH occasion, in response to receiving an indication of postponing, e.g. a non-numerical HARQ feedback timing, within a time window of the first SPS PDSCH occasion and/or the first PUCCH resource. The wireless device may postpone HARQ feedback information of a first SPS PDSCH occasion, in response to determining that the corresponding PUCCH, e.g., the first PUCCH resource, collides/overlaps with at least one DL and/or flexible symbol. The wireless device may transmit the HARQ feedback of the first SPS PDSCH occasion via a second PUCCH resource scheduled for a second SPS PDCH occasion. For example, the second SPS PDSCH occasion may be associated with a next period of the DL SPS, wherein the DL SPS is associated with the first SPS PDSCH occasion configuration. For example, the second SPS PDSCH occasion may be associated with a next period of the DL SPS, wherein the DL SPS is not associated with the first SPS PDSCH occasion configuration (e.g. first DL SPS configuration). For example, the second SPS PDSCH occasion may correspond to a second DL SPS configuration. The second PUCCH resource may be within a same (e.g. second) channel occupancy as the second SPS PDSCH occasion. The wireless device may transmit the HARQ feedback of the first PDSCH occasion via a third PUCCH resource scheduled by a third DCI.

The wireless device may multiplex one or more HARQ feedbacks of one or more DL transmissions in a HARQ codebook. The one or more DL transmissions may comprise a first SPS PDSCH occasion. The HARQ codebook may include at least one bit corresponding to the first SPS PDSCH occasion, wherein the first SPS PDSCH occasion may not belong to a size of the HARQ codebook. For example, the HARQ feedback of the first SPS PDSCH occasion may have been postponed. The wireless device may append the at least one bit corresponding to the first SPS PDSCH at the end of the HARQ codebook.

The wireless device may append one or more HARQ feedback bits corresponding to one or more postponed SPS PDSCH occasions at the end of a HARQ codebook. For example, the appending may be in an increasing order of DL SPS configuration indexes. For example, the appending may be in an increasing order of time, e.g. from oldest postponed SPS PDSCH occasion to newest postponed SPS PDSCH occasion.

A base station may configure at least two values for HARQ feedback timing of a DL SPS. For example, the base station may configure a first numerical timing value and a second non-numerical timing value. The RRC signaling may configure a non-numerical value for the DL SPS. The base station may configure one or more parameters, e.g. via RRC signaling, indicating that the wireless device may or may not use a non-numerical feedback timing value for HARQ feedback transmission of one or more DL SPSs, e.g. based on a first condition. The activation DCI may indicate the first numerical timing value or the second non-numerical timing value. When configured with at least the non-numerical value, the wireless device may determine to select the first numerical timing value in response to determining a first condition is met. When configured with at least the non-numerical value, the wireless device may determine to select the second non-numerical timing value in response to determining a first condition is not met. The first condition may be that a second DCI indicating a non-numerical HARQ feedback timing value is received, e.g. within a first time window. The first condition may be that a first PUCCH resource indicated by the first numerical timing value is not within a same channel occupancy as the corresponding SPS PDSCH. The first condition may be that a first PUCCH resource indicated by the first numerical timing value is only scheduled for the HARQ feedback transmission of the corresponding SPS PDSCH, e.g. and no other UL data/control information (e.g. SR/CSI report/other HARQ feedback information). In response to selecting the first numerical feedback timing value, the wireless device may transmit the HARQ feedback of the SPS PDSCH via the first PUCCH resource. In response to selecting the second non-numerical feedback timing value, the wireless device may not transmit the HARQ feedback of the SPS PDSCH via the first PUCCH resource. In response to selecting the second non-numerical feedback timing value, the wireless device may wait for a third DCI comprising a third numerical feedback timing value, wherein the third numerical feedback timing value indicates a second PUCCH resource. The wireless device may transmit the HARQ feedback of the SPS PDSCH via the second PUCCH resource.

A wireless device may receive one or more radio resource control (RRC) messages comprising parameters of a semi-persistent scheduling (SPS) configuration. The wireless device may receive a first downlink control information (DCI) indicating a first feedback timing value of a first physical uplink control channel (PUCCH) resource for a hybrid automatic repeat request (HARQ) feedback transmission of a physical downlink shared channel (PDSCH) occasion of the SPS configuration. The wireless device may receive a second DCI indicating a second feedback timing value. The wireless device may determine a second PUCCH resource for the HARQ feedback transmission of the PDSCH occasion based on a channel occupancy time (COT) of the PDSCH occasion expiring before the first PUCCH resource. The wireless device may determine a second PUCCH resource for the HARQ feedback transmission of the PDSCH occasion based on the second feedback timing value. The wireless device may transmit the HARQ feedback of the PDSCH occasion via the second PUCCH resource.

The parameters of the SPS configuration may comprise a periodicity of SPS PDSCH occasions. The one or more RRC messages may further comprise one or more feedback timing values, comprising the first feedback timing value and the second feedback timing value, indicating a number of one or more slots between a PDSCH to a corresponding HARQ feedback transmission. The one or more RRC messages may further comprise configuration parameters of one or more PUCCH resources for the corresponding HARQ feedback transmission. The configuration parameters of the one or more PUCCH resources may indicate at least one or more PUCCH resource indexes of the one or more PUCCH resources. The configuration parameters of the one or more PUCCH resources may indicate at least one or more PUCCH formats for the one or more PUCCH resources. The one or more PUCCH formats may indicate at least, for each of the one or more PUCCH resources, a number of resource blocks in frequency domain. The one or more PUCCH formats may indicate at least, for each of the one or more PUCCH resources, a starting symbol of a slot. The one or more PUCCH formats may indicate at least, for each of the one or more PUCCH resources, a number of symbols following the starting symbol.

The first DCI may further indicate at least time-domain resource allocation for SPS PDSCH occasions of the SPS configuration, wherein the SPS PDSCH occasions may comprise the SPS PDSCH occasion. The first DCI may further indicate at least frequency-domain resource allocation for the SPS PDSCH occasions. The first DCI may further indicate at least a PUCCH resource indicator from the one or more PUCCH resource indexes, indicating one of the one or more PUCCH resources for the first PUCCH resource.

The first DCI may schedule activation of the SPS configuration. The first DCI may be scrambled by a cell scheduling radio network temporary identifier (CS-RNTI).

The COT comprising the PDSCH occasion may be initiated by a base station in response to a successful listen-before-talk (LBT) procedure. The wireless device may receive a third DCI indicating a duration of the COT. The third DCI may indicate a number of remaining symbols of the COT from a beginning of a slot that the third DCI is received. A time resource of the PDSCH occasion may overlap with one or more of the remaining symbols of the COT. The COT of the PDSCH occasion may expire before the first PUCCH resource, for example, if one or more symbols scheduled for the first PUCCH resource are after a last symbol of the remaining symbols of the COT.

The one or more RRC messages may further comprise configuration parameters of the COT. The configuration parameters of the COT may indicate a length of a field indicating the duration of the COT in the third DCI. The configuration parameters of the COT may indicate a position of the field in the third DCI. The configuration parameters of the COT may indicate a list of values, each indicating a number of remaining symbols, for the duration of the COT. The configuration parameters of the COT may indicate a search space to receive the third DCI. The configuration parameters of the COT may indicate a radio network temporary identifier (RNTI).

The first PUCCH resource may be in a first slot that is a number of slots after a slot of the PDSCH occasion, wherein the number of slots is equal to the first feedback timing value.

The second DCI may indicate the second PUCCH resource via the second feedback timing value, for one or more HARQ feedback transmissions comprising the HARQ feedback transmission. The second PUCCH resource may be in a second slot that is a number of slots after a first slot, wherein the number of slots is equal to the second feedback timing value.

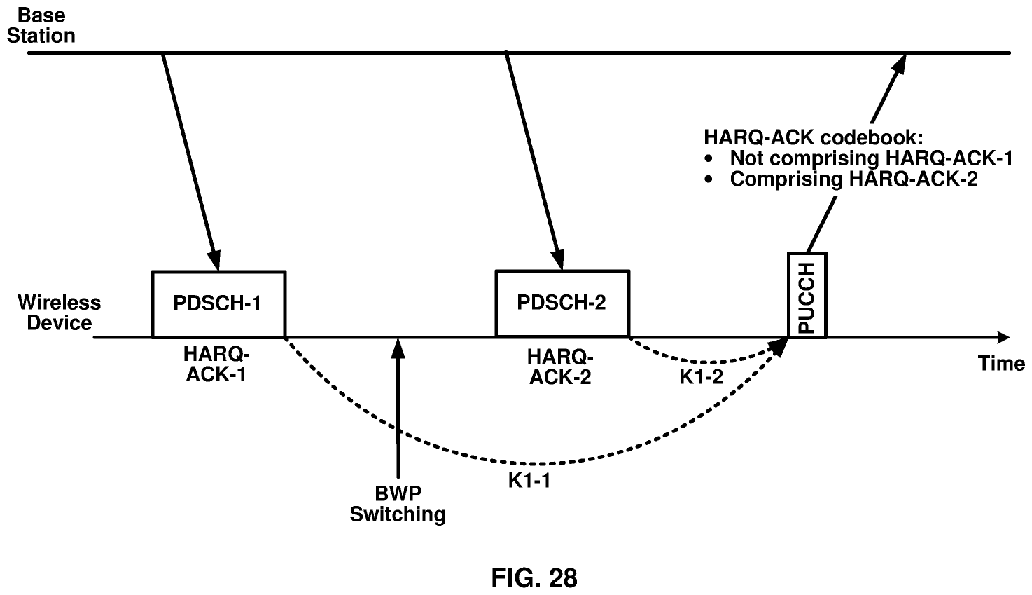

FIG. 28 shows an example of dropping a pending HARQ feedback in semi-static codebook due to BWP switching, according to some embodiments. In this example, the wireless device is scheduled with two downlink assignments: PDSCH-1 and PDSCH-2. The wireless device determines the HARQ-ACK information associated with each downlink assignment/data: HARQ-ACK-1 for PDSCH-1 and HARQ-ACK-2 for PDSCH-2. The wireless device may maintain the HARQ-ACK information in the HARQ feedback buffer. The wireless device determines a PUCCH resource for transmitting the HARQ-ACK information. The wireless device may determine the PUCCH resource based on HARQ feedback timing indicator values corresponding to the downlink assignments. The PDSCH-1 is scheduled with the HARQ feedback timing indicator value K1-1, indicating the PUCCH resource. The PDSCH-2 is scheduled with the HARQ feedback timing indicator value K1-2, indicating the (same) PUCCH resource. The wireless device receives a BWP switching command/notification, and switches a BWP after the PDSCH-1 and before the PDSCH-2 and before the PUCCH. The wireless device drops/skips the (pending) HARQ-ACK-1 of the PDSCH-1 which is scheduled/received before the BWP switching. The wireless device maintains/keeps the HARQ-ACK-2 of the PDSCH-2 which is scheduled/received after the BWP switching. The wireless device determines the HARQ-ACK codebook to transmit/multiplex in the PUCCH. The HARQ-ACK codebook may be semi-static codebook. The HARQ-ACK codebook does not comprise HARQ-ACK-1 associated with PDSCH-1. The HARQ-ACK codebook comprises HARQ-ACK-2 associated with PDSCH-2. The HARQ-ACK-1 is not reported and the base station may reschedule transmission of the data of PDSCH-1.

A BWP change may be due to a BWP inactivity timer expiration. The BWP change may be due to a BWP switch command, e.g. via PDCCH or RRC signaling. The BWP change may be due to random access resources being unavailable on the current BWP. The BWP switching may be on the same serving cell where PDSCH is scheduled/received (e.g. active DL BWP change). The BWP switching may be on the PCell (e.g. active UL BWP change).

A wireless device may be configured with a dynamic/enhanced-dynamic codebook (e.g. Type-2 HARQ-ACK codebook). The wireless device may determine monitoring occasions for PDCCH with one or more DCI formats scheduling PDSCH receptions and/or SPS PDSCH releases, e.g. on an active DL BWP of a serving cell c. The wireless device may transmit HARQ-ACK information of the monitoring occasions using the dynamic/enhanced-dynamic codebook in a PUCCH/PUSCH in slot nᵤ. The wireless device may skip/report NACK for a PDCCH monitoring occasion in the dynamic/enhanced-dynamic HARQ-ACK codebook. For example, the wireless device may skip/report NACK for a PDCCH monitoring occasion when the PDCCH monitoring occasion is before an active DL BWP change, e.g. on the serving cell c, and/or an UL BWP change, e.g. on a PCell. For example, the active DL BWP change may not be triggered in the PDCCH monitoring occasion.

A wireless device and a base station must have a common understanding of a HARQ-ACK codebook size, which for a dynamic codebook, depends on the number of PDCCH monitoring occasions across active DL BWPs of configured serving cells. When there is a BWP switching, a numerology (slot duration) of the BWP may change, and/or one or more CORESET configuration and the associated search spaces and the PDCCH monitoring occasions of the BWP may change. This may complicate the determination of the HARQ-ACK codebook size and the value of the DAI, e.g., when there is a PDSCH reception with pending HARQ-ACK information. Thus, in existing technologies, pending HARQ-ACK information is discarded, and is not considered in HARQ-ACK codebook determination. The wireless device may drop/skip/not report/report NACK for a HARQ-ACK information of one or more PDCCH monitoring occasions and/or SPS PDSCH occasions and/or SPS PDSCH releases in a dynamic/enhanced-dynamic codebook, for example, when the wireless device switches a BWP (e.g. DL BWP and/or UL BWP) after the one or more PDCCH monitoring occasions and/or SPS PDSCH occasions and/or SPS PDSCH releases. The BWP change may be before/at a same time as a corresponding PUCCH/PUSCH slot for the HARQ-ACK transmission.

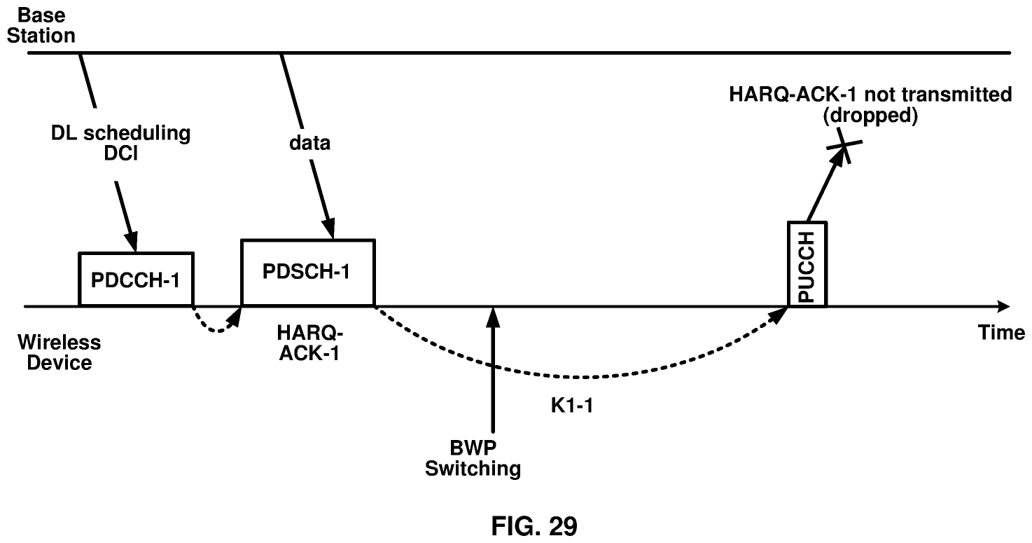

FIG. 29 shows an example of dropping a pending HARQ feedback in dynamic/enhanced-dynamic codebook due to BWP switching, according to some embodiments. In this example, the wireless device receives a DL scheduling DCI via PDCCH monitoring occasions (PDCCH-1). The DCI schedules PDSCH-1. The DCI indicates the HARQ feedback timing indicator value, K1-1. The wireless device determines the HARQ feedback information of the PDSCH-1, HARQ-ACK-1. The wireless device determines the HARQ-ACK codebook based on the dynamic/enhanced-dynamic codebook, based on PDCCH monitoring occasions with DCI format(s) scheduling PDSCH receptions or SPS release. The wireless device determines the PUCCH resource for the HARQ-ACK transmission based on K1-1. The wireless device receives a BWP switching command/notification. The wireless device performs a BWP switching after the PDCCH monitoring occasion with DCI format scheduling PDSCH reception, and before the PUCCH. The wireless device drops/does not transmit the HARQ feedback associated with PDCCH-1 in response to the BWP switching after the PDCCH-1. In this example, the BWP switching is after the PDSCH-1 reception.

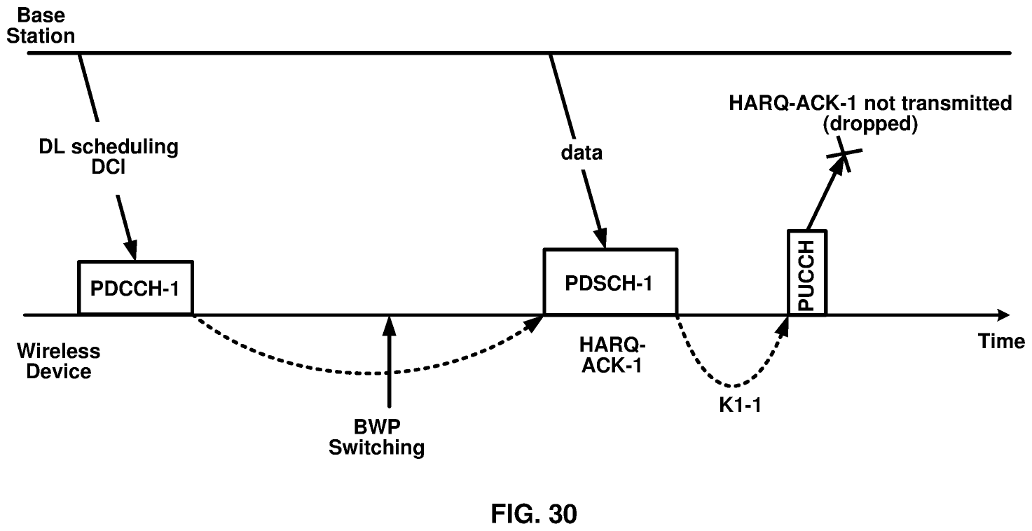

FIG. 30 shows an example of dropping a pending HARQ feedback in dynamic/enhanced-dynamic codebook due to BWP switching, according to some embodiments. In this example, the wireless device receives a DL scheduling DCI via PDCCH monitoring occasions (PDCCH-1). The DCI schedules PDSCH-1. The DCI indicates the HARQ feedback timing indicator value, K1-1. The wireless device determines the HARQ-ACK codebook based on the dynamic/enhanced-dynamic codebook, based on PDCCH monitoring occasions with DCI format(s) scheduling PDSCH receptions or SPS release. The wireless device determines the PUCCH resource for the HARQ-ACK transmission based on K1-1. The wireless device receives a BWP switching command/notification. The wireless device performs a BWP switching after the PDCCH monitoring occasion with DCI format scheduling PDSCH reception, and before the PUCCH. The wireless device drops/does not transmit the HARQ feedback associated with PDCCH-1 in response to the BWP switching after the PDCCH-1. In this example, the BWP switching is before the PDSCH-1 reception.

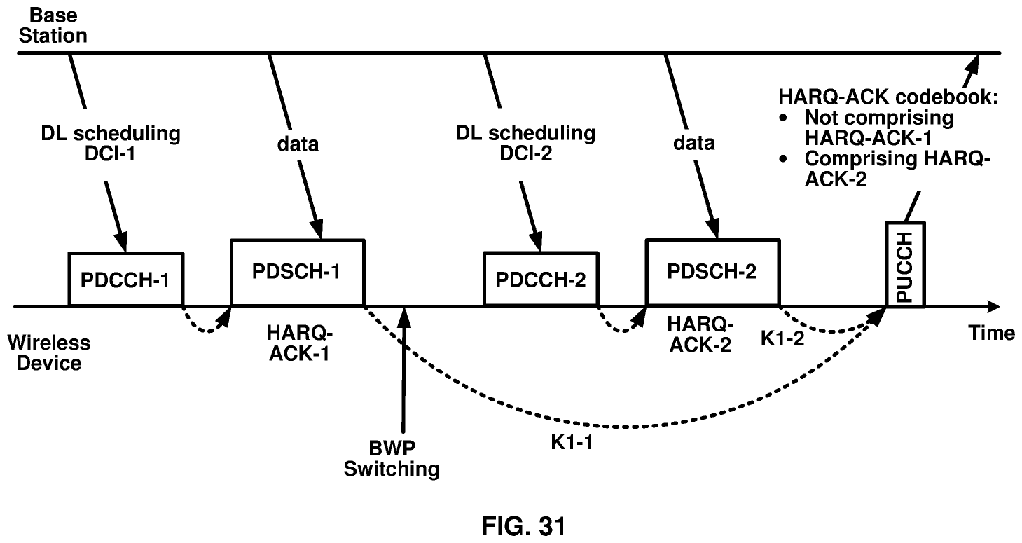

FIG. 31 shows an example of different HARQ feedback behavior with dynamic/enhanced-dynamic codebook due to BWP switching, according to some embodiments. The wireless device receives PDCCH-1 before the BWP switching and drops the associated HARQ-ACK-1 via the PUCCH that is scheduled for after the BWP switching. The wireless device receives PDCCH-2 after the BWP switching and transmits the associated HARQ-ACK-2 via the PUCCH that is scheduled for after the BWP switching.

A wireless device may be configured with a one-shot feedback (e.g. Type-3) HARQ-ACK codebook. The wireless device may determine the HARQ-ACK codebook for one or more serving cells, and one or more DL HARQ processes per serving cell, and/or one or more TBs per HARQ process, and/or one or more CBGs per TB. The wireless device may drop/skip/not report/report NACK for a HARQ-ACK information of one or more TBs and/or one or more DL HARQ processes in a one-shot codebook, for example, when the wireless device switches a BWP (e.g. DL BWP and/or UL BWP) after receiving the one or more TBs and/or after the one or more scheduled DL HARQ processes. The BWP change may be before/at a same time as a corresponding PUCCH/PUSCH slot for the HARQ-ACK transmission.

A wireless device may receive one DCI that allocates both a PDSCH resource for DL data reception and a corresponding PUCCH resource for HARQ feedback transmission of the DL data. The wireless device may receive at least two (e.g. separated) DCIs for PDSCH allocation and the corresponding PUCCH allocation for HARQ feedback transmission. For example, a cross-COT DL data reception and HARQ feedback transmission may be scheduled for the wireless device. For example, the wireless device may receive a first DCI within a first COT, that schedules one or more PDSCHs, and may receive a second DCI within a second COT, that schedules resources for HARQ feedback transmission of the one or more PDSCHs via a PUCCH/PUSCH resource. For example, the first DCI may indicate a non-numerical/inapplicable PDSCH-to-HARQ feedback timing value. For example, the one or more PDSCHs may comprise at least one SPS PDSCH occasion. For example, the first DCI may schedule at least one SPS PDSCH release.

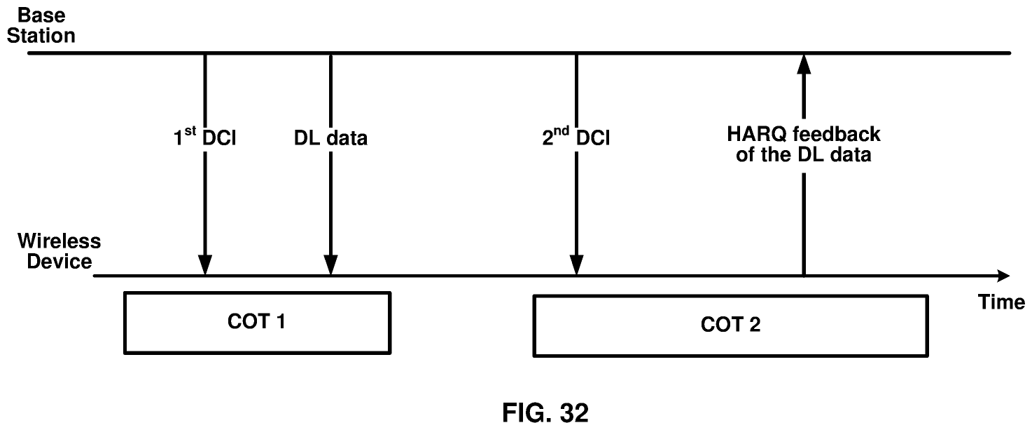

FIG. 32 shows an example of cross-COT scheduling of DL data reception and HARQ feedback transmission, according to some embodiments. The base station may initiate COT 1. The wireless device receives the first DCI in COT 1. The first DCI scheduled the DL data reception in COT 1. The base station may initiate COT 2. The base station may initiate the second COT when LBT is successful, e.g. the channel is diel/available. The wireless device receives the second DCI in COT 2. The second DCI schedules HARQ feedback transmission corresponding to the DL data reception in COT 2.

A BWP inactivity timer may be associated with an active DL BWP of a serving cell. The BWP inactivity timer may be started/restarted, e.g. when a PDCCH is received. The PDCCH may be addressed to a RNTI, e.g. C-RNTI or CS-RNTI. The PDCCH may be received on the active BWP (e.g. DL BWP). The PDCCH may indicate downlink assignment (e.g. PDSCH) and/or uplink grant (e.g. PUSCH) for the active BWP (e.g. DL BWP and/or UL BWP). The BWP inactivity timer may be started/restarted when the wireless device transmits one or more MAC PDUs in one or more configured grants. The BWP inactivity timer may be started/restarted when the wireless device receives one or more MAC PDUs in one or more configured downlink assignments. The wireless device may start/restart the BWP inactivity timer, e.g. when there is no ongoing random access procedure associated with the serving cell. The wireless device may start/restart the BWP inactivity timer, e.g. when the ongoing random access procedure associated with the serving cell is successfully completed (upon reception of this PDCCH addressed to C-RNTI).

The wireless device may start/restart the BWP inactivity timer, e.g., when a first DCI scheduling a downlink assignment with non-numerical K1 value is received on an active BWP. The wireless device may start/restart the BWP inactivity timer, e.g., when a second DCI including resource allocation for PUCCH is received on an active BWP. The second DCI may provide timing for transmission of HARQ A/N feedback.

In existing technologies, a base station may defer HARQ-ACK feedbacks of one or more PDSCH scheduling and/or SPS release of one or more serving cells of a wireless device. For example, the base station may transmit to the wireless device, a first DCI (e.g. DL scheduling DCI/SPS activating DCI/SPS deactivating DCI) indicating a non-numerical/inapplicable value for PDSCH-to-HARQ feedback timing. The non-numerical/inapplicable value may indicate that the wireless device may determine a HARQ-ACK timing and/or a HARQ-ACK resource for the HARQ feedback, associated with the PDSCH scheduled by the first DCI or a SPS released/deactivated by the first DCI, based on a second DCI. The wireless device may delay transmission of the HARQ-ACK feedback until the wireless device receives the second DCI. The non-numerical/inapplicable value may indicate that the wireless device keeps/holds the HARQ feedback associated with the PDSCH or the SPS release, indicated by the first DCI, and wait for the second DCI. The base station may send the second DCI indicating a PUCCH resource (the HARQ-ACK timing and the HARQ-ACK resource) for transmission of the HARQ feedback of the PDSCH or the SPS release indicated by the first DCI. In response to receiving the second DCI, the wireless device may transmit the HARQ-ACK feedback of the PDSCH or the SPS release indicated by the first DCI, using the indicated PUCCH resource.

In unlicensed spectrum, a base station may transmit one or more PDSCHs and/or SPS releases of a serving cell of a wireless device during a first COT duration. The base station may not be able to allocate one or more PUCCH resources for HARQ-ACK feedbacks of the one or more PDSCHs and/or the SPS releases of the serving cell of the wireless device during the first COT. For example, the first COT is not sufficiently long to accommodate the one or more PDSCHs and/or the SPS releases of the serving cell and the corresponding HARQ-ACK feedbacks. For example, the base station may not have resources for the HARQ-ACK feedbacks in the first COT for the wireless device. In some cases, the base station may delay the HARQ-ACK feedbacks to a next available resource, for example within a next COT (e.g., a second COT). The base station may indicate a non-numerical/inapplicable value for the one or more PDSCHs and/or the SPS releases of the serving cell of the wireless device. The wireless device, in response to the non-numerical/inapplicable value, may wait for a second DCI comprising a valid PUCCH resource for the HARQ-ACK feedbacks.

In unlicensed spectrum, depending on a channel availability/congestion level, a number of users, and/or the like, the base station may not be able to acquire the next COT (the second COT) earlier than a time duration, wherein the time duration is configured as a BWP inactivity timer of the serving cell for the wireless device. When the base station acquires the next COT (the second COT) after the time duration, the base station may send the second DCI after the BWP inactivity timer is expired. For example, the wireless device receives a first DCI scheduling a PDSCH for the serving cell with a non-numerical/inapplicable value in the first COT and the wireless device receives the second DCI indicating a PUCCH resource for the PDSCH in the second COT. When the time gap between the two DCIs is larger than a duration of the BWP inactivity timer of the serving cell, the wireless device encounters the expiry of the BWP inactivity timer between the first DCI and the second DCI. In an example, the wireless device may maintain a number of UL LBT failures experienced. When the number of UL LBT failures reaches a threshold, the wireless device may determine a consistent LBT failure and may switch an active DL/UL BWP. The consistent LBT failure may occur between the first DCI and the second DCI. The consistent LBT failure may be indicated when a counter counting UL LBT failures reaches a maximum value during a period. The maximum value and/or the period may be pre-defined/pre-configured by RRC signaling.

The wireless device may switch an active BWP after receiving the first DCI and before receiving the second DCI and/or before transmitting a HARQ feedback associated with the first DCI. In existing technologies, the wireless device may drop/skip/not report or may report NACK for the HARQ-ACK feedbacks associated with the one or more PDSCHs and/or the SPS releases of the serving cell indicated by the first DCI, if the first DCI is received before the BWP switching. Without receiving the HARQ-ACK feedbacks, the base station may need to retransmit the one or more PDSCHs and/or SPS releases of the serving cell for the wireless device. Such cases, where the BWP switching occurs either by the BWP inactivity timer or the LBT failure between the first DCI and the second DCI, may occur when unlicensed spectrum/channel is relatively occupied. Additional overhead of retransmissions, in a busy channel, may aggravate the channel occupancy and may lead to increased latency and higher overhead. In existing technologies, the wireless device may drop/skip/not transmit/report NACK for a pending HARQ-ACK information of a PDSCH/PDCCH occasion when there is a BWP switching. Although based on existing technologies, this might be a corner case, however when the wireless device is configured with non-numerical PDSCH-to-HARQ feedback timing value, a likelihood that the wireless device skips/drops or reports NACK for a PDSCH/PDCCH due to BWP switching may be increased. This may result in significantly increased inefficiency and delay for a considerable number of transmissions and receptions.

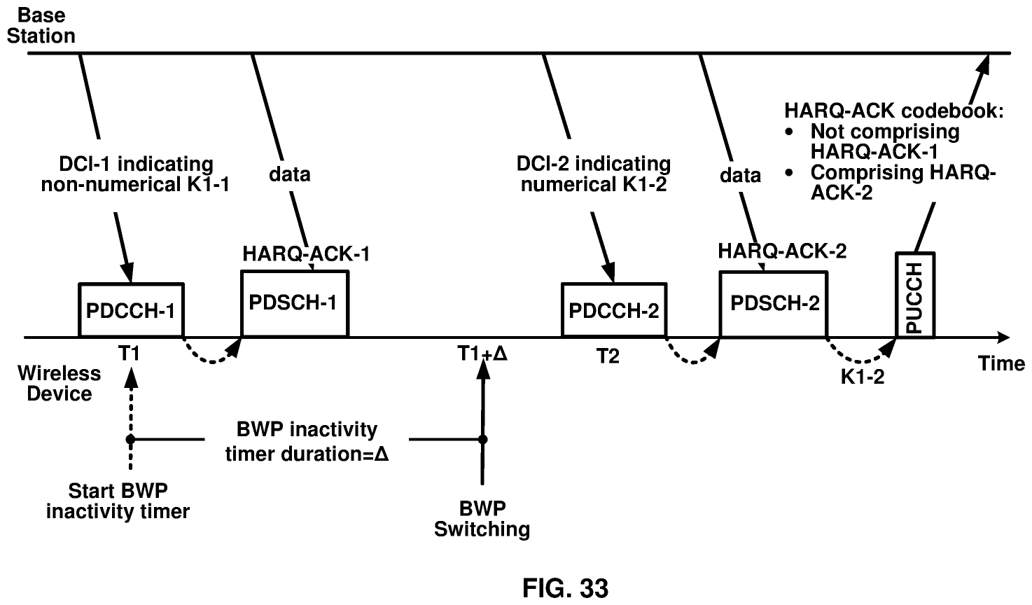

FIG. 33 shows an example of dropping a pending HARQ-ACK associated with a non-numerical HARQ feedback timing indicator, due to BWP switching before receiving a second DCI indicating a PUCCH resource for the HARQ-ACK transmission, according to some embodiments. In this example, the wireless device receives the first DCI (DCI-1) in PDCCH monitoring occasion (PDCCH-1). The wireless device starts/restarts the BWP inactivity timer at time T1 when DCI-1 is received. DCI-1 schedules PDSCH-1 and indicates a non-numerical/inapplicable HARQ feedback timing indicator value (non-numerical value for K1-1). The wireless device determines the HARQ feedback of PDSCH-1 (HARQ-ACK-1), and defers the HARQ-ACK-1 transmission in response to the non-numerical K1-1. The wireless device waits for receiving a second DCI (DCI-2) indicating a valid PUCCH resource to transmit HARQ-ACK-1. The BWP inactivity timer expires after a timer duration A at time T1+A. The wireless device performs a BWP switching at time T1+A, before receiving DCI-2 at time T2. In this example, expiry of the BWP inactivity timer triggers the BWP switching. In another example, an indication of consistent LBT failure may be received and trigger the BWP switching. The wireless device receives the next/second DCI (DCI-2) in PDCCH monitoring occasion at time T2. DCI-2 schedules another PDSCH (PDSCH-2) and indicates a numerical HARQ feedback timing indicator value for K1-2, which indicates the PUCCH resource. The wireless device determines the valid PUCCH resource based on DCI-2 and determines the HARQ-ACK codebook to transmit/multiplex in the PUCCH. Based on existing technology, the HARQ-ACK codebook comprises HARQ-ACK-2 associated with PDSCH-2 but does not comprise HARQ-ACK-1 associated with PDSCH-1. In this example, the wireless device drops HARQ-ACK-1 because a time gap from DCI-1/PDSCH-1 to DCI-2/PUCCH resource is longer than the BWP inactivity timer duration, Δ, and a BWP switching is performed before receiving DCI-2/before the PUCCH resource. the wireless device drops HARQ-ACK-1 even though the UL LBT at the PUCCH may be successful and the wireless device may transmit one or more other HARQ-ACK bits, comprising HARQ-ACK-2.

In existing technologies, the base station may configure a cell with a BWP inactivity timer to control the congestion level on BWPs of the cell and/or wireless devices activity on different BWPs of the cell. For example, when a wireless device does not have enough activity going on an active BWP that is different than a default or initial BWP, the BWP inactivity timer may be expired. Upon expiration of the BWP inactivity timer, the wireless device may switch to the default or the initial BWP, and may deactivated the current active BWP. The wireless device may not monitor and/or transmit/receive on any channels on the deactivated BWP, and may clear/release any configured downlink assignments and configured uplink grants on the deactivated BWP. As a result, resources on that BWP are available for other wireless devices with more activity. However, in an unlicensed operation, when the wireless device is configured with non-numerical PDSCH-to-HARQ feedback timing, the wireless device may experience a long delay between reception(s) and/or transmission(s), e.g. due to LBT failure at the base station and/or the wireless device. This does not imply that the wireless device activity is low. Existing mechanisms of BWP inactivity timer may not address a low activity due to LBT failures/channel busy status.

Based on existing technologies, a mechanism of HARQ-ACK feedback delay (e.g., based on a non-numerical/inapplicable value) may not effectively work with one or more events leading to a BWP switching, such as an expiry of a BWP inactivity timer, or a consistent LBT failure indication. Disabling the one or more events may not be effective. For example, the BWP inactivity timer is used for a UE power saving. Not utilizing the timer may lead to increased UE power consumption. For example, the consistent LBT failure indication is necessary to monitor a channel quality for the wireless device. Not utilizing the LBT failure indication may lead to performance degradation. To efficiently support unlicensed spectrum operation, enhancements are needed to effectively address the HARQ-ACK delay coexisting with the one or more events leading to the BWP switching.

In the present disclosure, one or more mechanisms are proposed to enhance a BWP operation and/or improve a HARQ feedback transmission in unlicensed bands. One or more embodiments of the present disclosure may enable a wireless device to avoid unnecessary/early BWP switching, e.g., when the wireless device is configured with non-numerical value for PDSCH-to-HARQ feedback timing, and/or cross-COT scheduling is needed. One or more embodiments of the present disclosure may enable the wireless device to maintain/transmit a HARQ feedback associated with a non-numerical PDSCH-to-HARQ feedback timing value, when a BWP switching occurs between the PDSCH/PDCCH occasion and the corresponding PUCCH/PUSCH resource. The embodiments may improve a UE power consumption, as well as resource scheduling and traffic control in BWPs of a cell operating in unlicensed bands, reduce a number of retransmissions of PDSCH/PDCCH, and/or enhance a reliability of HARQ-ACK codebook design by maintaining the HARQ information in spite of BWP switching.

The wireless device may maintain/not skip a pending HARQ feedback information when a BWP switching command/notification is received. The pending HARQ feedback information may be associated with a PDSCH occasion/reception. The pending HARQ feedback information may be associated with a PDCCH scheduling one or more PDSCHs. The pending HARQ feedback information may be associated with a PDCCH activating/deactivating/releasing one or more DL SPS configurations. The pending HARQ feedback information may correspond to a semi-static HARQ-ACK codebook. The pending HARQ feedback information may correspond to a dynamic/enhanced-dynamic HARQ-ACK codebook. The pending HARQ feedback information may correspond to a one-shot feedback HARQ-ACK codebook. The pending HARQ feedback information may correspond to a non-numerical HARQ feedback timing indicator value. The pending HARQ feedback information may correspond to a same cell where the BWP switching occurs. The pending HARQ feedback information may correspond to a same cell where the BWP switching command/notification is received. The pending HARQ feedback information may correspond to a different cell other than where the BWP switching occurs. The pending HARQ feedback information may correspond to a different cell other than where the BWP switching command/notification is received. The pending HARQ feedback information may or may not correspond to a same BWP where the BWP switching command/notification is received.

The wireless device avoid/ignore/skip the BWP switching while it has a pending HARQ-ACK associated with a non-numerical HARQ feedback timing indication. The wireless device may not expect to receive a BWP switching command (e.g. RRC or PDCCH) indicating a BWP switching. The wireless device may disable/halt/suspend/stop the BWP inactivity timer in response to receiving a DCI indicating that a HARQ-ACK is deferred/postponed (e.g. using non-numerical AHRQ feedback timing indication). The wireless device may disable/halt/suspend/stop the BWP inactivity timer in response to a channel occupancy/busy ratio/level is above a threshold. The channel occupancy level (or channel unavailability ratio) may indicate a ratio of a number of failed LBTs to a total number of LBTs, e.g. within a certain period. The threshold and/or the period may be pre-defined/pre-configured. The wireless device may disable/halt/suspend/stop the BWP inactivity timer in response to receiving a signal/indication from the base station indicating a high channel congestion level and/or a BWP inactivity timer release. The signal/indication may be RRC signaling releasing/deactivating the BWP inactivity timer. The signal/indication may be MAC CE and/or DCI. The wireless device may postpone a BWP switching until a second DCI indicating a PUCCH resource for the pending HARQ-ACK transmission is received. The wireless device may postpone the BWP switching until after the pending HARQ-ACK transmission associated with the non-numerical HARQ feedback timing indication.

The wireless device may receive a BWP switching command between a PDSCH/PDCCH reception time and a PUCCH for the corresponding HARQ feedback transmission. The wireless device may switch the active BWP based on the BWP switching command. The BWP switching command may be due to a BWP inactivity timer expiration. The BWP switching command may be triggered by a PDCCH. The PDCCH may indicate a downlink assignment and/or an uplink grant. The BWP switching may be triggered by RRC signaling. The BWP switching may be triggered by the MAC entity itself upon initiation of random access procedure. Additionally, in an unlicensed band operation, the wireless device may receive a BWP switching command in response to consistent UL LBT failure. The wireless device may switch to another BWP and initiate RACH upon declaration of consistent LBT failure on PCell or PSCell, e.g. if the wireless device is configured with another BWP with RACH resources.

A wireless device may receive one or more RRC messages from a base station. The one or more RRC messages may comprise parameters of BWP configurations of one or more cells. The parameters of BWP configurations may indicate one or more DL BWPs (e.g. up to four BWPs) for a serving cell, and for each DL BWP: a location and a bandwidth; a subcarrier-spacing; an identifier; common/cell-specific parameters and/or channels of the DL BWP (e.g. PDSCH, PDCCH, etc.); dedicated/UE-specific parameters and/or channels of the DL BWP (e.g. PDSCH, PDCCH, SPS, RLM, etc.). The parameters of BWP configurations may further indicate at least one of the followings: an identifier of an initial DL BWP; an identifier of a first active DL BWP; an identifier of a default DL BWP; and a duration for a BWP inactivity timer (e.g. in ms) wherein the wireless device may fall back to the default BWP when the BWP inactivity timer runs up to the duration and expires. The base station may further configure uplink resources (e.g. normal uplink and/or supplementary uplink) for the serving cell. The one or more RRC messages may further indicate one or more UL BWPs (e.g. up to four BWPs) for the serving cell, and for each UL BWP: a location and a bandwidth; a subcarrier-spacing; an identifier; common/cell-specific parameters and/or channels of the UL BWP (e.g. RACH, PUSCH, PUCCH, etc.); dedicated/UE-specific parameters and/or channels of the UL BWP (e.g. PUSCH, PUCCH, configured grant, SRS, beam failure recovery, etc.). The parameters of BWP configurations may further indicate at least one of the followings: an identifier of an initial UL BWP; and an identifier of a first active UL BWP. An UL BWP and a DL BWP with a same BWP identifier may be considered as a BWP pair, and may have a same center frequency, e.g. in case of TDD (unpaired spectrum).

The one or more RRC messages may further comprise second parameters of one or more physical uplink control channel (PUCCH) configurations for one or more UL BWPs. The one or more second parameters may indicate a set of HARQ feedback timing values (e.g. dl-DataToUL-ACK) for a given downlink resource (e.g. PDSCH) to a corresponding DL HARQ feedback resource (e.g. PUCCH). The set of HARQ feedback timing values may indicate one or more time offsets, e.g. in number of slots, from a PDSCH to a corresponding HARQ feedback transmission (e.g. 1, 2, . . . , 15 slots). The set of HARQ feedback timings may be predefined. The second parameters of the one or more PUCCH configurations may further indicate one or more PUCCH resource sets, each comprising one or more PUCCH resources. The second parameters may indicate for each PUCCH resource at least one of the followings: a PUCCH resources ID; a starting PRB; and a PUCCH format indicating a starting symbol within a slot and a number of symbols in the slot for the PUCCH format.

The one or more RRC messages may further comprise third parameters indicating a HARQ ACK codebook. The HARQ ACK codebook may be semi-static and/or dynamic and/or enhanced-dynamic and/or one-shot feedback.

The wireless device may activate a first BWP of a first cell. The first BWP may be activated for the wireless on the first cell. The first BWP may be a DL BWP and/or an UL BWP. For example, the wireless device may receive an RRC message indicating an identifier of the first BWP as a first active BWP of the first cell. For example, the wireless device may receive a PDCCH indicating switching to the first BWP. For example, the PDCCH may indicate a downlink assignment or an uplink grant for the first BWP. For example, the PDCCH may be received on the first BWP. For example, the MAC entity of the wireless device may indicate switching to the first BWP upon initiation of random access procedure. For example, the wireless device may switch to the first BWP when the BWP inactivity timer expires. The BWP switching for the first cell (e.g. switching to the first BWP) may comprise deactivating a second BWP and activating the first BWP at a time. For example, the second BWP may have been previously activated. For example, the first BWP may be the default BWP. For example, the first BWP may be the initial BWP. For example, in TDD operation (unpaired spectrum), the wireless device may switch to a first DL BWP (e.g. in response to BWP inactivity timer expiration) and switch to a first UL BWP at the same time. For example, the first DL BWP and the first UL BWP may have a same identifier and/or same center frequency. The wireless device may start the BWP inactivity timer upon activating/switching to the first BWP (e.g. the first DL BWP).

The wireless device may receive a first DCI. The first DCI may schedule/indicate one or more downlink assignments for the first BWP of the first cell. The first BWP may be activated. The wireless device may receive the first DCI on the first BWP (e.g. the first DL BWP) of the first cell. The wireless device may receive the first DCI in a second cell (e.g. cross-scheduling). The wireless device may receive the first DCI in a second BWP of the first cell, wherein the first DCI may indicate a BWP switching to the first BWP. The BWP inactivity timer may be running when the wireless device receives the first DCI. For example, the wireless device may have started/restarted the BWP inactivity timer when activating the first BWP. For example, the wireless device may have started/restarted the BWP inactivity timer upon receiving a PDCCH on the first BWP. For example, the wireless device may have started/restarted the BWP inactivity timer upon receiving the first DCI. For example, the wireless device may have started/restarted the BWP inactivity timer upon receiving a PDCCH indicating downlink assignment and/or uplink grant for the first BWP. For example, the wireless device may have started/restarted the BWP inactivity timer upon transmitting a MAC PDU in a configured uplink grant. For example, the wireless device may have started/restarted the BWP inactivity timer upon receiving a MAC PDU in a configured downlink assignment. The first BWP may not be the initial BWP. The first BWP may not be the default BWP. The first DCI may not indicate a BWP switching. The first DCI may indicate a BWP switching.

The first DCI may schedule/indicate one or more PDSCHs for the wireless device on the first BWP. For example, the first DCI may be a DL scheduling DCI. For example, the first DCI may activate one or more DL SPS configurations. The first DCI may deactivate/release one or more DL SPS configurations. At least one of the one or more DL SPS configurations may be for the first BWP (e.g. first DL BWP).

The first DCI may comprise an information field indicating at least one timing indicator value for HARQ feedback transmission of the one or more PDSCHs (e.g. PDSCH-to-HARQ feedback timing indicator; K1). The first DCI may indicate a timing indicator value. The timing indicator value may be a numerical value, indicating a time offset (e.g. in number of slots) from a PDSCH and/or scheduling PDCCH reception slot (e.g. last reception slot) to a PUCCH resource for the corresponding HARQ feedback transmission. The wireless device may determine a HARQ-ACK codebook based on RRC configurations. The wireless device may transmit/multiplex the HARQ feedback of the one or more PDSCHs/PDCCHs in the PUCCH resource. The wireless device may determine the PUCCH resource based on the first DCI. For example, the wireless device may determine a slot for the PUCCH resource based on the timing indicator value indicated by the first DCI. For example, the wireless device may determine a PUCCH format for the PUCCH resource based on a PUCCH resource indicator (PRI) indicated by the first DCI and/or a last DCI.

The wireless device may perform a BWP switching after receiving the first DCI or after the PDSCH reception or after the SPS release, and before or at the same time as the PUCCH resource, wherein the wireless device transmits the HARQ feedback of the PDSCH reception or the SPS release indicated by the first DCI via the PUCCH resource. The wireless device may drop the HARQ feedback associated with the first DCI in response to the BWP switching, if the first DCI does not indicate a non-numerical/inapplicable HARQ feedback timing indicator value.

The wireless device may include the HARQ feedback of the one or more PDSCHs/PDCCHs in the determined HARQ-ACK codebook. The one or more PDSCHs may be scheduled dynamically by the first DCI. The one or more PDSCHs may be associated with a DL SPS configuration, activated by the first DCI. The HARQ feedback may be associated with monitoring occasion(s) for one or more PDCCHs with DCI format, e.g. the first DCI. The first DCI may be received via the one or more PDCCHs. The first DCI may schedule PDSCH reception(s) and/or SPS PDSCH reception(s) and/or SPS PDSCH release(s) on the first BWP (e.g. the first DL BWP that is the active DL BWP). The HARQ feedback may be associated with one or more occasions for candidate PDSCH reception(s) and/or SPS PDSCH reception(s) and/or SPS PDSCH release(s).

The first DCI may indicate a timing indicator value. The timing indicator value may be a non-numerical/inapplicable value. The non-numerical feedback timing indicator (e.g. non-numerical K1 value or n.n.K1) may not indicate a time offset (e.g. in number of slots) from a PDSCH and/or scheduling PDCCH reception slot (e.g. last reception slot) to a PUCCH resource for the corresponding HARQ feedback transmission. The non-numerical feedback timing indicator may not indicate a PUCCH resource/slot for the HARQ feedback transmission of the scheduled PDSCHs. The wireless device may wait and/or hold the HARQ feedback information in response to receiving/detecting the non-numerical feedback timing indicator. After receiving the DL assignment(s), the wireless device may wait for an indication/signal from the base station scheduling/indicating a PUCCH resource for the HARQ feedback transmission of the DL assignments(s).

The MAC entity of the wireless device may receive a notification of BWP switching. The wireless device may receive the notification of BWP switching during a waiting time, wherein the waiting time may be between a first time, initiated in response to receiving the first DCI indicating the non-numerical feedback timing indicator for one or more PDSCHs and/or one or more SPS releases, and a second time of receiving a second DCI comprising a PUCCH resource for the one or more PDSCHs and/or the one or more SPS releases. For example, the wireless device may be holding/keeping the HARQ feedback information associated with the first DCI when notified of BWP switching. For example, the BWP inactivity timer may expire when the wireless device is waiting for the indication of the PUCCH resource (e.g. a second DCI). The wireless device may keep/maintain/hold the HARQ feedback of the one or more DL assignments. The one or more DL assignments may be scheduled/indicated/activated by the first DCI. The wireless device may keep/maintain/hold the HARQ feedback of one or more SPS PDSCH releases. The one or more SPS PDSCH releases may be indicated by the first DCI. The first DCI may deactivate the one or more SPS PDSCHs. The first DCI may indicate the non-numerical feedback timing indicator value. For example, the wireless device may receive a BWP switching command/notification after receiving the first DCI and before/at a same time as the PUCCH resource. The PUCCH resource may be pre-configured. The PUCCH resource may be scheduled/indicated by a second DCI. The wireless device may receive the second DCI after receiving the first DCI. The second DCI may be a next DCI received in a next COT after the first DCI. The second DCI may indicate a numerical feedback timing value to the PUCCH resource. The second DCI may schedule the PUCCH resource.

The wireless device may not drop/skip the HARQ feedback information of the one or more DL assignments scheduled by the first DCI in case of/in response to the BWP switching command/notification. The wireless device may transmit the HARQ feedback information regardless of the BWP switching. The wireless device may transmit the HARQ feedback information of the one or more DL assignments scheduled by the first DCI and/or the one or more SPS releases via the indicated PUCCH resource by the second DCI. For example, the wireless device may drop a second HARQ feedback information of one or more second DL assignments scheduled by a third DCI and/or one or more second SPS releases indicated by the third DCI, wherein HARQ feedback timing of the one or more second DL assignments and/or the one or more second SPS releases is indicated with a valid PUCCH resource or numerical value. The wireless device may drop the second HARQ feedback information in response to the BWP switching. The wireless device may transmit the second HARQ feedback information regardless of the BWP switching.

In an example, the wireless device may transmit the HARQ feedback information associated with the first DCI received when an active DL BWP is a first BWP via the PUCCH resource indicated by the second DCI received when an active DL BWP is a second BWP, when one or more conditions are satisfied. The one or more conditions may comprise one or more of the following examples. For example, the wireless device may transmit the HARQ feedback information, wherein an active UL BWP where the PUCCH resource is configured is maintained during a duration when the wireless device receives the first DCI and the wireless device receives the second DCI. For example, the wireless device may transmit the HARQ feedback information, wherein the HARQ feedback information is indicated by the base station to be delayed/deferred (e.g., indicated with non-numerical value for HARQ feedback timing). For example, the wireless device may transmit the HARQ feedback information wherein the BWP switching may have occurred based on one or more events occurred at the wireless device, instead of receiving a command from the base station. For example, the BWP switching may occur due to an expiry of BWP inactivity timer. For example, the BWP switching may occur due to consistent LBT failure. For example, the BWP switching may occur due to RACH procedure. For example, the BWP switching may occur due to a beam failure recovery procedure. For example, the wireless device may transmit the HARQ feedback information wherein the first DL BWP is same as the second DL BWP.

The wireless device may receive a BWP switching command/notification. For example, the BWP inactivity timer may expire. For example, an RRC signaling may indicate a BWP switching. For example, a PDCCH may indicate a BWP switching. For example, the MAC entity may indicate a BWP switching upon initiating a random access procedure. For example, the MAC entity may indicate a BWP switching upon receiving/detecting a notification of consistent UL LBT failure.

The wireless device may maintain/not drop the HARQ feedback information associated with a first DCI indicating a non-numerical feedback timing indicator value in case of receiving a BWP switching command before/at a same time as a PUCCH resource. The wireless device may receive the first DCI scheduling one or more PDSCHs. the first DCI may indicate the non-numerical feedback timing indicator. The wireless device may receive the BWP switching command/notification. The wireless device may maintain/not drop the HARQ feedback information of the one or more PDSCHs. The wireless device may perform the BWP switching. The wireless device may switch form the first BWP to a second BWP. The wireless device may switch form the first DL BWP to a second DL BWP. The wireless device may switch an active BWP on a second cell. The one or more PDSCHs may be scheduled for the first DL BWP. The wireless may or may not receive the one or more PDSCHs on the first DL BWP. The wireless device may receive a second DCI. The second DCI may schedule/indicate an uplink resource (e.g. PUCCH or PUSCH). The wireless device may transmit the HARQ feedback information of the one or more PDSCHs scheduled by the first DCI using/via the uplink resource scheduled by the second DCI. The wireless device may not drop/skip the HARQ feedback information in spite of the BWP switching during the waiting time. The waiting time may refer to a time duration from receiving the one or more PDSCHs until the PUCCH resource. The waiting time may refer to a time duration after receiving the first DCI (e.g. a PDCCH monitoring occasion) until the PUCCH resource. The BWP switching may refer to an active DL BWP change on a serving cell. The serving cell may be the first cell. The serving cell may not be the first cell. The BWP switching may refer to an active UL BWP change, e.g. on the PCell. The first DCI may or may not trigger the BWP switching.

The wireless device may receive/detect a second DCI. The second DCI may be received on the first BWP. The second DCI may be received on a second BWP of the first cell. The second DCI may be received on a second cell. The second DCI may schedule one or more DL assignments and/or uplink grants for the first BWP. The second DCI may schedule one or more DL assignments and/or uplink grants for a second BWP of the first cell. The second DCI may schedule one or more DL assignments and/or uplink grants for a second cell. The second DCI may schedule a PUCCH and/or PUSCH. The second DCI may schedule a second PDSCH, indicating a numerical feedback timing indicator value. The numerical feedback timing indicator value may indicate a PUCCH for transmitting HARQ feedback of the second PDSCH. The second DCI may not be a scheduling DCI. The second DCI may request a one-shot feedback. The second DCI may indicate a PUCCH resource (e.g. using a numerical feedback timing indicator value and/or PRI) for transmitting the one-shot HARQ feedback. The wireless device may transmit the HARQ feedback information associated with the DL assignment(s) scheduled by the first DCI using the PUCCH resource scheduled by the second DCI.

The PUCCH resource scheduled by the second DCI may overlap with a PUSCH resource. The wireless device may piggyback (e.g. multiplex) the HARQ feedback information associated with the PUCCH resource in the PUSCH resource.

The wireless device may start/restart the BWP inactivity timer, e.g., when the first DCI scheduling the downlink assignment (PDSCH) with non-numerical HARQ feedback timing indicator value is received on an active BWP. The wireless device may start/restart the BWP inactivity timer, e.g., when the second DCI including resource allocation for PUCCH is received on an active BWP. The second DCI may provide timing for transmission of HARQ A/N feedback. The second DCI may request one-shot feedback. The second DCI may indicate NFI (new feedback indicator). The second DCI may not schedule DL data reception or UL data transmission. The wireless device may start/restart the BWP inactivity timer in response to the second DCI, regardless of where/in which cell the second DCI is received. The wireless device may start/restart the BWP inactivity timer in response to the second DCI, if the second DCI is received in the same cell as the DL assignment (PDSCH). The wireless device may start/restart the BWP inactivity timer in response to the second DCI, if the second DCI is received in the same cell as the scheduling DCI (the first DCI). The wireless device may start/restart the BWP inactivity timers of all serving cells in response to the second DCI. The wireless device may start/restart the BWP inactivity timers of the serving cells that transmit one or more HARQ A/N feedback in response to the second DCI. The wireless device may start/restart the BWP inactivity timer, e.g. when there is no ongoing Random Access procedure associated with this Serving Cell or the ongoing Random Access procedure associated with this Serving Cell is successfully completed upon reception of this PDCCH addressed to C-RNTI.

The first DCI may comprise a first field indicating a PUCCH resource identifier (PRI). The PRI may correspond to a first UL BWP. The second DCI may schedule/indicate the PUCCH resource on the first UL BWP. The base station may configure the second DCI to indicate a same PRI for the PUCCH resource as the PRI indicated by the first DCI. The second DCI may schedule/indicate the PUCCH resource on a second UL BWP. For example, the second UL BWP may be in the first cell. For example, the second UL BWP may be in a second cell. The base station may configure the second DCI to indicate a same PRI for the PUCCH resource as the PRI indicated by the first DCI. The first UL BWP and the second UL BWP may have the same subcarrier-spacing. The first DCI may not indicate a PRI. The wireless device may use the PRI indicated by the second DCI to prepare the PUCCH transmission and to multiplex the HARQ-ACK codebook in the PUCCH.

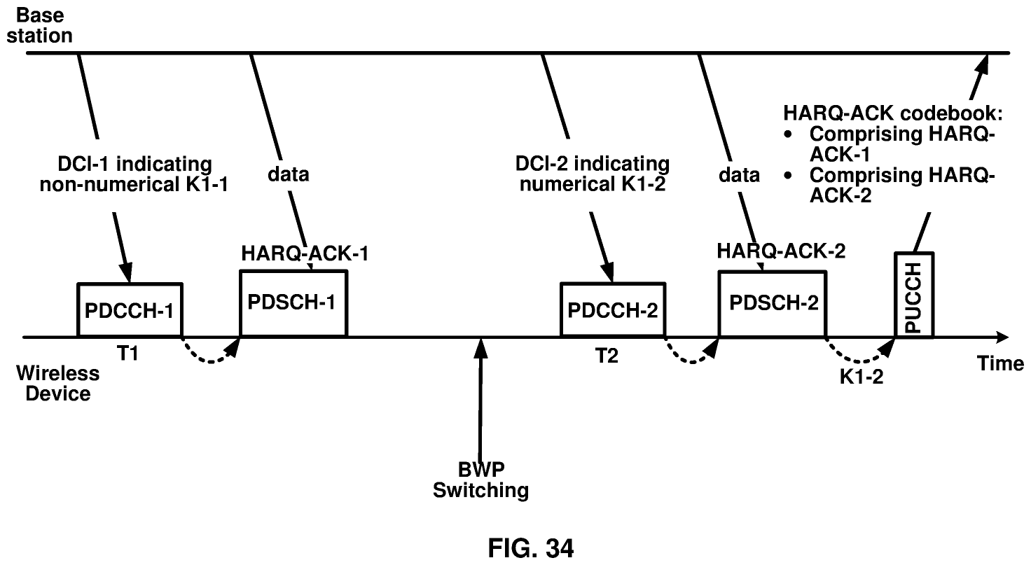

FIG. 34 shows an example of maintaining a pending HARQ-ACK associated with a non-numerical HARQ feedback timing indicator, in case of BWP switching before receiving a second DCI indicating a PUCCH resource for the HARQ-ACK transmission, according to some embodiments. In this example, the wireless device receives the first DCI (DCI-1) in PDCCH monitoring occasion (PDCCH-1). DCI-1 schedules PDSCH-1 and indicates a non-numerical/inapplicable HARQ feedback timing indicator value (non-numerical value for K1-1). The wireless device determines the HARQ feedback of PDSCH-1 (HARQ-ACK-1), and defers the HARQ-ACK-1 transmission in response to the non-numerical K1-1. The wireless device waits for receiving a second DCI (DCI-2) indicating a valid PUCCH resource to transmit HARQ-ACK-1. The wireless device performs a BWP switching before receiving DCI-2. For example, expiry of the BWP inactivity timer may trigger the BWP switching. For example, an indication of consistent LBT failure may be received and trigger the BWP switching. For example, RRC/PDCCH signaling may indicate the BWP switching. The wireless device receives the next/second DCI (DCI-2) in PDCCH monitoring occasion (PDCCH-2). DCI-2 schedules another PDSCH (PDSCH-2) and indicates a numerical HARQ feedback timing indicator value for K1-2, which indicates the PUCCH resource. The wireless device determines the valid PUCCH resource based on DCI-2 and determines the HARQ-ACK codebook to transmit/multiplex in the PUCCH. Based on one or more embodiments of the present disclosure, the wireless device includes the pending HARQ feedback associated with the non-numerical HARQ feedback timing indicator (HARQ-ACK-1) in the HARQ codebook that it transmits in the PUCCH resource, even though the wireless device performs the BWP switching after PDSCH-1 and before the PUCCH resource. As a result, HARQ feedback information is not missed and rescheduling and retransmission of the data is not needed.

In another example, the BWP switching may be between PDCCH-1 and PDSCH-1. In another example, the BWP switching may be between PDCCH-2 and PDSCH-2. In another example, the BWP switching may be between PDCCH-2 and PUCCH. For example, the BWP switching may be in a same cell as data reception (PDSCH-1). For example, the BWP switching may be in any serving cell. For example, the BWP switching may be in a same cell as scheduling DCI (PDCCH-1). For example, the BWP switching may or may not be triggered by DCI-1.

The wireless device may receive the first DCI scheduling/indicating one or more PDSCHs for the first DL BWP. The first DCI may indicate a timing indicator value. The timing indicator value may be a non-numerical/inapplicable value. The non-numerical feedback timing indicator (e.g. non-numerical K1 value or n.n.K1/NNK) may not indicate a time offset (e.g. in number of slots) from a PDSCH and/or scheduling PDCCH reception slot (e.g. last reception slot) to a PUCCH resource for the corresponding HARQ feedback transmission. The non-numerical feedback timing indicator may not indicate a PUCCH resource/slot for the HARQ feedback transmission of the scheduled PDSCHs. The wireless device may wait and/or hold the HARQ feedback information in response to receiving/detecting the non-numerical feedback timing indicator. After receiving the first DCI, the wireless device may wait for an indication/signal from the base station scheduling/indicating a PUCCH resource for the HARQ feedback transmission of the one or more PDSCHs.

The MAC entity of the wireless device may receive a notification of BWP switching. The wireless device may receive the notification of BWP switching during a waiting time initiated in response to receiving the first DCI indicating the non-numerical feedback timing indicator. For example, the wireless device may be holding/keeping the HARQ feedback information associated with the first DCI when notified of BWP switching. For example, the BWP inactivity timer may expire when the wireless device is waiting for the indication of the PUCCH resource (e.g. a second DCI). The wireless device may ignore the BWP switching command/notification, for example, when the wireless device has received the first DCI indicating the non-numerical feedback timing indicator value and the wireless device is waiting for a second DCI. The second DCI may indicate an uplink resource for HARQ feedback transmission associated with the first DCI, and the wireless device may maintain the HARQ feedback information while waiting for the second DCI.

The first DCI may indicate the non-numerical feedback timing indicator value. For example, the wireless device may receive a BWP switching command/notification after receiving the first DCI and before/at a same time as the PUCCH resource. The PUCCH resource may be pre-configured. The PUCCH resource may be scheduled/indicated by a second DCI. The wireless device may receive the second DCI after receiving the first DCI. The second DCI may be a next DCI received in a next COT after the first DCI. The second DCI may indicate a numerical feedback timing value to the PUCCH resource. The second DCI may schedule the PUCCH resource. The wireless device may not drop/skip the HARQ feedback information of the one or more DL assignments scheduled by the first DCI in case of/in response to the BWP switching command/notification. The wireless device may ignore/skip the BWP switching command/notification in response to pending HARQ feedback associated with the non-numerical feedback timing indicator value.

The wireless device may ignore/skip the BWP switching command/notification in response to receiving a non-numerical feedback timing indicator value. For example, the BWP inactivity timer may expire when the wireless device is waiting for the second DCI to transmit the HARQ feedback associated with the first DCI (indicating the non-numerical feedback timing indicator value). The wireless device may restart the BWP inactivity timer upon expiration while waiting for the second DCI. The wireless device may restart the BWP inactivity timer upon expiration while waiting HARQ feedback information associated with non-numerical feedback timing is pending.

For example, the wireless device may receive an RRC signaling and/or PDCCH indicating a BWP switching while waiting for the second DCI to transmit the HARQ feedback associated with the first DCI (indicating the non-numerical feedback timing indicator value). The wireless device may ignore the BWP switching triggered by the RRC signaling/PDCCH in response to pending HARQ feedback associated with the non-numerical feedback timing indicator value.

The wireless device may be configured with two or more durations for the BWP inactivity timer of the first cell. The wireless device may use a first duration from the two or more durations for the BWP inactivity timer, when starting/restarting the timer. The wireless device may receive the first DCI that indicates the non-numerical feedback timing indicator value. The wireless device may use a second duration from the two or more duration for the BWP inactivity timer. For example, the wireless device may start/restart the BWP inactivity timer in response to receiving the first DCI, based on the second duration. The second duration may not be pre-configured. The first DCI may indicate the second duration to the wireless device to use it for the BWP inactivity timer. For example, the base station may use the PRI field in the first DCI to indicate the second duration. The second duration may be longer than the first duration. The second duration may be added to the first duration. As a result, a likelihood of early/unnecessary BWP switching during pending HARQ feedback is decreased. After transmitting the pending HARQ feedback, the wireless device may use the first duration for the BWP inactivity timer again.

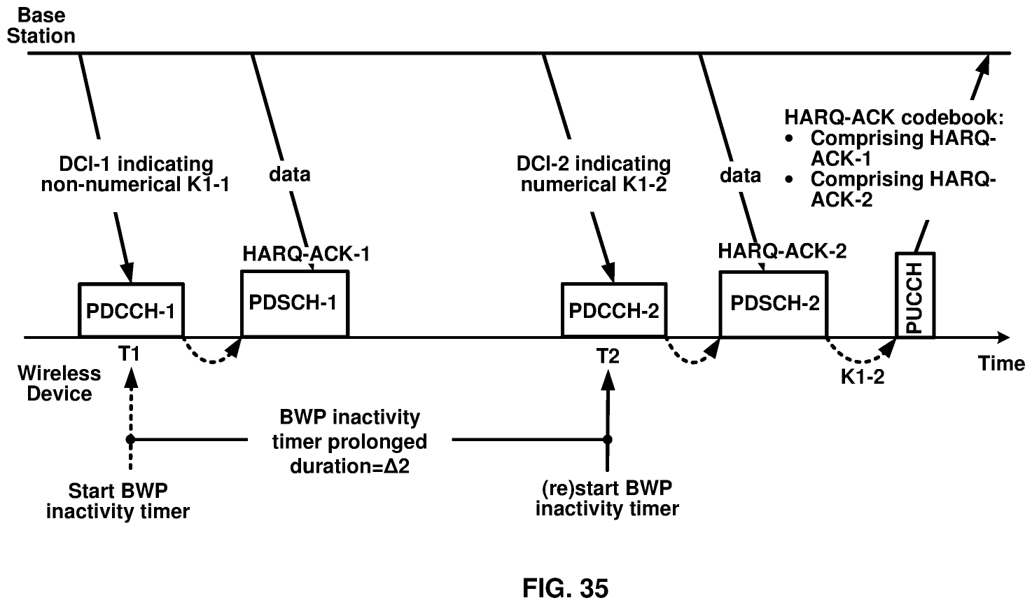

FIG. 35 shows an example of extending the BWP inactivity timer based on the non-numerical HARQ feedback timing indication, according to some embodiments. The wireless device receives DCI-1 at time T1. DCI-1 schedules data reception via PDSCH-1. DCI-1 indicates non-numerical value for the HARQ feedback timing of PDSCH-1, indicating that the wireless device defers/postpones transmission of HARQ-ACK-1 associated with PDSCH-1. The wireless device (re)starts the BWP inactivity timer when DCI-1 is received. The wireless device uses a second time duration for the BWP inactivity timer (Δ2) due to the non-numerical HARQ feedback timing indication. For example, DCI-1 may indicate Δ2. For example, Δ2 may be pre-defined/pre-configured by RRC. Δ2 is longer than A (the first/original BWP inactivity timer duration as shown in FIG. 33). The wireless device may determine Δ2 based on Δ, e.g. by adding a certain value to A. The certain value may be indicated by DCI-1 or be pre-defined or be pre-configured by RRC. The wireless device receives DCI-2 while BWP inactivity timer is still running. The wireless device (re)starts the BWP inactivity timer when DCI-2 is received. The wireless device may (re)start the BWP inactivity timer in response to DCI-2 based on Δ2 and/or A. The wireless device may continue using Δ2 for the BWP inactivity timer until receiving an indication of switching to A. The indication may be a DCI with numerical HARQ feedback timing indication (e.g. DCI-2), or RRC/MAC CE signaling. The wireless device may continue using Δ2 for the BWP inactivity timer for a certain time (e.g. pre-defined/pre-configured). DCI-2 may be received in any serving cell (e.g. self-carrier-scheduling and/or cross-carrier-scheduling). DCI-2 may be received in the same cell and/or same BWP as PDSCH-1/PDCCH-1. The wireless device receives the next/second DCI (DCI-2) in PDCCH monitoring occasion (PDCCH-2). DCI-2 schedules another PDSCH (PDSCH-2) and indicates a numerical HARQ feedback timing indicator value for K1-2, which indicates the PUCCH resource. The wireless device determines the valid PUCCH resource based on DCI-2 and determines the HARQ-ACK codebook to transmit/multiplex in the PUCCH, wherein the HARQ-ACK codebook comprises HARQ-ACK-1. Based on one or more embodiments of the present disclosure, the wireless device includes the pending HARQ feedback associated with the non-numerical HARQ feedback timing indicator (HARQ-ACK-1) in the HARQ codebook that it transmits in the PUCCH resource. This is possible by avoiding early BWP switching while a pending HARQ-ACK is waiting for the second DCI. As a result of extending the BWP inactivity timer duration, early BWP switching is avoided and HARQ feedback information is not missed and rescheduling and retransmission of the data is not needed.

The wireless device may activate the first BWP (e.g. the first DL BWP). The BWP inactivity timer associated with the first BWP may be running. The wireless device may receive the first DCI scheduling/indicating one or more PDSCHs for the first BWP. The first DCI may activate one or more SPS PDSCH configurations of the first BWP. The first DCI may deactivate/release one or more SPS PDSCH configurations of the first BWP. The first DCI may indicate a non-numerical feedback timing indicator value for HARQ feedback transmission of the one or more PDSCHs and/or SPS PDSCHs and/or SPS PDSCH releases.

The wireless device may stop/halt/pause/suspend/disable the BWP inactivity timer (e.g. if running) in response to receiving the first DCI indicating the non-numerical feedback timing indicator value. The wireless device may stop the BWP inactivity timer in response to the non-numerical feedback timing indicator value. The wireless device may stop the BWP inactivity timer in response to the first DCI indicating to wait for a second DCI. The wireless device may not start/restart the BWP inactivity timer (e.g. if not running) in response to receiving the first DCI indicating the non-numerical feedback timing indicator value. As a result, timer-controlled BWP switching is avoided while waiting for a second/next DCI in case of non-numerical feedback timing indicator.

The second DCI may indicate an uplink resource (e.g. PUCCH) for transmitting HARQ feedback information of the one or more PDSCHs/SPS releases. The wireless device may receive the second DCI. The wireless device may determine the uplink resource scheduled by the second DCI. The wireless device may transmit the HARQ feedback via the uplink resource.

Once stopped based on non-numerical feedback timing indicator, the wireless device may resume/restart/start the BWP inactivity timer in response to receiving the second DCI. The wireless device may resume/restart/start the BWP inactivity timer in response to receiving a PDCCH. The PDCCH may be received in the first cell associated with the first BWP. The PDCCH may be received in a second cell. The PDCCH may indicate one or more DL assignments. The PDCCH may indicate one or more UL grants. The DL assignments/UL grants may be for the first cell and/or the second cell. The DL assignments/UL grants may be for the first BWP and/or a second BWP of the first cell. The PDCCH may not indicating any scheduling. The PDCCH may indicate a one-shot feedback request. The wireless device may resume/restart/start the BWP inactivity timer in response to receiving a MAC PDU in configured DL assignment. The wireless device may resume/restart/start the BWP inactivity timer in response to transmitting a MAC PDU in a configured UL grant. The wireless device may start/restart the BWP inactivity timer after a time duration in response to the stopping the BWP inactivity timer. For example, the time duration may be pre-defined/pre-configured by RRC/indicated by the first DCI. The wireless device may start/restart the BWP inactivity timer associated with the first downlink BWP of the first cell in response to receiving the second DCI in the second cell. The second DCI may schedule the uplink resource for the second cell. The wireless device may transmit the HARQ feedback via the uplink resource in the second cell.

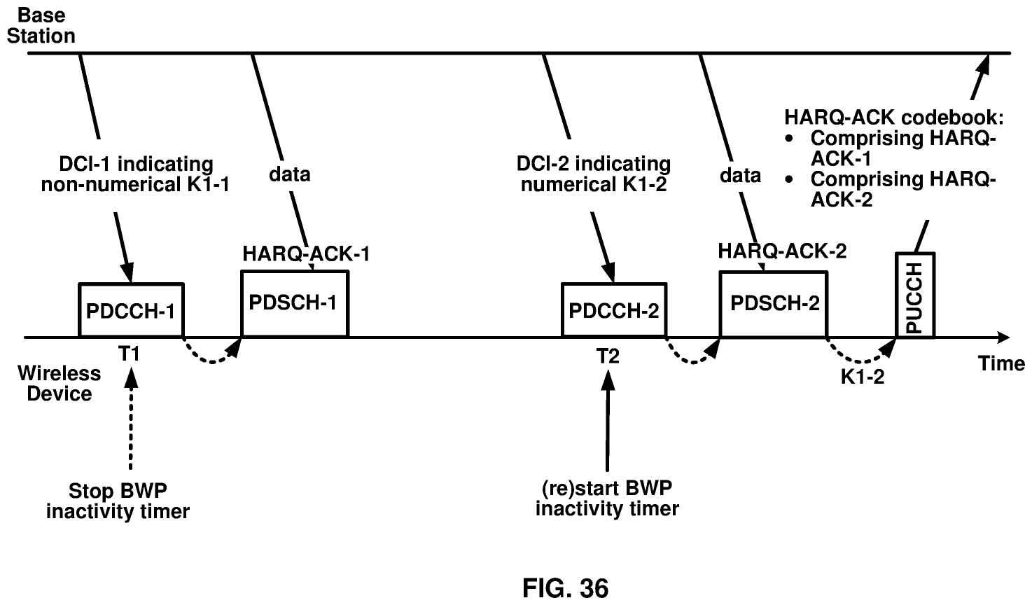

FIG. 36 shows an example of suspending the BWP inactivity timer based on the non-numerical HARQ feedback timing indication, according to some embodiments. The wireless device receives DCI-1 at time T1. DCI-1 schedules data reception via PDSCH-1. DCI-1 indicates non-numerical value for the HARQ feedback timing of PDSCH-1, indicating that the wireless device defers/postpones transmission of HARQ-ACK-1 associated with PDSCH-1. Based on one or more embodiments of the present disclosure, the wireless device stops/halts/suspends/disables/pauses the BWP inactivity timer when DCI-1 is received. The wireless device stops/halts/suspends/disables/pauses the BWP inactivity timer in response to receiving the non-numerical HARQ feedback timing indication (K1-1) at time T1. The wireless device receives the next/second DCI (DCI-2) in PDCCH monitoring occasion (PDCCH-2) at time T2. DCI-2 may be received in the same cell and/or same BWP as PDSCH-1/PDCCH-1. The wireless device may (re)start the BWP inactivity timer in response to receiving DCI-2 at time T2. DCI-2 schedules another PDSCH (PDSCH-2) and indicates a numerical HARQ feedback timing indicator value for K1-2, which indicates the PUCCH resource. The wireless device determines the valid PUCCH resource based on DCI-2 and determines the HARQ-ACK codebook to transmit/multiplex in the PUCCH, wherein the HARQ-ACK codebook comprises HARQ-ACK-1. Based on one or more embodiments of the present disclosure, the wireless device includes the pending HARQ feedback associated with the non-numerical HARQ feedback timing indicator (HARQ-ACK-1) in the HARQ codebook that it transmits in the PUCCH resource. This is possible by avoiding unnecessary/unintended BWP switching while a pending HARQ-ACK is waiting for the second DCI. As a result of stopping the BWP inactivity timer duration, BWP switching is avoided and HARQ feedback information is not missed and rescheduling and retransmission of the data is not needed.

In an example, a wireless device may be configured with a first cell (e.g., PCell) and a second cell (e.g., SCell). The wireless device may receive a first DCI comprising/indicating a non-numerical value of HARQ feedback timing for one or more PDSCH receptions/SPS releases of the second cell. The wireless device may receive the first DCI in the second cell (self-carrier scheduling) or the first cell (cross-carrier scheduling) or a third cell (e.g. another SCell or a PSCell/SCell of a second cell group). The wireless device may be configured to transmit a PUCCH via the first cell for one or more HARQ feedbacks of the second cell and/or the first cell. In response to receiving the first DCI, the wireless device may stop/halt/pause/suspend/disable a first BWP inactivity timer of the first cell (if configured and/or if running), e.g. irrespective of which cell the first DCI is received in. In response to receiving the first DCI, the wireless device may stop/halt/pause/suspend/disable a second BWP inactivity timer of the second cell (if configured/if running), e.g. irrespective of which cell the first DCI is received in. In response to receiving the first DCI, the wireless device may stop/halt/pause/suspend/disable a first BWP inactivity timer of the first cell (if configured and/or if running), e.g. if the first DCI is received via the first cell. In response to receiving the first DCI, the wireless device may stop/halt/pause/suspend/disable a second BWP inactivity timer of the second cell (if configured/if running), e.g. if the first DCI is received via the first cell or the second cell. In response to receiving a second DCI indicating the PUCCH for the one or more HARQ feedbacks, the wireless device may restart/resume/enable/start the first BWP inactivity timer of the first cell (if configured). In response to receiving the second DCI, the wireless device restart/resume/enable/start the second BWP inactivity timer of the second cell (if configured). The wireless device may receive the second DCI via the first cell or the second cell or the third cell.

In an example, a wireless device may be configured with a first cell (e.g., PCell), a second cell (e.g., SCell 1) and a third cell (e.g., SCell 2). The wireless device may have received a first DCI via the second cell, wherein the first DCI comprises scheduling assignments for the third and the first DCI comprises a non-numerical value of HARQ feedback timing. The wireless device may be configured with a cross-carrier scheduling of the third cell by the second cell (e.g., scheduling cell is the second cell for the scheduled cell of the third cell). The wireless device may be configured to transmit a PUCCH via the first cell for one or more HARQ feedbacks of the second cell. In response to receiving the first DCI, the wireless device may stop/halt/pause/suspend/disable a first BWP inactivity timer of the first cell (if configured/if running). In response to receiving the first DCI, the wireless device may stop/halt/pause/suspend/disable a second BWP inactivity timer of the second cell (if configured/if running). In response to receiving the first DCI, the wireless device may stop/halt/pause/suspend/disable a third BWP inactivity timer of the third cell (if configured/if running). In response to receiving a second DCI indicating the PUCCH for the one or more HARQ feedbacks, the wireless device may restart/resume/enable/start the first BWP inactivity timer of the first cell (if configured). In response to receiving the second DCI, the wireless device restart/resume/enable/start the second BWP inactivity timer of the second cell (if configured). In response to receiving the second DCI, the wireless device restart/resume/enable/start the third BWP inactivity timer of the third cell (if configured).

The non-numerical HARQ feedback timing indication may lock the BWP inactivity timer(s) in the scheduling cell and/or the scheduled cell and/or all serving cells and/or any serving cell with pending HARQ feedback.

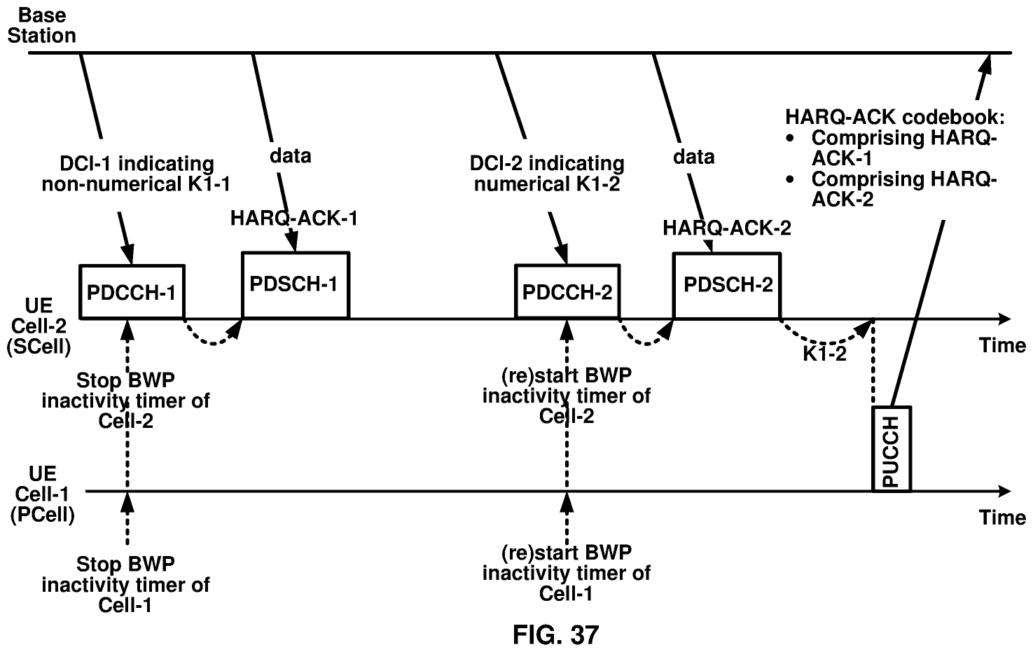

FIG. 37 shows an example of suspending the BWP inactivity timers of cells in a self-carrier scheduling scenario based on the non-numerical HARQ feedback timing indication, according to some embodiments. In this example, the wireless device is configured with a PCell (Cell-1) and a SCell (Cell-2). The wireless device receives DCI-1 in Cell-2 (e.g. SCell). DCI-1 schedules PDSCH-1 in Cell-2 (self-carrier scheduling). DCI-1 indicates non-numerical HARQ feedback timing indicator (K1-1) for PDSCH-1. The wireless device stops/suspends BWP inactivity timers of Cell-1 and/or Cell-2 in response to DCI-1 indicating the non-numerical K1-1. The wireless device waits for a second DCI indicating a PUCCH resource for transmitting HARQ feedback of PDSCH-1 (HARQ-ACK-1). The wireless device receives DCI-2 in Cell-2, indicating the PUCCH in Cell-1. The wireless device (re)starts the BWP inactivity timers of Cell-1 and/or Cell-2 in response to receiving DCI-2. The wireless device transmits a HARQ-ACK codebook comprising HARQ-ACK-1 via the PUCCH. As a result of stopping the BWP timers, the HARQ-ACK information is not missed/dropped and a number of rescheduling/retransmissions is reduced. In another example, the wireless device may receive DCI-2 via Cell-1. In another example, DCI-2 may schedule PDSCH-2 for Cell-1. In another example, DCI-2 may not schedule any data transmission/reception. In another example, DCI-2 may schedule uplink data transmission for Cell-1 and/or Cell-2. For example, DCI-2 may indicate a PUSCH resource. For example, the wireless device may multiplex the HARQ-ACK in the PUSCH indicated by DCI-2. In another example, the wireless device may receive DCI-2 via a third serving cell (e.g. Cell-3). In that example, the wireless device may stop/suspend the BWP inactivity timer of Cell-3 in response to DCI-1 and (re)start the BWP inactivity timer of Cell-3 in response to DCI-2.

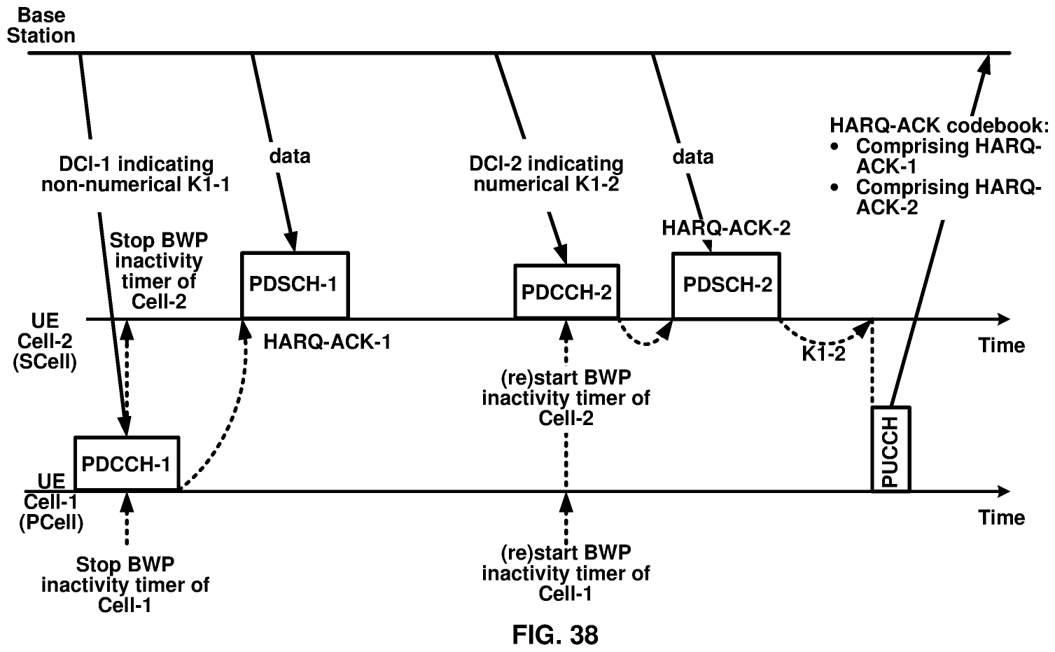

FIG. 38 shows an example of suspending the BWP inactivity timers of cells in a cross-carrier scheduling scenario based on the non-numerical HARQ feedback timing indication. In this example, the wireless device is configured with a PCell (Cell-1) and a SCell (Cell-2). The wireless device receives DCI-1 in Cell-1 (e.g. PCell or PUCCH SCell). DCI-1 schedules PDSCH-1 in Cell-2 (cross-carrier scheduling). DCI-1 indicates non-numerical HARQ feedback timing indicator (K1-1) for PDSCH-1. The wireless device stops/suspends BWP inactivity timers of Cell-1 and/or Cell-2 in response to DCI-1 indicating the non-numerical K1-1. The wireless device waits for a second DCI indicating a PUCCH resource for transmitting HARQ feedback of PDSCH-1 (HARQ-ACK-1). The wireless device receives DCI-2 in Cell-2, indicating the PUCCH in Cell-1. The wireless device (re)starts the BWP inactivity timers of Cell-1 and/or Cell-2 in response to receiving DCI-2. The wireless device transmits a HARQ-ACK codebook comprising HARQ-ACK-1 via the PUCCH. As a result of stopping the BWP timers, the HARQ-ACK information is not missed/dropped and a number of rescheduling/retransmissions is reduced. In another example, the wireless device may receive DCI-2 via Cell-1. In another example, DCI-2 may schedule PDSCH-2 for Cell-1. In another example, DCI-2 may not schedule any data transmission/reception. In another example, DCI-2 may schedule uplink data transmission for Cell-1 and/or Cell-2. For example, DCI-2 may indicate a PUSCH resource. For example, the wireless device may multiplex the HARQ-ACK in the PUSCH indicated by DCI-2. In another example, the wireless device may receive DCI-2 via a third serving cell (e.g. Cell-3). In another example, the wireless device may receive DCI-1 in a third cell (e.g. Cell-3, e.g. another SCell). In that example, the wireless device may stop/suspend the BWP inactivity timer of Cell-3 in response to DCI-1 and (re)start the BWP inactivity timer of Cell-3 in response to DCI-2.

What is claimed is:

1. A method comprising:
receiving, by a wireless device, a downlink channel of a semi-persistent scheduling, wherein the downlink channel is associated with a first uplink control channel indicated by a feedback timing parameter of the semi-persistent scheduling;
determining, based on at least one symbol of the first uplink control channel, that the first uplink control channel is not available for transmitting feedback information of the downlink channel;
determining a second uplink control channel after the first uplink control channel, wherein the second uplink control channel is available for the transmitting; and
multiplexing the feedback information in the second uplink control channel.

2. The method of claim 1, further comprising transmitting the feedback information via the second uplink control channel.

3. The method of claim 1, further comprising receiving a downlink control information (DCI) indicating the second uplink control channel.

4. The method of claim 1, further comprising receiving a radio resource control (RRC) message indicating the second uplink control channel, wherein the second uplink control channel is associated with a second semi-persistent scheduling.

5. The method of claim 4, wherein the second semi-persistent scheduling is the semi-persistent scheduling associated with the downlink channel.

6. The method of claim 1, further comprising receiving a radio resource configuration (RRC) message comprising configuration parameters indicating transmission directions of a plurality of symbols comprising the at least one symbol, wherein a transmission direction of a symbol is uplink or downlink or undetermined.

7. The method of claim 6, wherein the determining, based on the at least one symbol of the first uplink control channel, further comprises determining, based on the configuration parameters, that a transmission direction of the at least one symbol of radio resources allocated to the first uplink control channel is downlink.

8. The method of any one of claim 7, wherein the determining, based on the at least one symbol of the first uplink control channel, further comprises determining, based on the configuration parameters, that transmission directions of symbols of radio resources allocated to the second uplink control channel are uplink.

9. The method of any one of claim 7, wherein the determining, based on the at least one symbol of the first uplink control channel, further comprises determining, based on the configuration parameters, that transmission directions of symbols of radio resources allocated to the second uplink control channel are flexible.

10. The method of any one of claim 7, wherein the determining, based on the at least one symbol of the first uplink control channel, further comprises determining, based on the configuration parameters, that transmission directions of symbols of radio resources allocated to the second uplink control channel are uplink or flexible.

11. A wireless device comprising:
one or more processors; and
memory storing instructions that, when executed by the one or more processors, cause the wireless device to:
receive a downlink channel of a semi-persistent scheduling, wherein the downlink channel is associated with a first uplink control channel indicated by a feedback timing parameter of the semi-persistent scheduling;
determine, based on at least one symbol of the first uplink control channel, that the first uplink control channel is not available for transmitting feedback information of the downlink channel;
determine a second uplink control channel after the first uplink control channel, wherein the second uplink control channel is available for the transmitting; and
multiplex the feedback information in the second uplink control channel.

12. The wireless device of claim 11, further comprising receiving a downlink control information (DCI) indicating the second uplink control channel.

13. The wireless device of claim 11, further comprising receiving a radio resource control (RRC) message indicating the second uplink control channel, wherein the second uplink control channel is associated with a second semi-persistent scheduling.

14. The wireless device of claim 13, wherein the second semi-persistent scheduling is the semi-persistent scheduling associated with the downlink channel.

15. The wireless device of claim 11, further comprising receiving a radio resource configuration (RRC) message comprising configuration parameters indicating transmission directions of a plurality of symbols comprising the at least one symbol, wherein a transmission direction of a symbol is uplink or downlink or undetermined.

16. The wireless device of claim 15, wherein the determining, based on the at least one symbol of the first uplink control channel, further comprises determining, based on the configuration parameters, that a transmission direction of the at least one symbol of radio resources allocated to the first uplink control channel is downlink.

17. The wireless device of any one of claim 16, wherein the determining, based on the at least one symbol of the first uplink control channel, further comprises determining, based on the configuration parameters, that transmission directions of symbols of radio resources allocated to the second uplink control channel are uplink.

18. The wireless device of any one of claim 16, wherein the determining, based on the at least one symbol of the first uplink control channel, further comprises determining, based on the configuration parameters, that transmission directions of symbols of radio resources allocated to the second uplink control channel are flexible.

19. The wireless device of any one of claim 16, wherein the determining, based on the at least one symbol of the first uplink control channel, further comprises determining, based on the configuration parameters, that transmission directions of symbols of radio resources allocated to the second uplink control channel are uplink or flexible.

20. A non-transitory computer-readable medium comprising instructions that, when executed by one or more processors, cause the one or more processors to:
receive a downlink channel of a semi-persistent scheduling, wherein the downlink channel is associated with a first uplink control channel indicated by a feedback timing parameter of the semi-persistent scheduling;
determine, based on at least one symbol of the first uplink control channel, that the first uplink control channel is not available for transmitting feedback information of the downlink channel;
determine a second uplink control channel after the first uplink control channel, wherein the second uplink control channel is available for the transmitting; and
multiplex the feedback information in the second uplink control channel.
